(19) United States
(12) Patent Application Publication
(10) Pub. No.: US 2015/0054373 A1
(43) Pub. Date: Feb. 26, 2015

(54) COMMUTATORLESS AND BRUSHLESS DC MACHINE WITH STATIONARY ARMATURE AND METHOD OF OPERATING THE SAME

(71) Applicant: Sambhaji Shankarrao MANE, Dist Satara (M.S) (IN)

(72) Inventor: Sambhaji Shankarrao Mane, Haryana (IN)

(21) Appl. No.: 14/375,822

(22) PCT Filed: Jan. 30, 2013
(86) PCT No.: PCT/IB2013/050775

§ 371 Date: Jul. 31, 2014

(30) Foreign Application Priority Data
Feb. 1, 2012 (IN) 309/MUM/2012

(51) Int. Cl. H02K 16/02; H02K 19/02; H02K 3/12; H02K 21/12

(52) U.S. Cl. CPC H02K 16/02; H02K 21/12; H02K 19/02; H02K 3/12
USPC 310/156.37; 310/181

(57) ABSTRACT

The invention relates to commutatorless, brushless DC machine with stationary armature and method of operating the same. The armature system is so deployed within magnetic flux producing arrangement having closed path for flux through magnetic substance except air gaps, that the two coil sides of an armature coil are facing like poles of two different magnetic field systems 1 and 2. During DC generator operation magnetic field systems are rotated or moved linearly in same direction with respect to stationary armature such that DC emf in each coil is sum of emfs of all insulated conductor which are alternatingly facing magnetic fields 1 and 2. During DC motor operation rotatable torque or linear force is generated by armature coil conductors carrying direct current on magnetic field systems 1 and 2, causing the rotation or linear movement of the above said two magnetic field systems in same direction.

### FIELD OF INVENTION

This invention relates to commutatorless and brushless DC machine using stationary armature and the method of operating the same.

### BACKGROUND

The direct current (DC) machine is an electromechanical rotating machine that may either generate direct current/voltage or be driven by direct current/supply voltage. Accordingly machine that generate direct current/voltage are called DC generators while machines which are driven by direct current/voltage are termed as DC motors.

Conventional DC motors and generators have armature as rotating part of the machine. The current flow direction in the conductor needs to be reversed when conductor passes from one pole to another. The change in the direction of current is achieved by commutator and brushes. In a conventional DC generator commutator converts AC voltage induced in the armature winding into DC voltage which is taken out through brushes.

Due to the complexity in the construction of a conventional DC Machine having moving parts with or without brushes there is a constant wear and tear leading to an increase in maintenance costs and machine maintenance downtime. Besides, the DC voltage output from DC generator is not pure DC but has ripples. The reason for this excessive ripple is that the flux associated with the conductor decreases from magnet center to the end portion as per sine wave.

In existing technologies, there are brushless motors which have stationary armature winding on stator. The rotors of these motors have magnetic field system consisting of permanent magnets. Sensors such as Hall Effect sensor MOSFETs along with electronic circuitry connected serially to armature winding are adapted to sense the angular position of the rotor, to switch the current flowing through armature windings, and to generate a continuous torque in the intended direction.

Though the brushless motors have distinct advantage over DC motor with brushes and commutators, the electronic circuitry used for switching armature current in armature winding along with Hall Effect sensors, gives rise to a complexity in the circuit configuration of the motors thereby leading to excessive warming which is detrimental especially in hot weather. There is also an increase in cost price.

U.S. Pat. No. 4,564,778 granted on Jan. 14, 1986, discloses a brushless DC electromagnetic rotary machine where the current in a small part of armature winding produces torque on the rotor having permanent magnet. This arrangement is very inefficient given the large size when compared to the conventional DC motor with same power ratings.

Another U.S. Pat. No. 7,768,157 published on 1 May 2008 discloses a brushless DC motor which produces torque from both side of coil of armature. The disadvantages of the brushless motor of the '157 patent is the absence of a continuous transport means made of magnetic substances to transport magnetic flux, resulting into poor magnetic flux density and hence poor efficiency in term of torque production. Moreover, this invention does not include DC generators.

### OBJECT OF THE INVENTION

In order to obviate the drawbacks of inefficient power generation, high maintenance costs and the associated costs such as frequent maintenance down-time, the present invention provides for a commutator-less and brushless DC machine comprising stationary armature arrangement. The DC machine may either be a DC motor or a DC generator.

The main objective of this invention is to provide high efficiency DC machine

Yet another object of the invention is to provide DC machine which are practically maintenance free.

### SUMMARY OF THE INVENTION

Accordingly the present invention provides for commutatorless and brushless DC machine with stationary armature as well as the method of assembling and operating the same.

The DC machines which may be either a DC motor or a DC generator comprises a stationary armature arrangement with rotating magnetic fields. The armature arrangement may be broadly classified into 2 main types based on the deployment of the armature namely radial flux type rotating system and axial flux type rotating system. Both radial flux type and the axial flux type rotating systems may in turn be either rotating field type or rotating armature type. However, the radial flux type rotating system can also be opened out in a single plane to function as a linear flux type brushless DC machine.

The magnetic field systems employed both for radial flux machine and axial flux machine has at least one magnet, but are usually arranged in pairs. In the unconventional arrangement which has only one magnet, the other magnet is replaced by a laminated magnetic yoke which has the same shape and size of the magnet. A magnet used in radial flux machine may either be a single piece in the shape of a hollow cylinder or it may be multiple magnets arranged axially either on the inner wall in case of outer magnetic field system of laminated cylindrical pipe shaped yoke, or on the outer wall of laminated cylindrical pipe shaped yoke of inner magnetic field to form the shape of a cylindrical pipe. All these multiple magnets which form a cylindrical pipe shaped magnet have similar poles facing towards armature under them. For the purposes of this invention, the term “cylinder” means cylindrical pipe or hollow cylinder.

The cylindrical pipe shaped magnet on the outer magnetic field and the inner magnetic field which are on the same side with respect to the center of shaft length have similar poles facing their respective armature. There is at least one but preferably 2 cylindrical armatures placed co-axially, one each under poles of outer as well as inner magnetic fields.

Axial flux machine armature system comprises of two coaxial flat discs made from laminated magnetic substance and separated by non-magnetic substance. Each disc has inner and outer ring which are connected by arms. The said discs have radially placed conductors in slots on armature. The said armature is a projected portion on outer and inner rings on the said discs. There are two flat discs shaped magnetic field systems on either side of the armature, each field system having magnets in the shape of flat rings lined with rings of armature.

Two coil sides of an armature coil for radial or axial flux machine will be under poles of two different magnetic field systems. These poles will be similar poles.

The working principle of the DC machine when it operates as a DC generator is based on the fact that since the field systems are rotated in the same direction by the shaft(s) the emfs induced in the conductors on both sides of the coil on the armature system are additive and therefore the total coil emf is sum of emfs of individual conductors in coil. The emf on the individual conductors are additive because they are alternatively facing the two magnetic field systems. Being a DC generator, the emfs are unidirectional throughout the time.

The said coils are connected in series in such a way that emfs are further added to get rated voltage from the DC generator. Multiple units of such series connections can be connected in parallel to obtain higher yield of current.

The working principle of DC machine while operating as DC motor is based on the fact that in both radial flux and axial flux type DC motors, there is an interaction of magnetic flux produced by the current in the conductors with the magnetic flux produced by magnetic system resulting in differential magnetic flux around said conductors. Hence force is produced on conductors on both sides of armature coil in case of rotating armature type while in the case of rotating field type the force is produced on both field systems. This force produces a continuous unidirectional torque which results into continuous unidirectional motion from the motor.

Accordingly the present invention provides for commutatorless, brushless DC machine with stationary armature. DC machine is deployed in DC machine body. The DC machine comprises of magnetic flux producing system and armature system with an air gap between them in radial, axial or linear arrangements. The magnetic flux producing has at least one magnetic field system preferably two magnetic field systems. This may be a pair of movable or rotatable magnetic field systems having at least one magnet. DC machine has at least one closed loop flux transport means in the form of magnetic path.

The armature system comprises of at least 1 stationary member for transporting magnetic flux and has at least 2 surfaces. The stationary member has been described in the detailed description of invention. Each surface of stationary member has at least one armature core which has multiple slots, each slot housing a group of insulated conductors. The armature winding of armature system comprises of at least one winding. Winding comprises of multiple groups of coil. Each group of coils comprises of multiple coils. Each coil is formed by serially connecting insulated conductors alternating between the conductors on each of the armature cores which are fixed on opposite surfaces i.e. surface 1 and surface 2. Each coil so formed has at least 2 coil side each coil side corresponding to each armature core.

The armature system is so deployed with in the magnetic flux producing system which is movable or rotatable that the coil side on armature core of the surface 1 faces pole of magnet under magnetic field system 1 while the corresponding coil side on armature core of the surface 2 faces pole of magnet under magnetic field system 2. These poles of magnets which face corresponding coil sides have same polarity.

In a radial arrangement, the magnetic flux producing system which is permanent or electromagnetic field system comprising of at least one rotatable shaft and at least two magnetic field systems which are inner and outer magnetic field system. The inner magnetic field system is enclosed by the outer magnetic field system. The inner magnetic field system comprises of cylindrical pipe shaped yoke which is coaxially fitted on the rotatable shaft. The outer periphery of the cylindrical pipe shaped yoke has at least one cylindrical pipe magnet, which is magnetized in radial direction. The outer magnetic field system comprises of cylindrical pipe shaped yoke which encompasses the cylindrical yoke of the inner magnetic field system and is disposed toward machine body.

The inner periphery of the cylindrical yoke of outer magnetic field system has at least one cylindrical pipe shaped magnet. The cylindrical pipe shaped magnets of outer magnetic field system is also magnetized in radial direction. The cylindrical yoke of outer magnetic field system is anchored to the rotatable shaft by anchoring means. The armature system of radial flux DC machine comprises of at least one cylindrical shaped stationary member for transporting magnetic flux. The stationary member has at least two surfaces, inner and outer periphery, each of which has at least one armature core preferably two armature cores. Armature cores are made of laminated magnetic substance and have multiple slots which run in axial direction. The slot houses a group of insulated conductors. The armature winding comprises of at least 1 winding which has multiple groups of coils. The multiple groups comprises of multiple coils, in which each coil is formed by serially connecting the insulated conductors alternating between the insulated conductors on each armature core which is fixed on inner and outer periphery of stationary cylindrical member.

The armature system is so deployed within the rotatable magnetic flux producing system that the coil side of coil on armature core of inner periphery faces the pole of magnet under inner magnetic field system while the corresponding coil side of the same coil on armature core of outer periphery of stationary member faces pole of magnet under outer magnetic field system. These poles of magnet which face the corresponding coil sides have same polarity.

The magnetic flux generated from inner and outer magnetic field system is transported in a closed loop flux transport means through a magnetic path present in each magnetic field system. The magnetic flux generated from each magnetic field system is transported in a closed loop flux transport means through a magnetic path that include cylindrical magnets, air gap between magnets and armature cores, armature cores, stationary member of armature system, yoke of magnetic flux producing system.

Like radial flux machine axial flux DC machine also comprises of rotatable magnetic flux producing system and armature system. The magnetic flux producing system comprises of at least 1 rotatable shaft and at least 2 magnetic field systems. The magnetic field system comprises of cylindrical flat disc yoke which is coaxially fitted on rotatable shaft. The flat surface of the yoke cylindrical flat yoke and has at least one flat ring magnet which is magnetized in axial direction. The second magnetic field system comprises of cylindrical flat disc yoke coaxially fitted on rotatable shaft in longitudinal direction. The yoke of second magnetic field system has at least one ring magnet on its surface which is toward flat surface of the yoke having flat ring magnet in magnetic field 1. The armature system of axial machine comprises of at least one flat disc shaped stationary member for transporting magnetic flux. The stationary member has been explained in detail in the description of invention. The stationary member is made of two co-planer rings with air gap between them. Stationary member has been described in the detail description of invention. The coplanar rings are connected by arms which are made of laminated layers of magnetic substance. The cylindrical stationary member has hole at the center and has two opposite surfaces surface 1 and surface 2. Each surface has at least 1 armature core. Armature core comprises of slots running in radial direction which houses insulated conductors.

Armature winding which comprising of at least 1 winding and each winding has multiple groups of coils. Each coil of multiple group of coil is formed by serially connecting the insulated conductors alternating between the conductors on the armature core which is fixed on the opposite surface of the stationary member. The armature cores are aligned with each other. Each coil is so formed has at least 2 coil side, each coil side corresponding to each armature core.

The armature system is deployed within the magnetic flux producing system with the shaft passing through hole of the stationary member in the armature system. The deployment is done in a manner that the coil side on armature core of said surface 1 faces a pole of magnet under magnetic field system 1 while the corresponding coil side on armature core of said surface 2 faces pole of magnet under magnetic field system 2. These poles of the magnets which face the corresponding coil side have same polarity.

The closed flux transport means for closed flux loop from ring magnets of said magnetic flux generated from each magnetic field system is transported in a magnetic path that includes ring magnets, armature core, stationary member and yokes of magnetic flux producing system.

In case of linear flux machine arrangement, commutatatorless and brushless DC machine with stationary armature comprises of magnetic flux producing system and armature system. The magnetic flux producing system which is permanent or electromagnetic system comprising of at least two magnetic field systems, magnetic field system 1 and magnetic field system 2. The magnetic field system 1 comprising of at least 1 rectangular yoke made of magnetic substance which is movable in linear direction. The rectangular yoke has at least one rectangular magnet deployed on its surface. The magnetic field system 2 also comprises of at least 1 rectangular yoke made of magnetic substance which is movable in linear direction. The rectangular yoke has at least one rectangular magnet on the surface which is facing rectangular magnet of magnetic field system 1 which is having rectangular magnet. The two rectangular yokes of the two magnetic field system are fixed to the non-magnetic rectangular plate.

The armature system for linear flux machine comprises of rectangular flat shaped stationary member for transporting magnetic flux and has two opposite surfaces surface 1 and surface 2. Stationary member has been described in the detail description of invention. Each surface has at least one armature core which has slots for housing groups of conductors.

Armature winding comprises of at least 1 winding. Each winding comprises of multiple groups of coils. Each coil in multiple coils is formed by serially connecting the insulated conductors alternating between the insulated conductors on the armature cores which are fixed on the opposite surface of the stationary member. The armature cores aligned with each other. Each coil so formed has at least 2 coil sides, each coil side corresponding to each armature core.

The armature system is so deployed within the magnetic flux producing system movable in linear direction that the surface 1 of the stationary member faces magnetic field system 1 while the said surface 2 of the stationary member faces magnetic field system 2. The coil side on armature core of said surface 1 faces a pole of magnet under magnetic field system 1 while the corresponding coil side on armature core of said surface 2 faces pole of magnet under magnetic field system 2. These poles of the magnets which face the corresponding coil sides have same polarity.

The magnetic flux generated from each magnetic field system is transported in a closed loop flux transport means through a magnetic path that include rectangular magnets, air gap between magnets and armature cores, armature cores, stationary member of armature system, yoke of magnetic flux producing system.

### BRIEF DESCRIPTION OF THE DRAWINGS

FIG. 1 shows view from one side of armature systems of axial flux DC machine with a member having disc shaped yokes (102, 103) having flat outer and inner rings, and fixed on two opposite sides of core (301) which is made of nonmagnetic substance. Armature cores (104, 105) fixed on outer and inner rings on the yoke (102) and armature cores (106, 107) fixed on outer and inner rings on yoke (103).

FIG. 2 shows magnetic field systems (304) and (305) with flat ring shaped magnetic poles for axial flux DC machine.

FIG. 3 shows cross sectional view of assembly of armature system with magnetic field systems (304, 305) for axial flux DC machine. The armature system having disc shaped yokes (102, 103) fixed on two opposite sides on disc (301) made of nonmagnetic substance

FIG. 4 shows assembly of armature system of radial flux DC machine with outer and inner field systems showing cross sectional view and end cap side (lateral) view. The armature system is having member (cylindrical yokes (408, 410) fitted on inner and outer periphery of cylindrical core (409)) made of non-magnetic substance.

FIG. 5 shows cross sectional view of construction of two shaft axial flux machine

FIG. 6 shows construction of two shaft radial flux machine.

FIG. 7 shows brushless electromagnetic field system arrangement for radial flux/axial flux DC machine

FIGS. 8A(1), 8A(2) and 8B show electromagnetic rotating field system for axial flux machine

FIG. 9A shows construction of south poles of electromagnetic outer magnetic field system for radial flux DC machine

FIG. 9B shows construction of north poles of electromagnetic outer magnetic field system for radial flux DC machine

FIGS. 10A and 10B show construction of north poles and south poles respectively for electromagnetic inner magnetic field system for radial flux DC machine

FIG. 11 shows the direction of induced emf and current and flux directions for radial flux DC generator.

FIG. 12 shows the direction of magnetic fluxes produced and direction of induced emf in conductors for axial flux DC generator.

FIG. 13A shows the direction of force produced on conductors in coil sides (307) and (308) on armatures (104) and (105) under magnetic field system (304) as seen from top of periphery of outer and inner rings of armature system for rotating armature type axial flux DC motor.

FIG. 13B shows the direction of forces on conductors in coil sides (307) and (308) on armatures (104) and (105) placed under magnetic field system (304) as seen from end cap (350) for rotating armature type axial flux DC motor.

FIG. 13C shows the direction of force produced on magnets (201) and (202) of magnetic field system (304) by current carrying conductors in coil sides (307)) and (308) on armatures (104) and (105) as seen from top of periphery of outer and inner rings of armature system for rotating magnetic field system (stationary armature) type axial flux DC motor.

FIG. 13D shows the direction of force produced on magnets (201) and (202) of magnetic field system (304) by current carrying conductors in coil sides (307) and (308) on armatures (104) and (105) as seen from end cap (350) for rotating magnetic field system (stationary armature) type axial flux DC motor.

FIG. 14 shows the direction of currents sent through conductors on armatures and direction of fluxes produced for radial flux DC motor.

FIG. 15A shows the direction of forces produced on conductors in armatures under north poles of outer and inner magnetic field systems for rotating armature type radial flux DC motor as seen from side of end cap (450).

FIG. 15B shows the direction of forces produced on conductors in armatures under south poles of outer and inner magnetic field systems for the rotating armature type radial flux DC motor as seen from side of end cap (452).

FIG. 15C shows the direction of forces produced on north poles of outer and inner magnetic field systems (on magnets 412 and 403) by conductors (427, 431) in coil sides (425, 405) respectively and the direction of rotation of field system for the rotating field system (stationary armature) type radial flux DC motor as seen from side of end cap (450).

FIG. 15D shows the direction of forces produced on south poles of outer and inner magnetic field systems (magnets 413 and 411) by conductors (428, 433) in coil sides (429, 432) respectively and the direction of rotation of field system for rotating field system (stationary armature) type radial flux DC motor as seen from side of end cap 452.

FIG. 16A shows multiple pieces of permanent magnets arranged to produce pipe shaped cylindrical magnets facing their north poles towards respective armatures for outer and inner magnetic field systems for radial flux DC machine.

FIG. 16B shows similarly multiple pieces of permanent magnets arranged to produce pipe shaped cylindrical magnets with south poles facing towards respective armatures for outer and inner magnetic field systems for radial flux DC machine.

FIG. 17A shows the direction of force produced on conductors in coil sides (309) and (310) on armatures (106) and (107) under magnetic field system (305) as seen from top of periphery of outer and inner rings of armature system for rotating armature type axial flux DC motor.

FIG. 17B shows the direction of forces on conductors in the coil sides (309) and (310) on the armatures (106) and (107) placed under the magnetic field system (305) as seen from end cap (352) for the rotating armature type axial flux DC motor.

FIG. 17C shows the direction of forces produced on magnets (204, 206) of magnetic field system (305) by current carrying conductors in the coil sides (309) and (310) on armatures (106) and (107) as seen from top of periphery of outer and inner rings of armature system for rotating field system (stationary armature) type axial flux DC motor.

FIG. 17D shows the direction of forces produced on magnets (204, 206) of magnetic field system (305) (and direction of its rotation) by current carrying conductors in coil sides (309) and (310) on armatures (106) and (107) as seen from end cap (350) for rotating field system (stationary armature) type axial flux DC motor.

FIG. 18 shows the direction of magnetic fluxes produced and the direction of currents sent through conductors for axial flux DC motor.

FIG. 19 shows the overall assembly including bearings, fan, end caps and body for radial flux DC machine.

FIG. 20 shows the overall assembly including bearings, fan, end caps and body for axial flux DC machine.

FIG. 21 shows the outer and inner magnetic field systems each with single pipe shaped magnet. Another magnet is replaced by magnetic yoke with same shape and size of magnet for radial flux DC machine.

FIG. 22 shows two magnetic field systems each with single flat ring shaped magnet another magnet is replaced by magnetic yoke with same shape and size of magnet for axial flux DC machine.

FIG. 23 shows assembly of axial flux machine with electromagnetic field system.

FIG. 24 shows axial flux machine with rotating armature and stationary magnetic field system.

FIG. 25A shows lateral view of electromagnetic field system showing single set each of outer and inner electromagnet.

FIG. 25B shows the another set of electromagnet in electromagnetic field system in which inner and outer electromagnets are replaced by yoke.

FIG. 26 shows radial flux machine with rotating armature system and stationary field system.

FIGS. 27A(1), 27A(2) and 27B show construction of electromagnetic field system with single set of electromagnets for each field system while another set replaced by a yoke for axial flux DC machine.

FIG. 28 shows assembly of armature system with electromagnetic field system having single set of electromagnets for each field system while another set is replaced by yoke, for axial flux DC machine.

FIG. 29 shows assembly of armature system with electromagnetic field system from one lateral side for radial flux machine.

FIG. 30 shows axial flux machine with permanent magnetic field system, where flat ring shaped pole is formed by multiple permanent magnets.

FIG. 31A shows top view of armature system taken from below the magnetic field system; for linear brushless DC motor with stationary armature having conductors in the form of bars; and moving magnetic field system.

FIG. 31B shows right hand side view of embodiment) in FIG. 31D for linear brushless DC motor; showing the direction of force on magnet (3007) and yoke (3008) and the direction of their motion w.r.t. stationary armature core (3006).

FIG. 31C shows right hand side view of embodiment) in FIG. 31D for linear brushless DC motor taken from vertical central plane drawn between armature core (3006) and armature core (3012); showing direction of force on magnet (3009) and yoke (3008) and direction of their motion w.r.t. stationary armature core (3012).

FIG. 31D shows cross sectional front view of embodiment); for linear brushless DC motor showing two armature cores with conductors under magnetic field system.

FIG. 31E shows another example of embodiment 1; showing cross sectional front view of embodiment 1 in FIG. 31D with magnetic field system having single magnet; with another magnet replaced by yoke; for linear brushless DC motor.

FIG. 31F shows cross sectional view front view for one more example of embodiment 1 in FIG. 31D; with stationary magnetic system fixed with body of motor and moving armature system.

FIG. 32A shows cross sectional front view for embodiment 2 for linear brushless DC motor; with armature system having armature cores (4030,4031) & (4032, 4015) having coils of armature winding in it, fixed on yokes (4014,4017); under magnetic field systems comprising of magnets (4008, 4009, 4007, 4010) and yokes (4011,4012). Member comprising of yokes (4014, 4017) and core (4016), said yokes are fixed on two opposite flat surfaces of core (4016) which is made of non-magnetic substance.

FIG. 32B shows left hand side view of embodiment 2 shown in FIG. 32A; for linear brushless DC motor, showing directions of forces applied on and directions of motions of magnets (4008) and (4007) and yokes (4011) and (4012) w.r.t. stationary armature cores (4030) and (4032).

FIG. 32C shows left hand side view taken from vertical central plane drawn between magnets (4008) and (4009); of embodiment 2 shown in FIG. 32A; for linear brushless DC motor, showing directions of forces applied on and directions of motions of magnets (4009) and (4010) and yokes (4011) and (4012) w.r.t. stationary armature cores (4031) and (4015).

FIG. 32D shows cross sectional front view for embodiment 2 shown in FIG. 32A; with one of the magnets fixedly fixed to yoke (4011) is replaced by one yoke and one of the magnets fixedly fixed to yoke (4012) is replaced by another yoke; for linear brushless DC motor.

FIG. 33 shows assembly of armature system of radial flux DC machine with outer and inner field systems showing cross sectional view and end cap side (lateral) view. Armature cores (421, 422) fitted on outer periphery of member (cylindrical yoke (444)) while armature cores (407, 422) fitted on inner periphery of member (yoke (444)).

FIG. 34 shows cross sectional view of assembly of armature system with magnetic field systems (304 and 305) for axial flux DC machine. Armature system having armature cores (104, 105) fixed on flat ring shaped surface of outer and inner ring of member (yoke (117)) on one flat side of member (yoke (117)) while armature cores (106, 107) fixed on flat ring shaped surface of outer and inner ring of member (yoke (117)) on another flat side of member (yoke (117)).

FIG. 35 shows cross sectional front view for linear brushless DC motor/generator; with armature system having armature cores (4030, 4031) and (4032, 4015) having coils of armature winding in it, fixed on two opposite surfaces of member (yoke (4049)); under magnetic field systems consisting of magnets (4008, 4009) & (4007, 4010) and yokes (4011, 4012).

FIG. 36 shows view from one side of armature systems of axial flux DC machine with member (disc shaped yoke (117)) made of magnetic substance having flat outer and inner rings, armature cores (104, 105) fixed on the flat surfaces of outer and inner rings on member yoke (117) on one flat side of yoke (117) and armature cores (106, 107) fixed on flat surfaces of outer and inner rings on another flat side of member (yoke (117)).

### DETAILED DESCRIPTION OF THE INVENTION WITH REFERENCE TO THE DRAWINGS AND ILLUSTRATED WITH EXAMPLES

The commutatorless, brushless DC machine with stationary armature which is disclosed in present invention comprises of magnetic flux producing system and armature system. The term magnetic flux producing system comprises of more than one magnetic field system, where each magnetic field system comprises of field magnets or permanent magnets, field coils and yoke for producing magnetic flux. The present invention also discloses closed loop flux transport means which refers to a closed magnetic path to transport magnetic flux through it. The term prime mover used in this document refers to the source of mechanical energy when DC machine acts as a DC generator which may include internal combustion engine or steam engine or wind turbine or water falling through turbine. In the present invention, the term “member” used in reference to the armature system can be used to define either a single yoke made of magnetic material or used as a combination term for a pair of yokes made of magnetic substance with nonmagnetic core. Further this member is termed as stationary member in the commutatorless, brushless machine with stationary armature. In the embodiments wherein commutatorless DC machine stationary is with rotating armature or movable armature member is termed as movable or rotatable member.

The DC machine can be identified by the type of magnetic field system used for creating magnetic flux. Usually, permanent field systems are used for small, portable and low power rated electrical machines while powerful electromagnetic field systems are employed for medium and large power rated electrical machines. In both types of machines, the deployment of the armature may be a radial flux type or an axial flux type.

In an instant invention, the radial, axial or linear arrangements comprises of magnetic flux producing system having at least one magnetic field preferably two magnetic field systems i.e. magnetic field system 1 and 2, and the armature system having stationary member, whose geometrical cross section may be cylindrical, disc shaped or rectangular depend on the type of arrangement i.e. radial, axial or linear respectively.

The present invention provides for commutatorless, brushless DC machine with stationary armature. DC machine is deployed in DC machine body. The DC machine comprises of magnetic flux producing system and armature system with an air gap between them in radial, axial or linear arrangements. The magnetic flux producing has at least one magnetic field system preferably two magnetic field systems. This may be a pair of movable or rotatable magnetic field systems having at least one magnet. DC machine has at least one closed loop flux transport means in the form of magnetic path in each magnetic field system.

The armature system comprises of at least 1 stationary member for transporting magnetic flux and has at least 2 surfaces. Each surface of stationary member has at least one armature core which has multiple slots, each slot housing a group of insulated conductors. The armature winding of armature system comprises of at least one winding. Winding comprises of multiple groups of coil. Each group of coils comprises of multiple coils. Each coil is formed by serially connecting insulated conductors alternating between the conductors on each of the armature cores which are fixed on opposite surfaces i.e. surface 1 and surface 2. Each coil so formed has at least 2 coil side, each coil side corresponding to each armature core.

The armature system is deployed with in the magnetic flux producing system which is movable or rotatable. The deployment is done in a manner that the coil side on armature core of the surface 1, faces pole of magnet under magnetic field system 1 while the corresponding coil side on armature core of the surface 2 faces pole of magnet under magnetic field system 2. These poles of the magnets face the corresponding coil sides have same polarity.

In the exemplary embodiments, the arrangement of commutatorless and brushless machine which can be radial or axial flux DC machine is explained in more elaborated manner.

### A: Radial Flux Type DC Machine:

In the radial flux type DC machine, the magnetic flux travels in radial direction and the DC machines are usually cylindrical in shape with the rotating field system being on either side of armature system portion. The novelty and the inventive step in the radial flux type DC machine of the present invention as well as its working principle are described in exemplary embodiments.

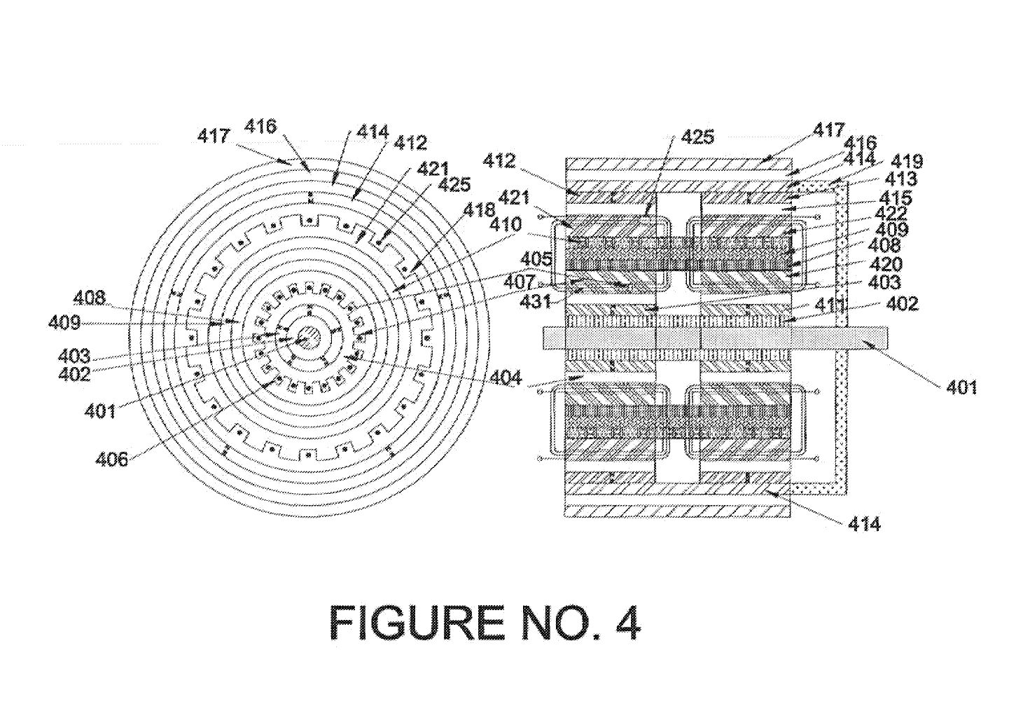

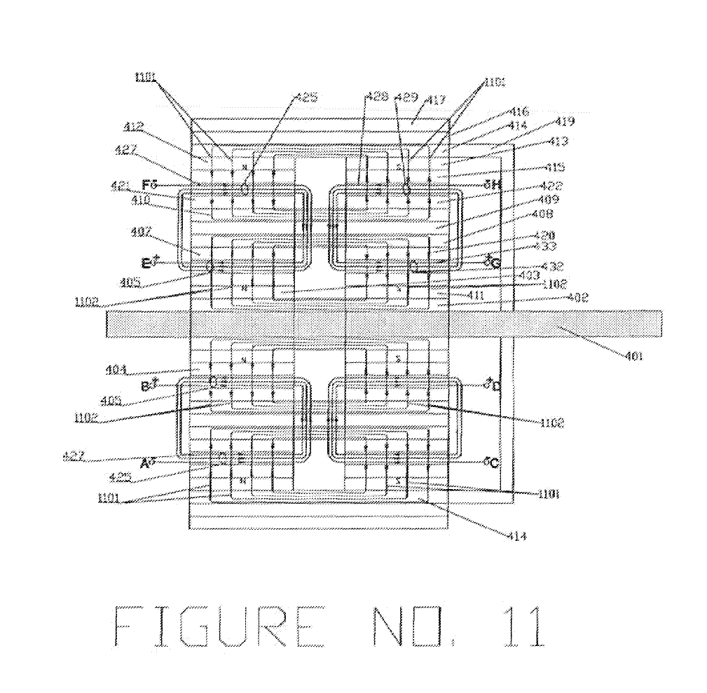

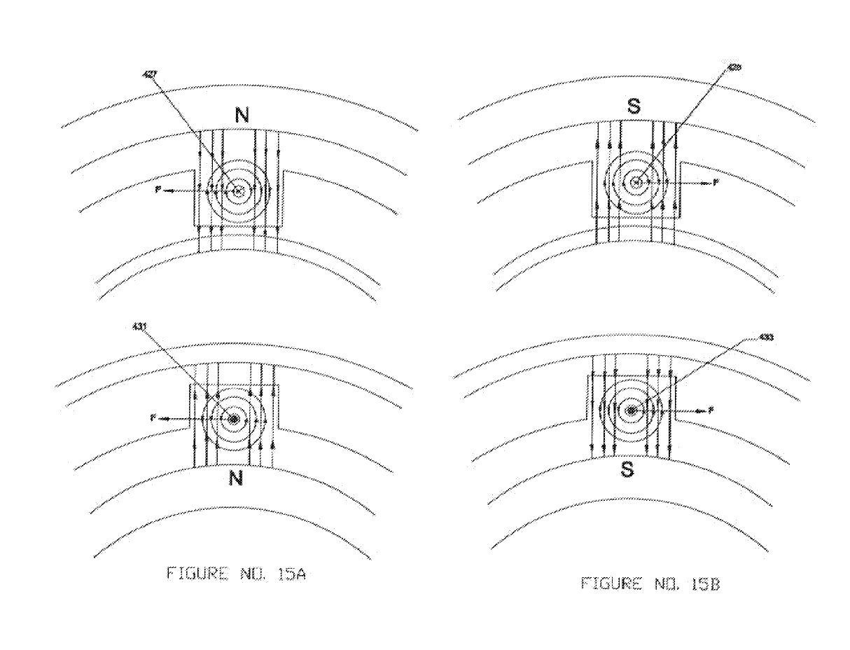

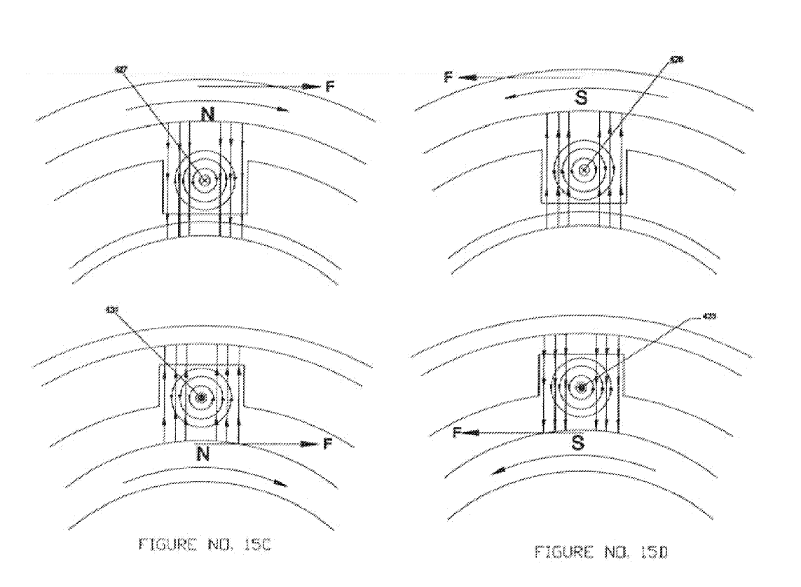

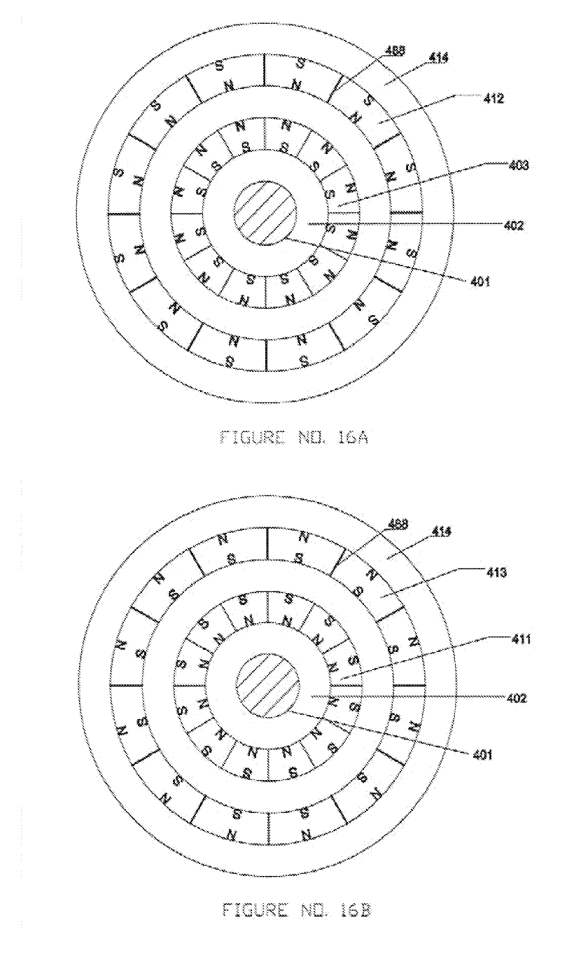

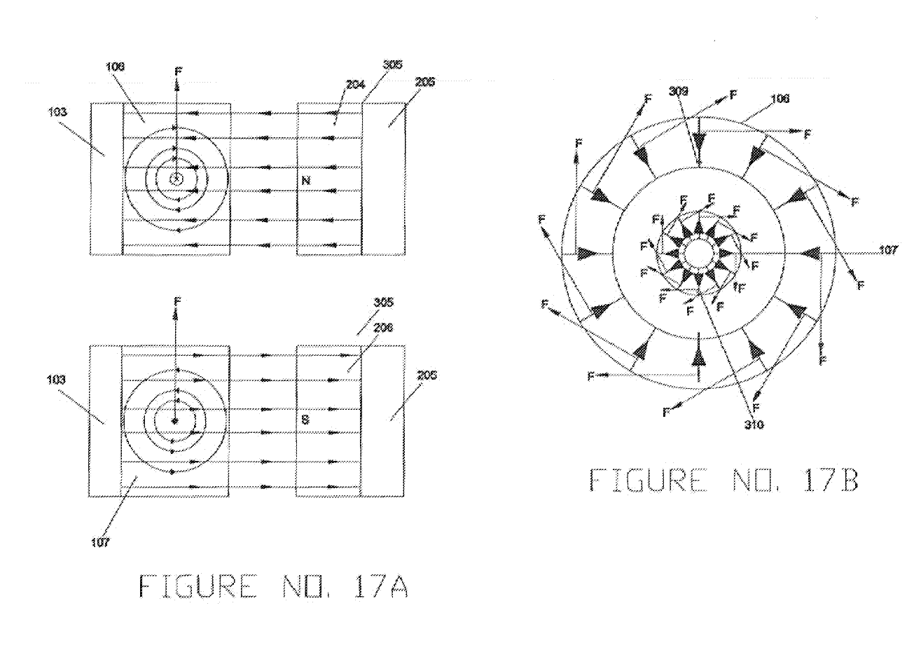

The general assembly of the radial flux type DC machine is explained with the help of FIGS. 4, 6, 19 and 33. The radial flux type DC machine operating as DC motor are explained in FIGS. 14, 15A, 15B, 15C and 15D while the radial flux type DC machine operating as DC generator is explained in FIG. 11.

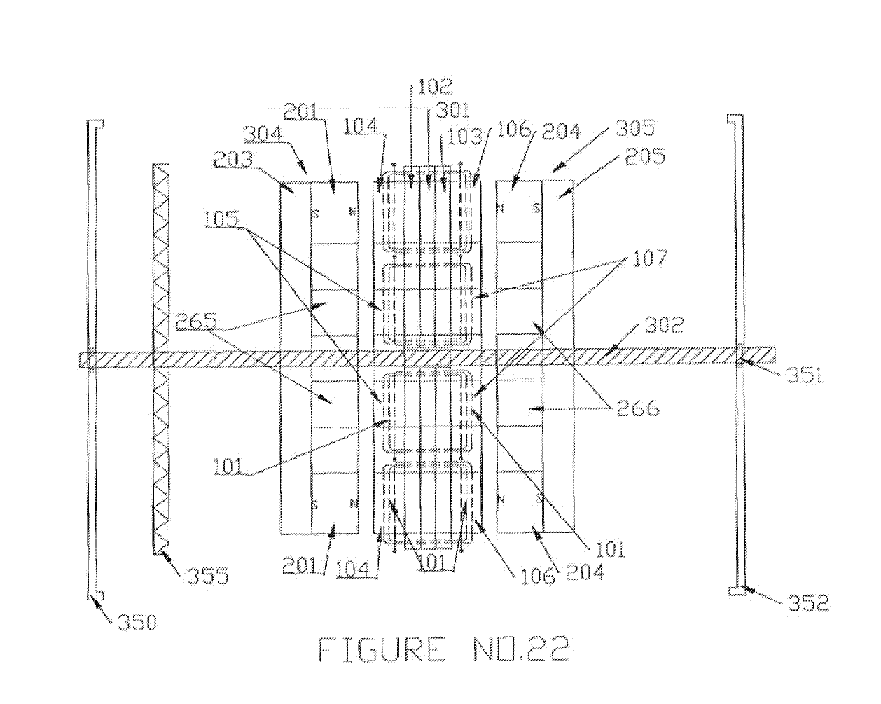

The present invention when directed to radial flux type DC machine comprises a rotary shaft (401) which is rotatably supported on bearings in the bearing housing (451) which are fixed in end caps (450) and (452). The said end caps are fixed to the body of DC machine (417). The said body (417) is generally cylindrical to enclose substantial portions of the machine, and which is fixed on base, not shown in FIG. 19. There are 4 yokes (402, 408, 410, and 414) and one non-magnetic core (409). One yoke (402) is deployed on the shaft (401). Another yoke (408) is deployed on the inner periphery of the non-magnetic core (409) while the yoke (410) is deployed on the outer periphery of the non-magnetic core (409). The yoke (414) is disposed towards the machine body.

The said magnetic flux producing system for the said radial DC machine comprises of at least two magnetic field systems, inner and outer magnetic field system. This aforementioned radial arrangement also comprises 2 sets of permanent magnets viz, a pair of outer permanent magnets (412, 413) which are deployed on the inner periphery of the yoke (414) forming the inner magnetic field system, and a pair of inner permanent magnets (403, 411) deployed on the outer periphery of yoke (402) forming the outer magnetic field system.

The armature system of the radial flux DC machine comprises of inner armature cores (407, 420), outer armature cores (421, 422), stationary member which is combination of yokes (408, 410) and non-magnetic core (409) and armature winding (explained elsewhere). The entire armature system is fixedly mounted to the machine body through said yokes and core via end cap (450). The end cap (450) may be either attached to machine body or may form an integral part of the machine body (417).

The shaft (401) supports the first yoke (402) which is generally cylindrical and made of laminated layers of magnetic substance. The said yoke (402) carries a pair of permanent magnets (403) and (411) each of which are generally cylindrical, covering at least partially the outer periphery of the said yoke. The permanent magnet (403) is magnetized such that its outer and inner peripheral portions have north (N) and south (S) poles respectively while the other magnet (411) is magnetized vice versa i.e. its outer and inner peripheral portions have south (S) and north (N) poles respectively. Rotary shaft (401), the first yoke (402), permanent magnets (403 and 411) form the inner magnetic field system of the DC machine.

The second yoke (408) is fixed to the machine body via end cap (450). Armature cores (407) and (420) are fixed on inner cylindrical periphery of the said second yoke (408) which is also surface 1 of stationary member in longitudinal direction. The outer cylindrical periphery of the said armature cores (407) and (420) touch the inner periphery of the yoke (408) in such way that axial length of core (407) aligns with the length of the said permanent magnet (403) and axial length of said armature core (420) aligns with that of the said permanent magnet (411) on the said rotary shaft (401).

There are slots on the inner periphery of armature cores (407, 420) which run in axial direction. There is adequate air gap (404) between the outer peripheral surface of the permanent magnets (403, 411) and inner periphery of said armature cores (407, 420). Axial length of yoke (408) is sufficient to cover axial lengths of armature cores (407, 420) and axial spacing between the said armature cores (407, 420).

The said second yoke (408) and the said inner armature cores (407, 420) are cylindrical in shape and are made of laminated layers of magnetic substance. However, the cylindrical pipe shaped core (409) is made of non-magnetic substance. The said core (409) is fitted on outer cylindrical periphery of said yoke (408) and fixed on the said motor body (417) via end cap (450). The length of the said non-magnetic core (409) extends up to that of the said yoke (408), and its main function is to isolate the magnetic flux produced by outer and inner magnetic field systems.

The third yoke (410) which is also cylindrical in shape and made of layers of laminated magnetic substance is fixed on the outer cylindrical periphery which is surface 2 of the stationary member of said core (409) while the inner cylindrical periphery of said yoke (410) touches the outer cylindrical periphery of said core (409). The said third yoke (410) is also fixed on the machine body (417) via end cap (450).

Another pair of armature cores (421, 422) is fixed on the outer periphery (surface 2 of stationary member) of the said yoke (410) in longitudinal direction. Both said outer armature cores (421, 422) are in cylindrical shape and are made of layers of laminated magnetic substance. The inner cylindrical periphery of the armature cores (421, 422) touches the outer periphery of the yoke (410) in such way that axial length of the said outer armature core (421) is equal to the inner armature core (407) and aligns with it, while the axial length of said outer armature core (422) is equal and aligns with that of the inner armature core (420).

There are slots on the outer periphery of outer armature cores (421, 422), which run in axial direction. Axial length of the yoke (410) is sufficient to cover the axial length of outer armature cores (421, 422) and axial spacing between the said outer armature cores.

There are radial through holes (openings) which are aligned and made through yoke (410), core (409) and yoke (408) in front of opening of slots in inner armature cores (407) and the corresponding outer armature core (421) on the both sides of the armature cores (407, 421), i.e. on the left hand side towards the end cap (450) and the right hand side towards the dividing space. The same arrangement is repeated for armature cores (420) and (422) which are on the other side of the dividing space. This arrangement been depicted in FIG. 19. The part of armature coils which joins conductors in two coil sides of said coil, passes through this hole/opening.

In order to create an outer magnetic field, the yoke (414) made of laminated layers of magnetic substances and having cylindrical pipe shape, is fixed to the rotary shaft by fixing means (419), which is free to rotate with the shaft 401. The yoke (414) carries a pair of permanent magnets (412, 413), which are generally cylindrical in shape. The said permanent magnets (412, 413) are fixed to the inner periphery of the said yoke (414) in such way that axial length of said permanent magnet (412) is equal to the axial length of the armature core (421) and aligns with it, while axial length of said permanent magnet (413) is equal to, and aligns with that of armature core (422). The permanent magnets (412, 413) are magnetized in such a way that inner peripheral portion facing the outer armature cores (421, 422) respectively have the same polarity as that on the outer peripheral portion of inner magnets (403, 411) respectively. With reference to FIG. 19 the said outer permanent magnet (412) has north pole (N) on its inner peripheral portion facing the armature core (421) while the south pole (S) which is on the outer periphery is touching the inner periphery of said yoke (414). Similarly the other outer permanent magnet (413) has the south pole (S) on its inner periphery facing the armature core (422) while the north pole (N) on the outer periphery of same permanent magnet, is touching with the inner periphery of said yoke (414). Rotary shaft (401), means (419), yoke (414), permanent magnets (412, 413) form the outer magnetic field system.

Insulated conductors are placed in slots in armature core. A coil is series connection of multiple insulated conductors. A coil side is a group of insulated conductors in a coil which are in the same slot of the armature core. FIG. 14 depicts coil sides (425, 405) placed in a slot in the armatures (421) and (407) respectively. These coil sides (425 and 405) are in fact a group of conductors (427) and (431) respectively. A coil is formed by connecting one conductor (427) from coil side (425) to another conductor (431) from coil side (405), with this arrangement alternating until all conductors are connected to form coil with terminals. Conductors in the coil sides (425 and 405) are connected in series through conductors which pass through the radial holes (mentioned above) on both sides of the armature cores (421 and 407) and which are also part of same coil.

Armature winding comprises of at least 1 winding (1, 2 . . . n), each said winding have multiple groups of coils which are connected serially or parallel, however in the preferred embodiment only two winding 1 and 2 has been described.

Now referring to FIG. 14, north poles facing coil sides on each coil in the said group of multiple coils bears terminals (E,F/A,B/E′,F′/A′,B′ . . . n) such that terminals E, B, E′, B′ are on a coil sides (405) present on the slots of the inner armature core while the corresponding terminals F, A, F′, A′ are on the adjacent coil sides (425) present on the slots of the outer armature core. These terminals are so connected that terminal E is connected A, B is connected to F′, E′ connected to A′ and so on till all the coils are connected to form serially connected group of multiple coils.

Similarly a coil side (429) in a slot in the armature core (422) and a coil side (432) in a slot in the armature core (420) form a coil. South poles facing coil sides on each coil in the said group of multiple coils bears terminals (G,H/D,C/G′,H′/D′,C′ . . . n) such that the terminals (G, D, G′, D′) are on coil side (432) present on the slots of the inner armature core while the corresponding terminals H, C, H′, C′ are on the adjacent coil side (429) present on the slots of the outer armature core, such terminals being so connected that terminal G is connected to C, D is connected to H′, G′ connected to C′ and so on till all the coils are connected to form serially connected group of multiple coils, each said serially connected group of multiple coils having two end terminals, inner end terminal and outer end terminal.

One set of winding of multiple groups of said coils having coil sides (425, 405) i.e. winding 1, comprises of serially connected multiple said groups in a manner that the inner end terminal of first group is joined to the outer end terminal of second group, inner end terminal of second group is joined to the outer end terminal of third group, so on till all the groups having said coils each with coil sides (425, 405) are connected, with terminal START of first group marked as terminal START of winding 1 and terminal FINISH of last group marked as terminal (finish) of winding 1.

Alternatively, winding 1 is formed by parallel connection of said multiple groups of serially connected said coils with outer end terminals of all multiple groups connected together and marked as START of winding 1 and inner end terminal of all multiple groups connected together and marked as terminal FINISH of winding 1, wherein each group includes equal number of coils in series, each coil having equal number of conductors in it.

Winding 2 is identical to winding 1 but having said groups, each said group having coils with coil sides (429, 432).

Armature winding comprises of said winding 1 and said winding 2 connected serially in manner that terminal FINISH of winding 1 is connected to terminal START of winding 2 with terminal START of winding 1 marked as terminal A1 and terminal FINISH of winding 2 marked as terminal A2 of armature winding. Alternatively armature winding comprises of said winding 1 and said winding 1 connected in parallel in a manner that terminal START of both windings connected together and marked as terminal A1 of armature winding and terminal FINISH of both windings connected together and marked as terminal A2 of armature winding.

Aforementioned explained construction of armature winding remain same for DC machine operating as DC generator or DC motor.

During DC motor operation, when DC voltage with “one” polarity is applied across the terminals A1 and A2 of the armature winding, then current direction in conductors in all coil sides (425, 405, 429, 432) are maintained as shown by arrows in FIG. 14. (FIG. 14 depicts radial flux type DC machine operating as DC motor). The current direction in conductors in all coil sides (425, 405, 429, 432) will be opposite to those shown by arrows on the conductors in FIG. 14, if DC voltage with “another” polarity (which is opposite to“one” polarity), is applied across armature winding terminals A1 and A2.

The two terminals of armature winding marked as A1 and A2 are taken out through axial holes in either one of the yokes (410, 408) or the nonmagnetic substance core (409) and then through a hole in the end cap (450) or through machine body (417). DC voltage is supplied across the two terminal A1 and A2 in case of radial flux machine operating as DC motor or induced DC voltage is available across terminals A1 and A2, in case of DC machine operating as DC generator.

### Radial Flux Type DC Machine Working as DC Generator.

FIG. 11 shows the direction of induced emf in conductors based on the assumption that direction of rotation of the outer and inner magnetic field system is in anticlockwise direction, when seen from the side end cap (450) in FIG. 19

The working principle of DC radial flux generator is based on Fleming's right hand rule which shows the direction of induced emf and current flow through conductor when conductor moves in magnetic field. According to this rule if the first three fingers of right hand are placed mutually at right angles with each other then the thumb indicates the direction of motion of conductor, fore finger indicates direction of flux, the middle finger indicates direction of induced emf in conductor and direction of current flow in it.

There are two isolated magnetic field systems of which one is the inner magnetic field while the other is the outer magnetic field both of which are rotated in the same direction. The outer and the inner magnetic fields produce magnetic flux lines (1101) and (1102) respectively. The magnetic flux lines (1101) emerges out from north pole of the magnet (412), passes through the closed flux transport loop which is a magnetic path which traverses the air gap (415), moves through the conductors (427) from coil side (425) mounted in armature core (421), through the yoke (410) longitudinally, armature core (422), conductors (428) from coil side (429), air gap (415), south pole of magnet (413), yoke (414) and finally through the north pole of magnet (412).

Similarly the magnetic flux lines (1102) from the inner magnetic field (1102) emerges out from the north pole of magnet (403), and is transported in the closed flux transport loop which is the magnetic path which includes air gap (404), conductors (431) from coil side (405) mounted in armature core (407) and then through yoke (408) longitudinally, armature core (420), conductors (433) from coil side (432), air gap (404), south pole of magnet (411), yoke (402) and finally through the north pole of magnet (403).

With the above mentioned direction of rotation of the outer and inner magnetic field systems i.e. anticlockwise rotation as seen from the side end cap (450) (refer FIG. 19), relative direction of rotation of all armatures including coil sides and conductors will be in clockwise direction as seen from side of end cap (450). Now by applying Fleming's right hand rule to the conductors in the armature cores (421 and 422) which are under the outer magnetic flux lines (1101), the direction of induced emfs in all conductors is shown by arrows as given in FIG. 11. The direction of the induced emf in the conductors in the armature (421) is opposite to the induced emf in those conductors that are in the armature (422) because the magnetic flux lines (1101) are set up in opposite direction when passing through the respective conductors.

Similarly Fleming's right hand rule applies to the conductors in the inner armature cores (407, 420), which are under the magnetic flux lines (1102), the direction of induced emfs in all conductors (431) in coil side (405) and the direction of induced emf in all conductors (433) in coil side (432) is as shown by arrows on conductors (431, 433). It is to be noted that the direction of the induced emfs in all conductors (433) in the coil side (432) in armature (420) is opposite to that in the conductors (431) because the magnetic flux lines (1102) are set up in opposite direction when passing through the respective conductors.

The direction of emfs in all conductors in each coil side is identical. Further each coil side cuts the magnetic flux of the same pole throughout the rotation. Since the direction of emfs in all conductors in each coil side is the same throughout the duration of rotation, it means that the emf induced in all conductors in each coil side is DC emf. Further in one complete rotation, the direction of the magnetic flux is at right angle with regard to relative direction of motion of conductor so that the induced emf has constant value throughout just like pure DC voltage from battery. This constant value of pure DC emf in conductor is proportional to the speed of rotation.

The directions of emfs in the conductors in coil side (405) and (425) are such that the value of the emf induced in the coil formed from the said coil sides is the sum of emfs induced in all conductors in the said coil sides. One such coil is shown with terminals E and F in FIG. 11 where terminal E is positive while terminal F is negative. Similarly in another coil the induced emf is such that terminal B is positive w.r.t terminal A. There are multiple such coils, each having one coil side in a slot on armature (407) and another coil side in a slot on armature (421).

Similarly the directions of emfs in the conductors in coil side (429) and (432) are such that the value of the emf induced in the coil formed from the said coil sides is the arithmetic sum of emfs induced in all conductors in the said coil sides.

The above arrangement can be replicated for the coils having coil sides (429) and (432) which are respectively under south poles of the magnets (413, 411) of outer and inner magnetic field systems. The direction of the emf induced in such coils having for e.g. terminals G and H in one coil and terminals C and D in another, is such that terminals G and D are positive while terminals H and C are negative.

Winding 2 may be formed with multiple coils having terminals similar to G, H, C, D being connected in the same manner as described above for Winding 1.

Armature winding construction for DC machine working as DC generator having above said coils with coil sides (425,405) and (429,432) is identical to that mentioned under radial flux DC machine. The output DC voltage and DC power is available across terminals A1 and A2.

### Radial Flux Type DC Machine Working as a DC Motor:

FIGS. 14, 15A, 15B, 15C and 15 D are used to explain the DC machine working as a DC Motor. FIG. 14 shows the direction of flux generated by the inner magnetic field system and outer magnetic field systems and it also shows the direction of currents sent through the armature conductors. FIG. 15A shows the direction of force produced on conductors in armatures under north poles of the outer and inner magnetic fields as seen from end cap (450) (shown in FIG. 19) for rotating armature system radial flux DC motor while FIG. 15B shows force on conductors in armatures under south poles of outer and inner magnetic field system as seen from end cap (452) for rotating armature system radial flux DC motor. FIG. 15C shows the direction of forces produced on north poles of outer and inner magnetic field systems i.e. on magnets (412) and (403), by conductors in coil sides (425 and 405) respectively for rotating field system (stationary armature) type radial flux DC motor, while FIG. 15D shows direction of forces produced on the south poles of outer and inner magnetic field systems i.e. on magnets (413) and (411), by conductors in coil sides (429) and (432) respectively for rotating field system (stationary armature) type radial flux DC motor.

Working of DC motor is based on Fleming's left hand rule which states that if first three fingers of left hand are placed mutually at right angles to each other and if middle finger indicates direction of current in conductor; the fore-finger indicates the direction of magnetic field (flux) then the thumb indicates direction of force on conductor and thereby direction of motion of conductor.

The coils of armature winding are energized by applying DC voltage across the armature terminals A1 and A2. An appropriate value of DC voltage is also applied across the winding terminals of outer as well as inner magnetic field systems in case of electromagnetic field system with such polarity so as to produce flux as shown in FIG. 14. The direction and path of flux lines is shown in FIG. 14. One of the direction in which DC voltage is applied across the terminals A1 and A2 is such that the polarities of potential difference are created across four coils for e.g. terminal F is positive w.r.t terminal E, terminal A is positive w.r.t terminal B, terminal H is positive w.r.t terminal G and terminal C is positive w.r.t. D. This results in direction of currents flowing through conductors (431, 427, 433 and 428) from coil sides (405, 425, 432 and (429) respectively as indicated by arrows on the conductors.

FIG. 15A depicts 2 conductors of which one of the conductors (427) (only one conductor is shown for simplicity) of coil side (425) is under the north pole of the outer magnetic field systems while the other conductor (431) from coil side (405) is under the north pole of the inner magnetic field system. When direction of current for the conductor (427) as shown in FIG. 14 is seen from the side end cap (450) which is depicted in FIG. 19, then the direction of the current will be going away from the observer and it is cross marked as shown in FIG. 15A. Similarly, the direction of current for the other conductor (431) will be towards the observer as shown by dot marked on the conductor (431) in FIG. 15A.

The conductor (427) while carrying current creates a circular self-flux which is in clock-wise direction. Similarly the self-flux created around conductor (431) carrying current is in anticlockwise direction. FIG. 15A shows that the flux from outer magnetic field's north pole is in the downward direction. Due to interaction of the said magnetic flux from the outer magnetic field's north pole with the self-flux produced by the said conductor (427) there is an increase in the total flux on the right hand side of the conductor while there is decrease in the total flux in the left hand side of the conductor. This imbalance of flux or differential flux on the said conductor (427) leads to the development of force, which causes the conductor (427) to move to its left thereby resulting in the rotation of armature fitted on the shaft in anticlockwise direction as seen from end cap (450). The direction of force is also given by Fleming's left hand rule.

But in case of DC machine with stationary armature, since the armature and the conductor are stationary and outer magnetic field system is free to rotate, then the said force acts on outer magnetic field system. Therefore the said force acts in right hand direction on magnet (412) opposite to the direction shown in FIG. 15A thereby causing the rotation of the outer magnetic field in clockwise direction w.r.t stationary conductor and hence w.r.t stationary armature (421) as shown by curved arrow on magnet in outer magnetic field, in upper part of FIG. 15C.

Similarly flux from inner magnetic field's north pole is in upward direction. Due to interaction of the said magnetic flux from the inner magnetic field north pole with the self-flux produced by the said conductor (431) there is increase in total flux on the right hand side of the conductor while there is decrease in total flux in the left hand side of the conductor (431). This imbalance of flux or differential flux on the said conductor (431) leads to the development of force which causes the conductor (431) to move to its left thereby resulting in the rotation of armature in anti-clockwise direction—for rotating armature type radial flux DC motor. The direction of force on conductor placed in magnetic field is also given by Fleming's left hand rule. Since the armature system and conductors are stationary and inner magnetic field system is free to rotate, hence said force acts on the inner magnetic field system (on magnet (403)) which is free to rotate in opposite direction i.e. in right hand side direction (opposite to the direction shown in FIG. 15A for force on conductor). Thus, thereby causing the rotation of the inner magnetic field in clockwise direction as seen from side of end cap (450), with respect to stationary conductor (431) residing in stationary inner armature (407) as shown by curved arrow on magnet in the inner magnetic field, in lower part of FIG. 15C.

FIG. 15B shows the direction of current flow as well as the magnetic field for conductor (428) from coil side (429) in armature (422) and for conductor (433) from coil side (429) from armature (420). When the direction of current flow in both the conductors (428) and (433) as shown in FIG. 14 is seen from side end cap (452) which is depicted in FIG. 19, then the direction of current flow for both the conductors (428) and (433) will be as shown in FIG. 15 B. FIG. 15B also shows the self-flux generated by these current carrying conductors (428) and (433). Applying above mentioned explanation or Fleming's Left hand rule for the conductors (428) and (433) the direction of force which acts on the conductors (428) and (433) is shown in FIG. 15B. The direction of force is such that it causes both the conductors (428, 433) to move to their right when seen from side end cap (452) (to left when seen from side end cap (450)) which is depicted in FIG. 19. This force results into rotation of armature system in clockwise direction as seen from end cap (452) (anti-clock wise seen from end cap (450)), for the rotating armature type radial flux DC motor.

But in case of DC machine with stationary armature as shown in FIG. 15D since the conductors (428, 433) and armature are fixed with DC machine so opposite force act on the outer and inner magnetic fields i.e on magnets (413 and 411). Therefore both outer and inner magnetic fields rotate in anticlockwise direction as seen from end cap (452) (clock wise direction as seen from end cap 450) while the direction w.r.t stationary armature (420, 422) are depicted by curved arrow on magnet in inner magnetic field and outer magnetic field.

Hence forces act in clockwise direction on both the outer and inner magnetic field system when seen from the end cap (450), thereby causing the rotation of the both magnetic field system in clockwise direction.

In brief, the radial flux DC machine operates as DC motor when the directions of the currents sent through conductors in coil sides (405, 425, 432, 429) are such that the forces acting on north pole and south pole of the outer magnetic field system as well as inner magnetic field system are in the same direction w.r.t stationary armature systems. For current directions in conductors in above said coil sides as shown in FIGS. 14, 15A, 15B, 15C and 15D, the rotation of outer magnetic field system is in clockwise direction as seen from end cap (450). Similarly the forces acting on the north pole and the south pole of inner magnetic field are in the same direction w.r.t stationary armature systems, resulting in the rotation of inner magnetic field system in the same clockwise direction as seen from the end cap (450).

In order to reverse the direction of rotation of outer and inner magnetic field systems i.e. to reverse the direction of rotation of the DC motor, the emf can be applied to the armature winding terminals in such a way that the current direction in conductors in all the above said coil sides will be opposite to that shown in the FIGS. 14, 15A, 15B, 15C and 15D.

During DC motor operation, the emf having polarity opposite to the DC voltage across armature terminal A1 and A2, is induced in the armature conductors. This occurs due to the cutting of rotating magnetic flux by the stationary armature conductors in DC machines with stationary armature. In case of DC machine with rotating armature, the emf is induced due to the cutting of stationary magnetic field by rotating armature conductors. In both instances this emf is known as back emf (Eb). The amount of Armature current (Ia) drawn by armature winding from DC supply, can be computed using the following expression

Ia=(V−Eb)/Ra, where Ra is resistance of armature winding.

It is to be noted that the back emf (Eb) is directly proportional to the relative speed of rotation (N) of armature w.r.t. field systems. When mechanical load on motor is increased, relative speed decreases. This results in the decrease of back emf and increases armature current Ia drawn from supply. In case of decrease of load, speed increases, thereby increasing back emf at the same time decreasing armature current Ia as per above expression. Thus armature current and the power drawn from DC supply is always proportional to mechanical load on motor. Armature current is governed by back emf. Therefore back emf is also referred to the governor of DC motor.

Speed of rotation of DC motor is given by speed N=k Eb/Φ=k[V−(Ia×Ra)]/Φ

Where k=constant, V=armature voltage, Eb=back emf, Φ=magnetic flux produced by field systems. Speed of DC motor can be controlled by 1) voltage control method, 2) armature resistance control method and 3) flux control method.

### Embodiment Describing Electromagnetic Field System in Radial DC Machines:

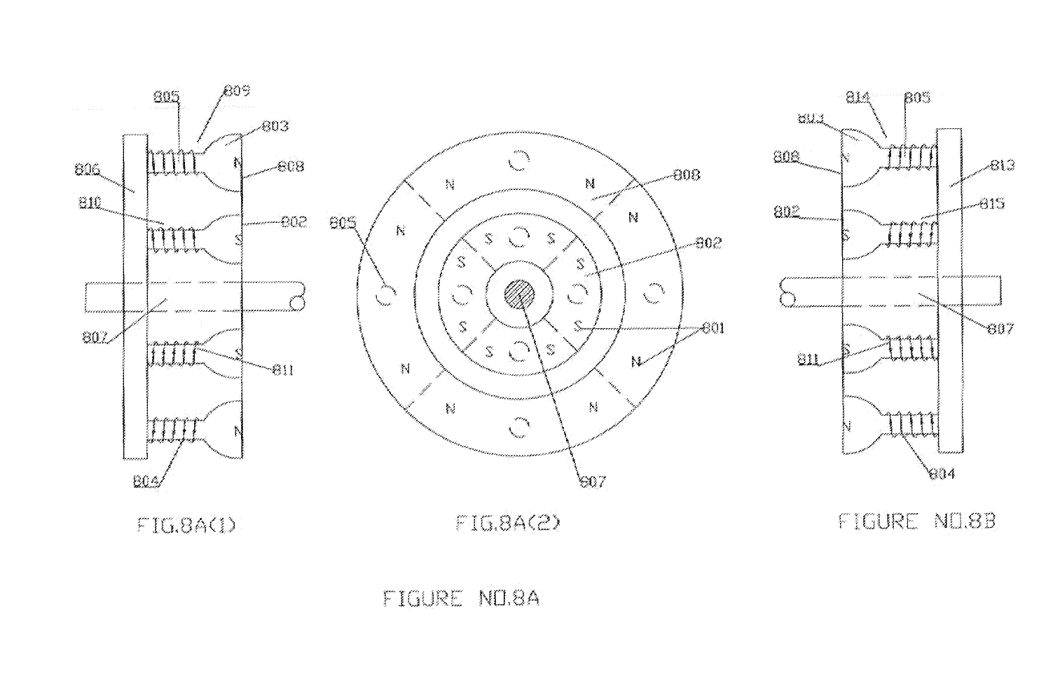

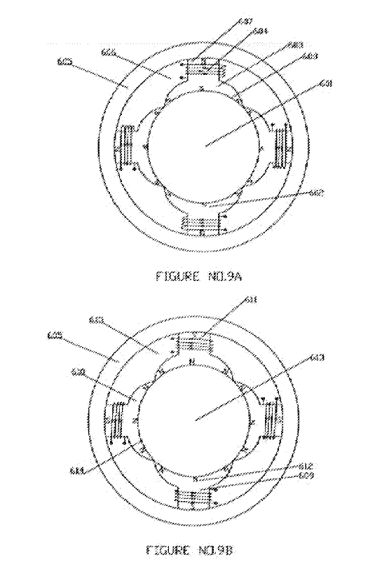

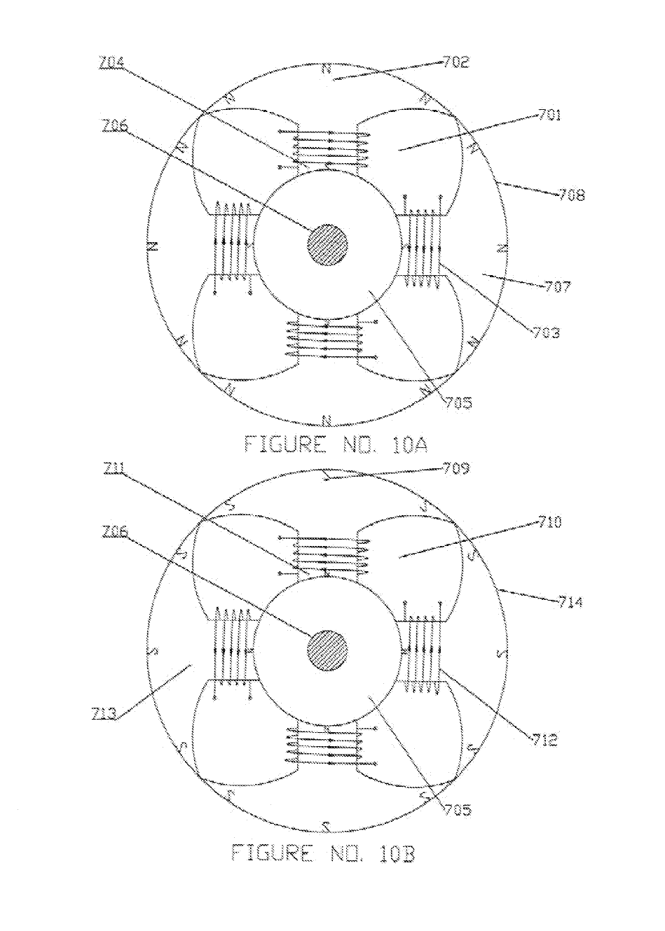

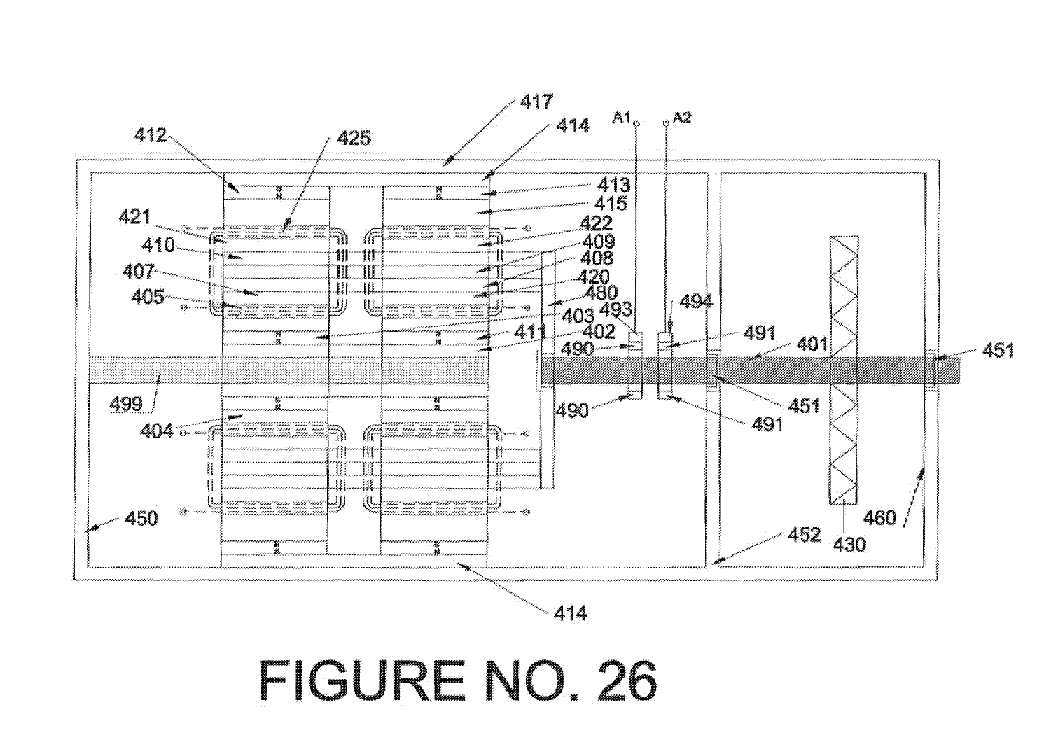

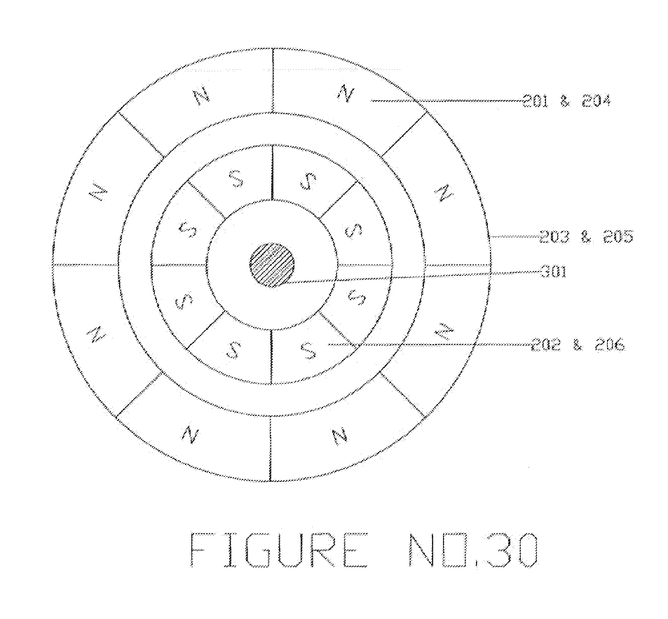

Another embodiment of the electromagnetic field systems for radial flux DC machine is explained using FIG. 9A, 9B, 10A, 10B, 25A and FIG. 29. The outer electromagnetic field system are depicted by FIGS. 9A and 9B while FIGS. 10A and 10B show detailed construction of inner electromagnetic field systems. FIG. 25A shows the outer and inner electromagnetic field system from one lateral side without armature for simplicity, while FIG. 29 shows the same with armature.

The outer electromagnetic field ‘system is the outer most part inside the body (417) of the radial flux DC machine. It consists of at least one yoke (605) which is cylindrical shaped and deployed toward the machine body. There are two set of electromagnets which are deployed on the inner periphery of the said yoke (605). Meanwhile, the inner electromagnetic field system which is the inner most part consists of at least one yoke (705). The said yoke is cylindrical shaped and mounted on shaft (706). There are two sets of electromagnets deployed on the outer periphery of the yoke (705). Its armature system construction is similar to radial flux machine described in earlier embodiments.

The yoke (605) which is made of laminated layers of magnetic substance is fixedly supported with the shaft (706) by supporting means (419), which is not shown in FIGS. 9A and 9B, but is similar to that described in earlier embodiments. One of the forms of the said supporting means (419) is a flat disc whose periphery is fixedly mounted with the yoke (605) while its center is fixedly mounted on shaft (706). There is air gap (416) between motor body (417) and the outer periphery of the said yoke (605).

FIG. 9A shows one set of electromagnets which consists of 4 multiple field magnets (606) as an illustrative example. Each field magnet (606) comprises of pole core (607) and pole shoe (603) which are made of multiple laminations of magnetic substance. These multiple laminations are stacked together or bolted together (not shown) to get required thickness of pole core and pole shoe. The field magnets (606) are fixedly mounted on the inner cylindrical periphery of yoke (605) through the pole core (607). Since the pole shoe (603) is larger than the pole core (607), the pole shoe serves two purposes, i.e. it spreads out magnetic flux in air gap, and reduces the reluctance of the magnetic path. The pole core also supports field coil (604). There are (601) which is inside cavity.

The axial length of each field magnet (606) is generally equal to that of the armature core (422) and aligns with it. The cross sectional area of pole face (608) of each field magnet (606) are arranged to touch each other in such a manner that the total combined shape and surface area of pole faces are cylindrical in shape. The field coils or pole coils (604) consist of turns of insulated conducting wire or strip. The turns are of a certain dimension and are formed by wounding it on a former. Once the coils are formed, the former is removed and the wound coil is put into place over the pole core (607). The direction of DC current sent though the field coil (604) of each field magnet, is shown by arrow on its turns and is such that, pole face (608) forms same pole as that formed on pole shoe (713) or pole face (714) in FIG. 10B. Thus the pole face (608) of each field magnet (606) forms south (S) pole o while end of pole core of each field magnet (606) towards yoke (605) forms north (N) pole. Said cylindrical south (S) pole (602) produces magnetic flux in radial direction. There is air gap (415) between south (S) pole faces (608) and outer periphery of armature core (422).

FIG. 9B shows a second set of field magnets (615) of the outer magnetic field system which is fixedly supported on the inner periphery of the yoke (605) to cover it at least partially in longitudinal direction from the first set of magnets (606). The construction is identical to that of the first set of magnets (606) except for the direction of the current in the field coils (611) which is in the opposite direction to that in the field coils (604). The current direction is shown by arrows on coil turns is such that the formed cylindrical magnet has its inner periphery acting as same pole as that on cylindrical outer periphery formed by pole shoes (707) of field magnets (shown in FIG. 10A).

Thus the inner periphery of the formed cylindrical magnet has north polarity while the portion of the pole core which touches the yoke (605) has south polarity. The axial length of field magnet (615) is generally equal to axial length of armature (421) and aligns with it. The other parts are marked as follows. They are pole shoe (610), pole core (609), north poles (612), inside cavity (613), and pole face (614).

As seen from above, the outer electromagnetic field system comprises of two sets of field magnets (606, 615), yoke (605) and means (419) for connecting the said outer field system to the shaft. The said two sets of field magnets are both arranged in cylindrical manner such that one set (606) produces cylindrical south (S) pole while the other set (615) produces cylindrical north (N) pole.

FIG. 10A depicts an arrangement of one set of field magnets for the inner electromagnetic field system. There is another yoke (705) which is fixedly attached with rotary shaft (706). The said yoke (705) has cylindrical shape and is made of laminated layers of magnetic substance. The said yoke carries a set of multiple field magnets (701) on its outer peripheral surface to cover it at least partially, wherein each said field magnet comprises of pole core (704), pole shoe (707), field coil (703) and pole surface (708), north pole (702).

The axial length of field magnet (701) is generally equal to that of the armature core (407) and aligns with it. The cross sectional area of the pole face (708) of each field magnet (701) are arranged to touch each other in such manner that the total combine shape and surface area of pole faces is cylindrical shaped. The multiple field magnets (701) are fixedly mounted on to yoke (705).

In an illustrative embodiment four field magnets are shown. The said field coils or pole coils (703) comprise of turns of insulated conducting wire or strip. The turns are of a certain dimension and are formed by winding it on a former. Once the coils are formed, then the former is removed and the wound coil is put into place over pole core (704). The direction of DC current sent though the field coil (703) is shown by arrow on its turns and is such that pole face (708) of pole shoe (707) forms north (N) pole and end portion of pole core (704) fixed to yoke (705) forms south (S) pole. There is air gap (404) between outer periphery of pole and inner periphery of armature cores (407) and (420).

FIG. 10B depicts second set of field magnets (710) for the inner magnetic field which is fixedly mounted on the yoke (705) to cover at least partially outer periphery of yoke, in longitudinal direction from the first sets of field magnets (701). The construction of these field magnets is same as those shown in FIG. 10 A, except the formed cylindrical pole has outer cylindrical periphery acting as south (S) pole because of the direction of the current in field coils (712) is as shown by arrow on turns of coil (712) in FIG. 10 B. The axial length of the field magnet (710) is generally equal to that of armature core (420) and aligns with it. The other parts are south pole (709), pole core (711), pole shoe (713) and pole face (714).

The set of field magnets forming outer cylindrical north (N) pole in FIG. 10A, and the outer cylindrical south (S) pole in FIG. 10B together with the yoke (705) forms the inner electromagnetic field system.

Embodiment Describing Radial Flux Machine with Two Shafts:

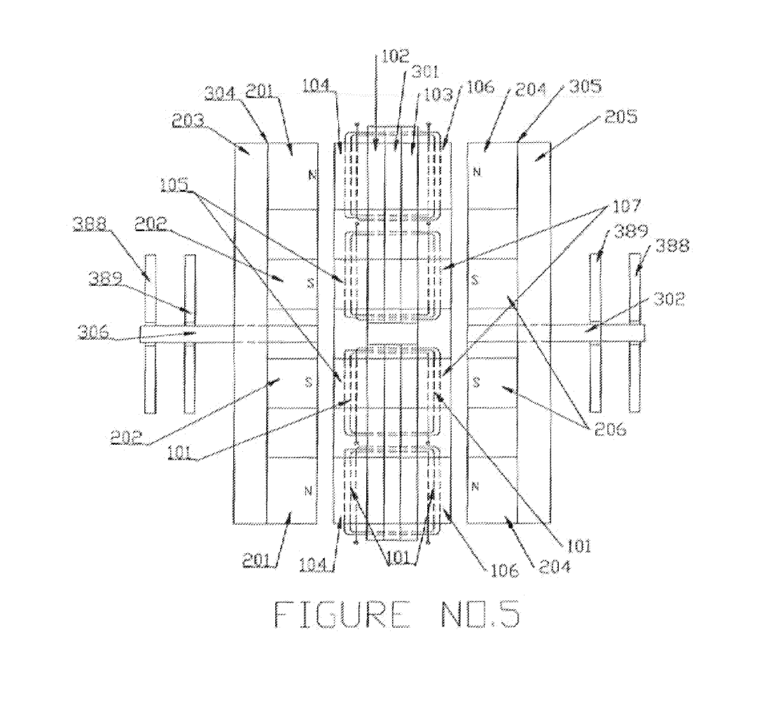

FIG. 6 shows the construction of two shaft radial flux DC machine (DC motor and DC generator), which is also known as two speed radial flux DC machine. The working principle for two shaft radial flux DC motor is identical to single shaft radial flux DC motor but differ in construction and operation. Said radial flux DC machine with two shafts comprises of two mechanically isolated shafts i.e. (426) and (401). One of the ways to have two shaft constructions is “shaft in shaft construction”. On one said shaft (426) outer magnetic field is fitted while on another said shaft (401) the inner magnetic field is fitted. Both shafts rotate in the same direction. Two said magnetic field systems i.e. the inner magnetic field system and the outer magnetic field system are such that the value of magnetic flux and flux densities produced by the inner and outer magnetic field system are kept different. Thus two mechanical powers are available at two shafts.

The speed N1 with which the outer magnetic field system will rotate and the speed at which mechanical output power is made available at shaft (426) is given by expression:

N1=k[V1−(Ia×Ra1)]/Φ1=k Eb1/Φ1

Similarly the speed N2 with which inner magnetic field system will rotate and the speed at which another mechanical output power is available at shaft (401) is given by the expression:

N2=k[V2−(Ia×Ra2)]/Φ2=k Eb2/Φ2

wherein
Φ1 is flux produced by outer magnetic field system,
Φ2 is flux produced by inner magnetic field system,
Eb1 is sum of back emfs induced in conductors in coil sides under outer magnetic field system,
Eb2 is sum of back emfs induced in conductors in coil sides under inner magnetic field system,
V1 is sum of voltage drops across conductors in coil sides under outer magnetic field system,
V2 is sum of voltage drops across conductors in coil sides under inner magnetic field system (where supply voltage to armature winding V=V1+V2),
Ra1 is sum of resistances of conductors in coil sides under outer magnetic field system,
Ra2 is sum of resistances of conductors in coil sides under inner magnetic field system and Ia is armature current

The speeds N1 and N2 at the two shafts can be controlled by the controlling magnetic flux values Φ1 and Φ2 respectively. In this way DC motor of the present invention can work as two speed (two different speed ranges) DC motor and can drive two different mechanical loads at two shafts. Armature current Ia and power input to armature system is proportional to the sum of mechanical power outputs at two shafts. Armature current Ia is computed by expression

Ia=[V−(Eb1+Eb2)]/(Ra1+Ra2)

As shown in FIG. 6 said two shaft radial DC machine when operates as two shaft radial DC generator has same working principle as that of single shaft generator but differs in construction and operation. In case of two shaft radial DC generator, rotary mechanical energy input from one prime mover is supplied to shaft (401) and thereby to inner magnetic field system for rotation while the rotary mechanical energy input from another prime mover is supplied to shaft (426) and thereby to outer magnetic field system for rotation, but direction of rotation of both the shafts must be the same. The DC power output of generator is proportional to the sum of input mechanical powers from two prime movers. The DC output voltage is kept constant by adjusting speeds of the two prime movers and magnetic flux produced by inner and outer field systems.

### Embodiment Describing Radial Flux Machine Having Single Magnet in Inner and Outer Magnetic Field System:

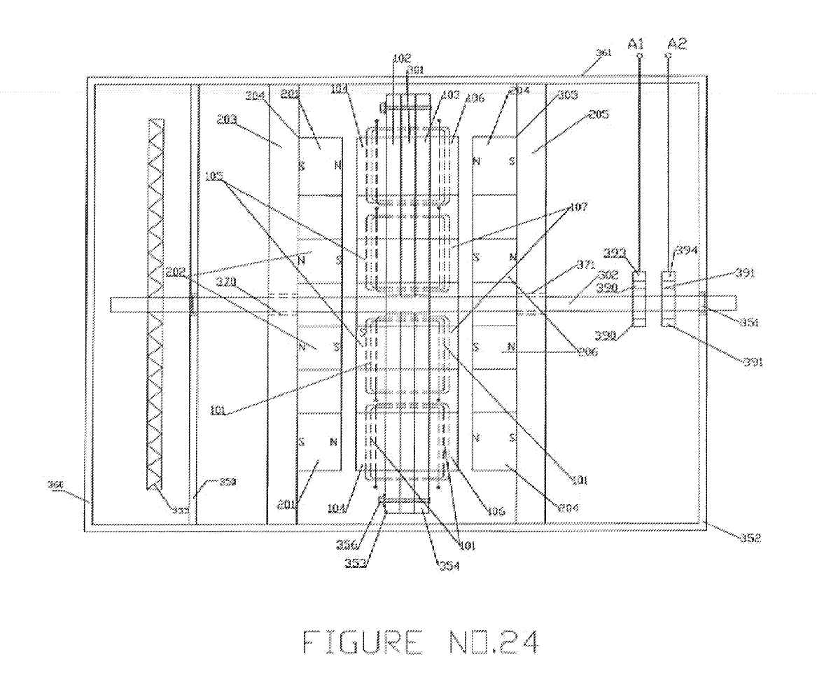

FIG. 21 shows, the assembly construction of inner and outer magnetic field systems which are identical as explained in embodiment 1 with the help of FIGS. 4, 6, 14, except that a single cylindrical pipe shaped magnet is used each for outer and inner magnetic field systems. So instead of deploying two magnets, only one magnet is deployed while in place of another permanent magnet, the cylindrical pipe shaped yoke made of laminated layers of magnetic substance is deployed.

In illustrative embodiment a cylindrical pipe shaped yoke (465) is fixedly mounted on the outer cylindrical surface of yoke (402) in longitudinal direction from magnet (403) to cover at least partially outer periphery of yoke (402). The outer diameter of yoke (465) is generally equal to that of magnet (403). The axial length of yoke (465) is generally equal to the axial length of armature core (420) and aligns with it. There is adequate air gap (404) between the outer cylindrical surface of yoke (465) and the periphery of armature core (420). The said permanent magnet (403) is polarized in predetermined orientation, in which magnet (403) has its outer cylindrical shaped surface magnetized in one polarity, while its inner cylindrical shaped surface which has contact with yoke (402) is magnetized in other polarity, which is opposite to one polarity. The rotary shaft (401), yoke (402), permanent magnet (403) and yoke (465) form inner magnetic field system.

In an outer magnetic field, cylindrical pipe shaped yoke (466) made from laminated magnetic substance is fixedly attached to inner periphery of yoke (414) and is spaced in longitudinal direction from the magnet (412). The inner diameter of yoke (466) is generally equal to that of magnet (412). The axial length of yoke (466) is generally equal to axial length of armature core (422) and aligns with it.

The permanent magnet (412) is magnetized in such a fashion that its peripheral portion facing armature core (421) have north (N) polarity while another peripheral portion which is in touch with the inner periphery of yoke (414) has south (S) polarity. Rotary shaft (401), means (419), yoke (414), permanent magnet (412) and yoke (466) form outer magnetic field system.

With the polarity of magnets (403, 412, 411, 413) as depicted in FIG. 4, either pair of magnets (403, 412) is replaced by yokes (465, 466) or pair of magnets (411, 413) is replaced by yokes (465, 466).

Embodiment Describing Radial Flux Machine with Single Set of Electromagnets:

FIGS. 25A, 25B depicts two opposing views from two side end caps of the radial flux machine with single set of electromagnets.—Its overall construction is similar to the radial flux DC machine with electromagnetic field system, except one set of electromagnets is replaced by yoke in each outer and inner magnetic field system. For simplicity armature system is not shown. In illustrative embodiment, sets of electromagnets (606, 710) are replaced by yoke (901, 902) respectively as depicted in 25B.

One of the two sets of electromagnets (606, 615) of outer field system earlier shown in FIG. 9A and FIG. 9B respectively is now replaced by yoke (901). The yoke (901) is fixedly attached on the inner periphery of yoke (605). The said yoke (901) is cylindrical pipe shaped which is made of laminated layers of magnetic substance. The inner diameter of the yoke (901) is generally equal to the diameter of the cylindrical cavity (601) in FIG. 9A or cylindrical cavity (613) in FIG. 9B. The axial length of the yoke (901) is generally equal to axial length of field magnets (606) or (615).

Similarly for the inner magnetic field system, out of two sets of electromagnets (701, 710) as depicted in FIGS. 10A and 10B respectively, one set of electromagnets is replaced by yoke (902). The yoke (902) which is cylindrical pipe shaped is made of laminated layers of magnetic substance, is fitted on outer periphery of yoke (705). The outer diameter of yoke (902) is generally equal to outer diameter of cylindrical magnetic pole formed, in FIG. 10A or FIG. 10B. Axial length of the yoke (902) is generally equal to axial length of field magnet (701 or 710).

The replaced set of electromagnets (606, 710) is that which produces the same polarity on its outer periphery as that which is produced by the set of electromagnets on their inner periphery of the outer electromagnet field system. It further means that either sets of electromagnets (606,710) or (615,701) are replaced by yokes (901,902) respectively.

Embodiments for Describing Radial Flux Machine with Rotating Armature System and Stationary Magnetic Field System:

FIG. 26 shows alternative type of radial flux DC machine (motor/generator) with rotating armature system and stationary magnetic field system. Rotary shaft (401) which is rotatably supported by supporting means (451) on end cap (452) and generally disc shaped part (460) having means (451). End cap (452) and support (460) are fixedly supported to motor frame (417). Motor frame is generally cylindrical to enclose the substantial portions of motor, and fixed on the base thereof, not shown.

The armature system has construction identical to that described under embodiment 1, except for the following changes. Yokes (408, 410) and core (409) are not fixed with motor body but are fixedly attached with means (480). Means (480) is generally shaped as a flat disc and its center is fixedly attached with shaft (401). Thus armature cores (407, 420, 421, 422) having armature windings on them and which are fitted on yokes (408, 410) and the non-magnetic core (409) are free to rotate with shaft (401) by the connecting means (480). The said connecting means (480) connects the shaft with the armature system.

The outer and inner magnetic field systems have identical construction as mentioned under embodiment 1, except that the—yoke (414) is fixedly attached with motor body (417). Alternatively the said yoke (414) may be absent and the permanent magnets (412) and (413) may be fixed with inner periphery of motor body (417) which is made of laminated layers of magnetic substance. Further the yoke (402) is fixed to the vertical surface of end cap (450) directly or through solid cylindrical part (499). End cap (450) is fixed with motor body (417) or it could be integral part of machine body (417). Slip rings (490,491) are fixed on shaft (401) and are free to rotate with shaft (401). Connections to armature winding terminals (described in earlier embodiment but not shown in FIG. 26) on rotating armature system are taken out through slip rings (490 and 491) which in turn are electrically insulated from shaft (401)) and brushes (493, 494). Brushes (493, 494) are connected by wires to terminals (A1, A2) and are fixed to machine body through electrical insulation (not shown). This arrangement is for supplying DC power in case of DC motor, or getting DC voltage output in case of DC generator, between terminals, marked as A1 and A2. The terminals A1 and A2 are made available in terminal box (not shown) on motor body (417). Fan (430) circulates air for ventilation and is fixedly mounted on shaft (401).

Embodiment for Illustrating Radial Flux Machine with Single Cylindrical Shaped Magnet Formed by Multiple Permanent Magnets:

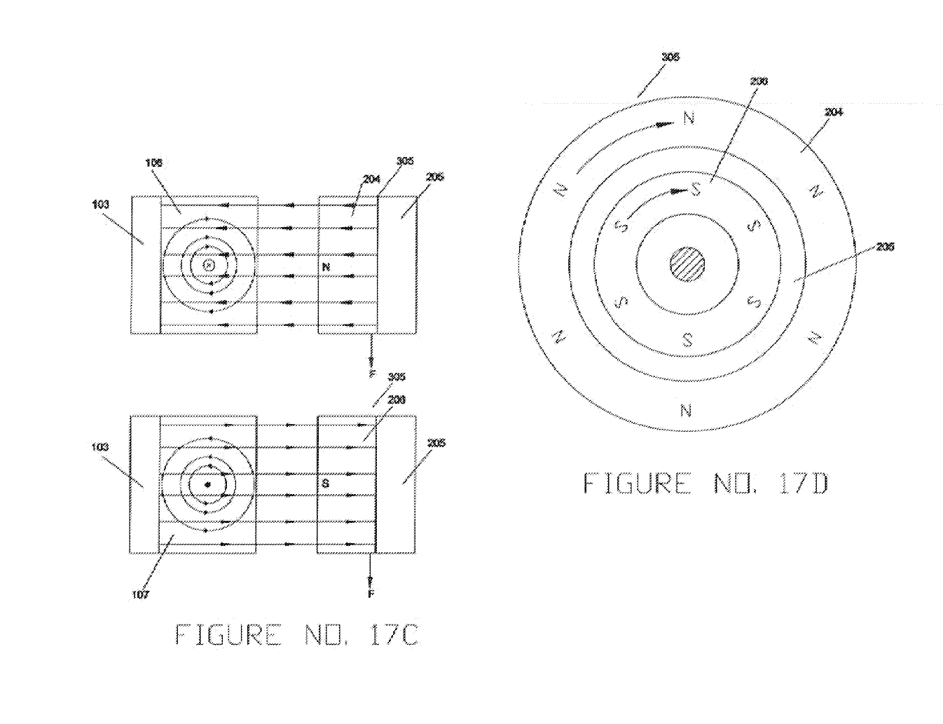

FIGS. 16A and B show another type of arrangement for the cylindrical pipe shaped magnets which are used in earlier embodiments for radial type flux machine.

Because of non-availability or higher price of cylindrical pipe shaped magnets, such magnet can be replaced by multiple permanent magnets forming shape of cylindrical pipe. In FIG. 16A, there are multiple permanent magnets which are fixedly mounted on inner periphery of the yoke (414). There is small gap (488) between the two adjacent magnets. The magnets are polarized in such way that their inner arc shaped face acts as north (N) pole while their outer arcs which are in touch with surface of the yoke (414) act as south poles of magnets. The axial lengths of magnets are generally equal to that of armature core (421) and align with it. Cylindrical pipe shaped magnet (412) is formed by above arrangement having its inner periphery acting as north pole. For simplicity armature system is not shown.

There are multiple permanent magnets which are fixedly mounted on outer periphery of the said yoke (402). There is small gap between adjacent magnets. The said magnets are polarized in such way that their outer arc shaped faces act as north (N) pole while their inner arcs which are in touch with yoke (402) act as south (S) pole. The axial length of said magnets is equal to axial length of armature core (407) and aligns with it. Cylindrical pipe shaped magnet (403) is formed by above arrangement having its outer periphery acting as north pole.

Similarly FIG. 16B shows cylindrical pipe shaped magnets (413) and (411) formed by above said arrangements. The said magnet (413) has its inner periphery acting as south pole while magnet (411) has its outer periphery acting as south pole.

### Embodiment Describing Brushless Electromagnetic Field System for Rotating Field Type Radial Flux/Axial Flux DC Generator/DC Motor:

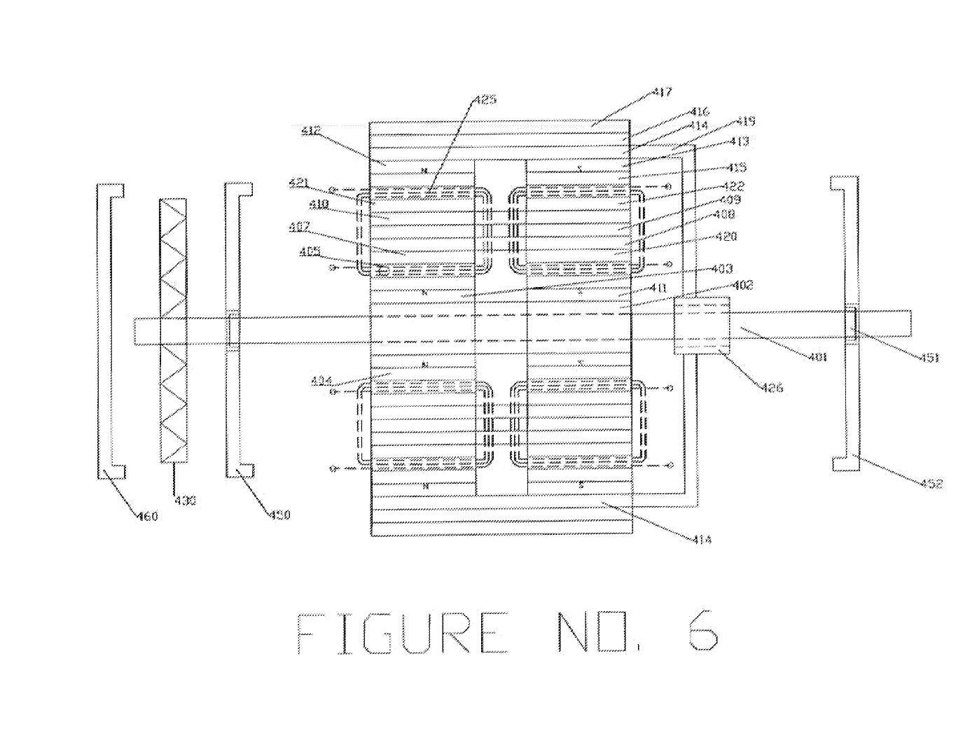

FIG. 7 details the brushless electromagnetic field system for rotating field type radial flux/axial flux DC generator/DC motor. This embodiment is essentially directed towards for providing DC supply, arrangement and method of producing rotating field in case of radial/axial type DC machine with electromagnetic field system.

For DC machine with rotating electromagnetic field, DC supply to field winding can be provided by following two ways.
a. Slip ring and brush arrangement-field windings on both outer and inner electromagnetic field systems for radial flux machine and also field windings on both electromagnetic field systems (304) and (305) (described elsewhere) for axial flux machine, are connected to DC supply through slip rings and brushes arrangement which is similar to that shown for supplying power to rotating armature in FIG. 26. The two terminals of field windings are connected to insulated said slip rings which are rotating with shaft and brushes which are stationary and are in contact with said slip rings). Wires connected to two brushes are connected to DC supply in case of DC motor. In case of DC generator (under invention), wires connected to two brushes are connected to armature winding terminals from stationary armature of said DC generator to get induced DC supply.
   This is conventional method used for three phase ac generators and synchronous motors to supply DC power to their rotating electromagnetic field windings.
b. Brushless electromagnetic field system for rotating field type radial flux/axial flux DC machine (DC motor/DC generator) under invention is illustrated. FIG. 7 shows the details. Machine/machine parts are shown by blocks to avoid repetition of figures.
   Block (501) represents the stationary armature system of radial flux type or axial flux type DC machine under invention while block (502) represents electromagnetic field system of respective radial flux or axial flux DC machine. There are also two more blocks (503) and (504) which together form another DC machine whose main function is to excite the DC machine under invention.
   The electromagnetic field system block (502) is fixedly mounted on rotary shaft (505) and is free to rotate with rotary shaft (505). Stationary armature winding terminals are marked as (507) and (508). Terminals (507) and (508) are connected to DC supply in case of DC motor of radial flux/axial flux type. In case of radial flux/axial flux DC generator, DC voltage is induced in armature winding and is available as output between the terminals (507) and (508). Terminals of rotating field winding are marked as f1 and f2 and are shown on block (502).
   Exciter represented by blocks (503) and (504) together) is generally a machine smaller than the DC machine represented by blocks (501) and (502) together. The exciter consists of stationary field system (503) with field terminals (509) and (510). Terminals (509) and (510) of the field system (503) are connected to terminals (507) and (508) of the armature (501) of the DC generator under invention to get DC supply. However, in case of DC motor in the present invention which are represented by (501) and (502) the said terminals (507 and 508) may be connected to separate DC supply.
   Exciter, which produces DC voltage may be a conventional DC generator whose armature (504) is fixedly mounted on same shaft (505) as that of DC generator. DC voltage is available at the armature terminals marked + and − of armature (504) of conventional generator and it is fed to terminals f1 and f2 of field winding under field system (502) for production of magnetic flux.
   Alternatively Exciter may be small three phase alternator in which block (503) represents its stationary field system. Said exciter draws power for its field system (503) from DC supply or from armature system (501) of DC generator. It consists of rotor having three phase winding. The three phase ac voltage generated in rotor winding is rectified by three phase rectifier. Block (504) represents rotor with three phase winding and three phase full wave rectifier together. The rotor (504) is fixedly mounted on rotary shaft (505). The rectified DC voltage is available at + and −terminals of said block (504). This DC voltage is supplied to terminals f1 and f2 of field system (502) of axial flux/radial flux DC generator/DC motor.
   Alternatively exciter may be DC generator under invention with rotating armature system (504) and stationary field system (503). Stationary field system may be of two types, one with permanent magnets and another with electromagnets. Electromagnetic field system is represented by block (503) while rotating armature system is represented by block (504). The armature system of the exciter is fitted on same rotary shaft (505) as that of said electromagnetic field system (502) of the DC machine under invention represented by blocks (501) and (502). DC voltage which is available at the armature terminals marked + and − of armature (504) of exciter is fed to terminals f1 and f2 of field winding under field system (502) of DC machine (generator/motor) under invention for production of magnetic flux.
      Embodiment for Radial Flux Machine with Armature System Having Only Single Yoke:

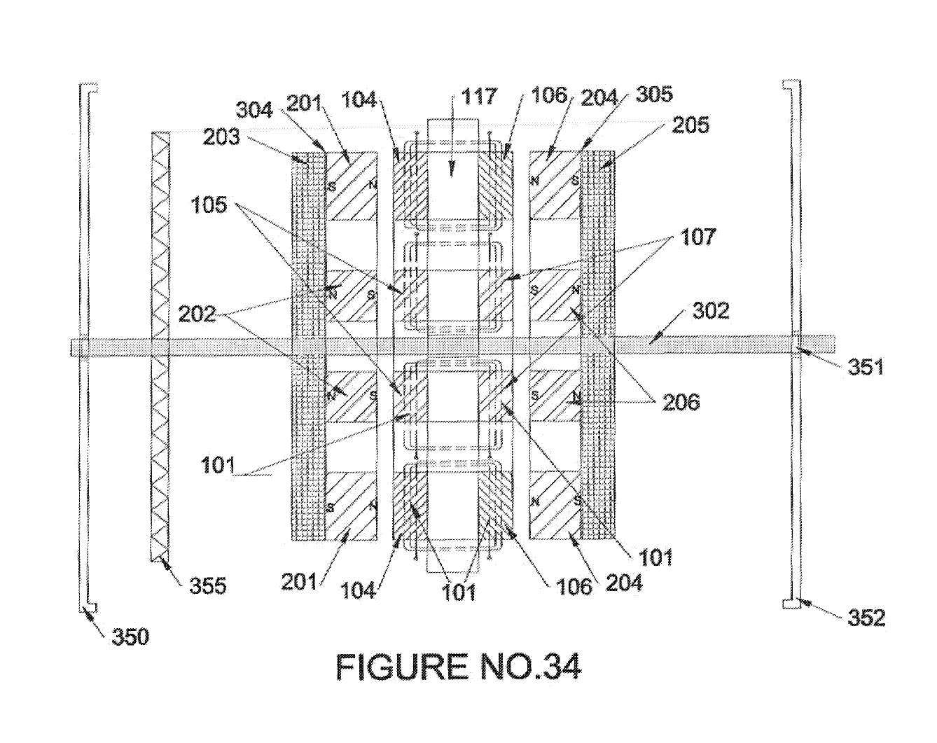

FIG. 33 sets forth yet another way of construction of said armature used in said radial DC machine in which armature system, instead of having stationary member which has pair of yokes (408, 410) and nonmagnetic core (409), has member which has only single yoke (444). For the operation of DC machine as DC motor or DC generator non-magnetic core (409) is not essential (except for two shafts operation).

For the second type of armature system wherein stationary member for transporting magnetic flux is single yoke, the core (409) is absent and said yokes (408 and 410) are combined into single cylindrical pipe shaped yoke (444) made of laminated magnetic substance as shown in said FIG. 33. The said armature cores (421, 422) are fixed on the outer cylindrical periphery of the yoke (444), while the said armature cores (407, 420) are fitted on the inner cylindrical periphery of the yoke (444). For stationary armature system construction, the length of yoke (444) is extended (not shown) to mount it on end cap (450) with flat ring shaped surface of the yoke (444) touching flat surface of the end cap (450). In extended portion of the length of yoke (444) radial through holes are provided for passing armature conductors joining two said coil sides.

For rotating armature system where member is single yoke, the core (409) is absent and yokes (408, 410) are combined into single cylindrical pipe shaped yoke (444) made of laminated magnetic substance as shown in said FIG. 33. The said armature cores (421, 422) are fixed on the outer cylindrical periphery of the yoke (444) (surface 2 of the member), while the said armature cores (407, 420) are fitted on the inner cylindrical periphery of the yoke (444) (surface 1 of member). For rotating armature construction, the length of the yoke (444) is extended (not shown) to mount it on flat disc (480) with flat ring shaped surface of the yoke (444) touching the flat peripheral portion of the disc (480) in place of the core and the yokes (409, 408, 410) as shown in FIG. 26. In extended portion of length of the yoke (444) radial through holes are provided for passing armature conductors joining two said coil sides. Remaining construction of armature system is similar to that mentioned under embodiment 1.

### Modification of Radial Flux DC Machine

The present invention also discloses radial flux brushless DC machine which can be modified into linear brushless DC machine. This will be explained in three separate embodiments i.e. two embodiments of DC motor and one embodiment of DC generator. Linear brushless DC machine is another machine whose structure is almost identical to radial DC machine disclosed in present invention if the said radial flux DC machine is unrolled or cut radially at one place from periphery to centre, and straightened, such that it becomes linear brushless machine

### Linear Brushless DC Motor

Instead of providing rotational torque, linear motor offers motion in linear direction. It is useful in automation for movement of machine parts, table movement etc. In heavy duty industrial use, linear motion is achieved by use of hydraulic/pneumatic actuators. Sometimes three phase linear induction motor is also used. The DC brushless linear motor can offer advantages of good speed control and ease in reversal of direction.

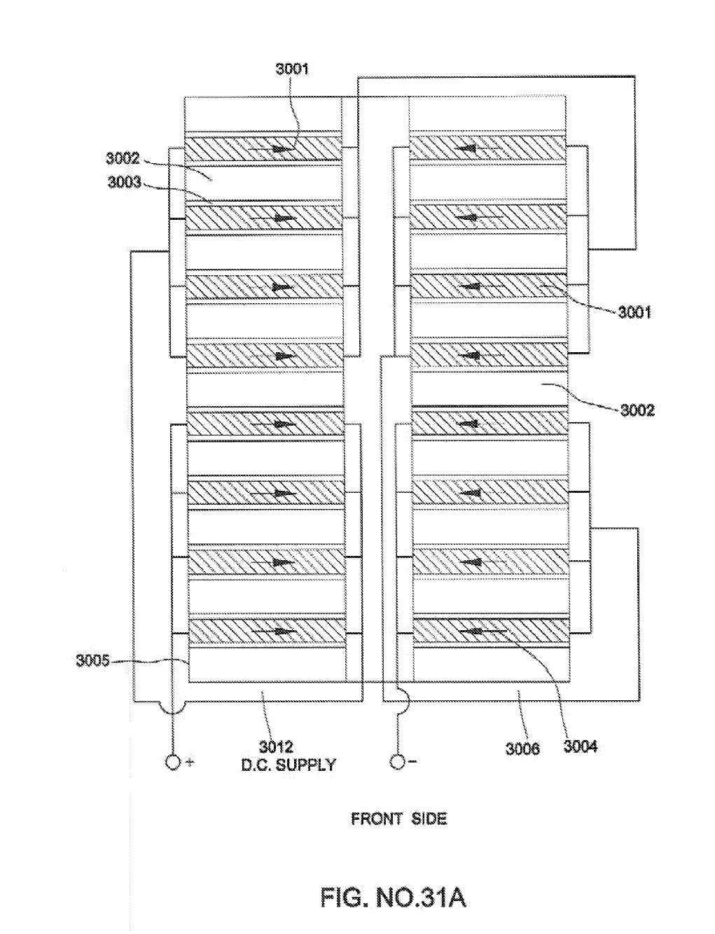

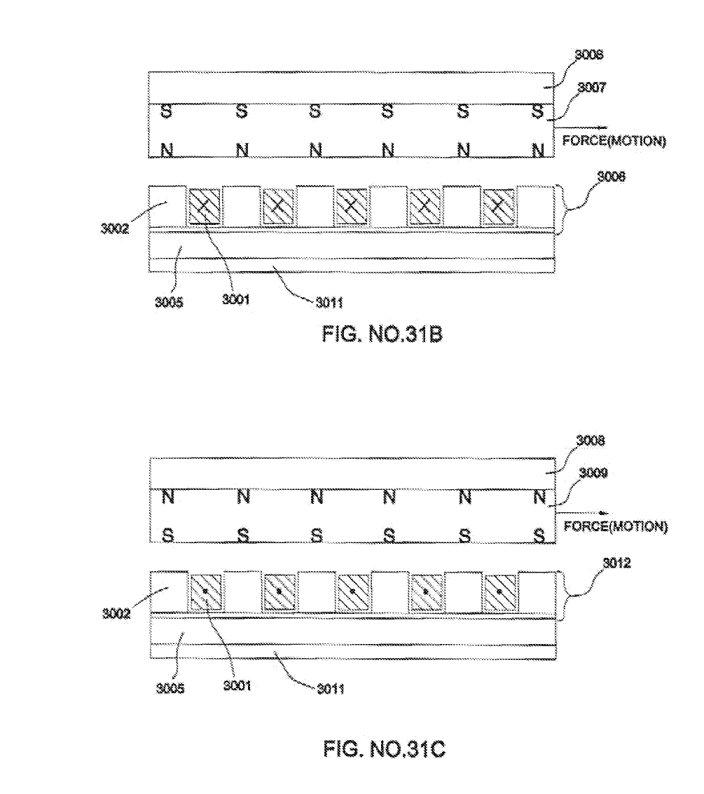

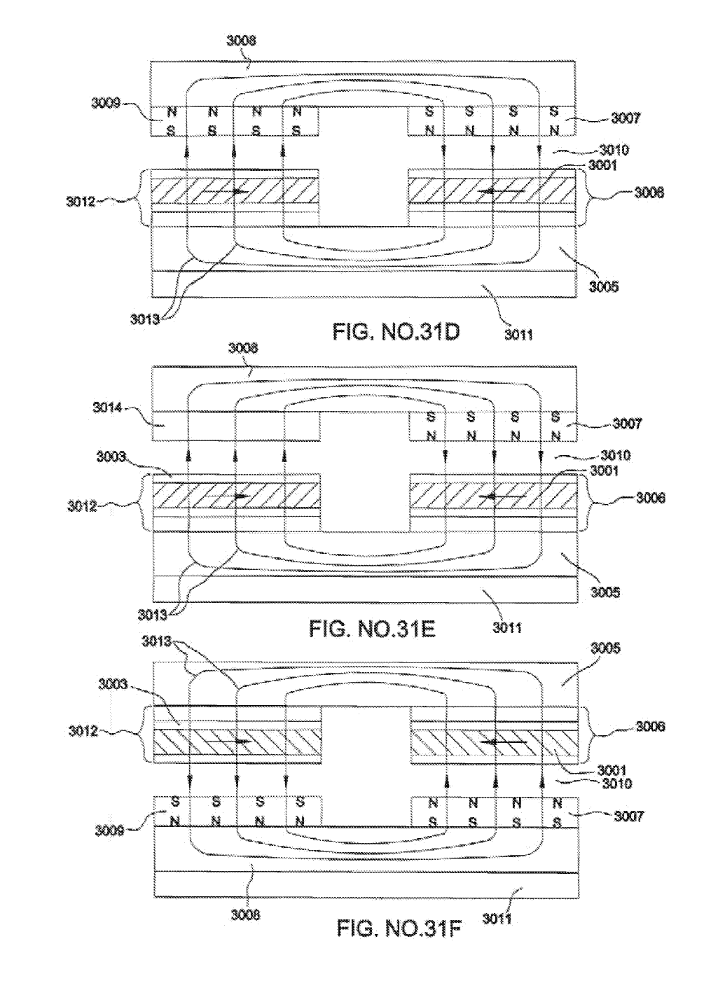

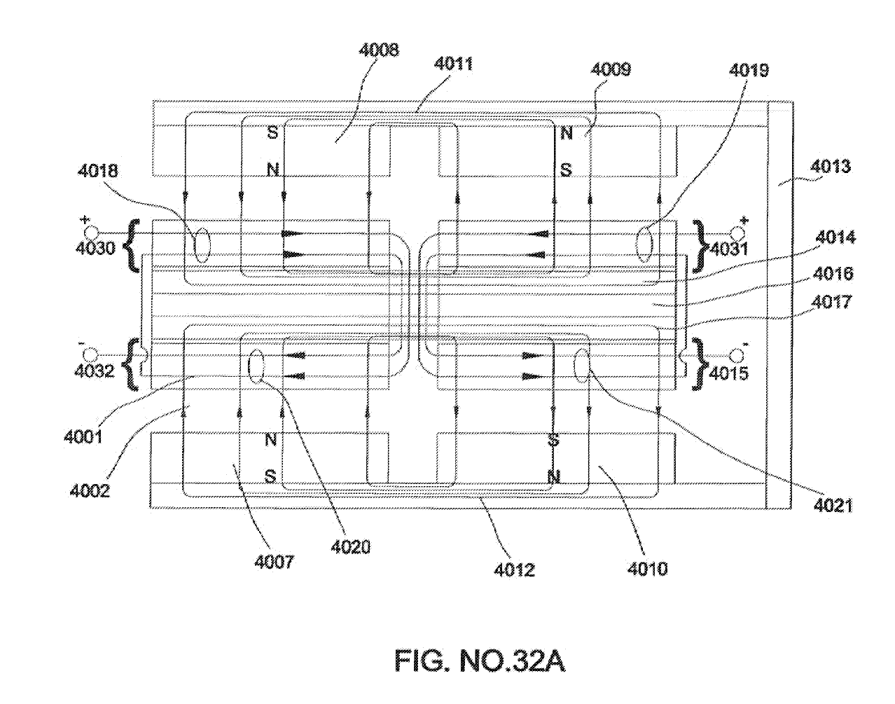

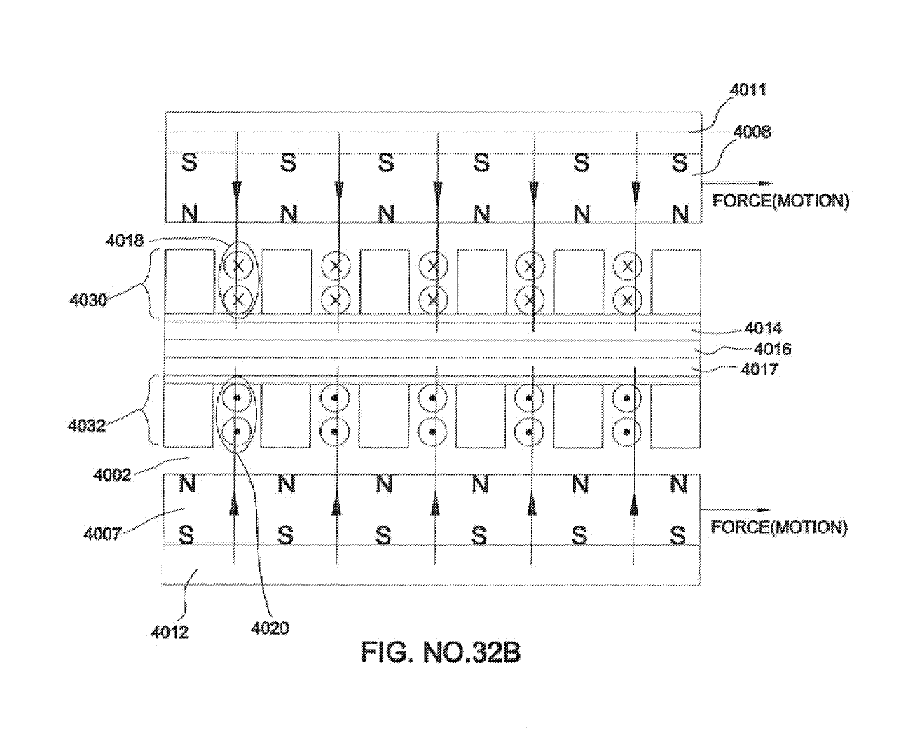

FIGS. 31A, 31B, 31C, 31D, 31E and 31F show DC linear brushless motor including single magnetic field system with two magnets and armature with insulated conducting bars.

DC Linear brushless motor in this embodiment comprises of two yokes (3005, 3008). These yokes are made of laminated magnetic substance. There are two armature cores (3006, 3012) placed apart with a gap in between, which are deployed on yoke (3005) forming armature system. The magnetic flux producing system comprises of single magnetic field system including the yoke (3008) which has two magnets deployed on it in such a manner that magnets (3007) and (3009) are facing the armature cores (3006) and (3012) respectively.

The yoke (3005) which is a rectangular flat plate is fixedly attached with body (3011) of motor. The armature cores (3006, 3012) have flat rectangular plate shape. The said armature cores (3006) and (3012) are made of laminated magnetic substance and have multiple slots (3003) in it for housing armature conductors (3001). Slots on the armature core (3006) and (3012) are aligned axially with each other. The armature conductors are generally in the form of bars having rectangular or round shape and are made up of insulated conducting substance like copper or aluminum. Usually one bar is placed in a slot and the length of conductor (3001) generally matches the length of the slot (3003) of the armature cores (3006, 3012). A group of conductors are connected in parallel by wires. Such multiple groups from armature core (3006, 3012) are connected in series as shown in FIG. 31A, to increase voltage rating of motor. This is one of the ways of connecting multiple conductors with each other and to DC supply.

The direction of current sent through conductors (3001) is shown by arrows (3004) on them. The direction of currents in all conductors (3001) on both armature cores (3006, 3012) should be either flowing towards center line between two said armature cores or flowing away from same center line. In the illustrative embodiment, the direction of currents sent in all conductors on the armature cores (3006 and 3012) are towards center line between the said two armature cores as shown by arrows (3004) on them.

With reference to FIGS. 31B, 31C and 31D, the magnets (3007, 3009) are fixedly attached to yoke (3008) on one of the surface of yoke (3008), with a gap between two magnets. FIG. 31B is the view from the right hand side of FIG. 31D. The yoke (3008) is made of laminated magnetic substance and has rectangular flat plate shape. Magnets (3007, 3009) have rectangular flat plate shape and are either permanent magnets or electromagnets. In case of permanent magnets, (3007, 3009), each said magnet is single piece or is made up of multiple magnets with same polarity and placed side by side on the yoke (3008), above the same armature core.

The said magnets and the yoke have the same width which may be larger, smaller or equal to the width of the armature cores. It is to be noted that the width of the said permanent magnets is the linear dimension in the direction of motion.

The magnets (3007, 3009), armature cores (3006, 3012) and the conductors in the said armature cores are aligned lengthwise respectively to each other. The north (N) pole of magnet (3007) faces the armature core (3006) and its south (S) pole is in touch with yoke (3008), while the south pole (S) of magnet (3009) faces armature core (3012) and its north (N) pole is in touch with the yoke (3008).

In the illustrative embodiment the system comprising of magnets (3007, 3009) and yoke (3008) is free to move above armature cores (3006, 3012) in horizontal direction, along the width of the said armature cores keeping constant length of air gap (3010) between magnets and armature cores. In FIG. 31A, the said motion is perpendicular to the direction of current flowing is the conductors (3001). In FIG. 31B, the current in conductors (3001) on armature core (3006) is such that it is going away from observer and is shown by cross (X) on conductors.

FIG. 31D shows the close loop flux transport means which is the magnetic path for lines of magnetic flux (3013) produced by magnets (3007), (3009) together, while direction of flux lines is shown by arrows on them. Said flux lines pass through the said magnetic path which includes conductors (3001) on armatures cores (3006) and (3012), armatures cores (3006) and (3012), yokes (3005, 3008) air gap (3010) and magnets (3007, 3009). Interaction between flux produced by the current in the conductors on the armature core (3006) and flux produced by the magnets (3007) and (3009), results into development of force on magnet (3007) and hence on yoke (3008), so as to move magnet (3007) and yoke (3008) in direction shown in FIG. 31B. FIG. 31C is the right hand side view of FIG. 31D, taken from vertical plane at the center line between two armature cores (3006, 3012). The current in conductors (3001) on armature core (3012) is such that it is coming towards observer and is shown by dot (.) on the conductors. The interaction between flux produced by the current in the conductors on the armature core (3012) and flux (3013) produced by the magnets (3007 and 3009), results into development of force on the magnet (3009) and hence on yoke (3008). Thus the said magnet (3009) and the yoke (3008) move in the direction as shown in FIG. 31C.

These two forces are in same direction w.r.t. stationary armature cores. Hence they act additively on the system which comprises of magnets (3007, 3009) and yoke (3008) and thereby resulting in the motion of the said (magnetic) system in direction from bottom to top of paper for as depicted in FIG. 31A and of in direction going away from observer (in direction going into paper) w.r.t. as depicted in FIG. 31D.

FIG. 31E shows another example of above embodiment, in which one of the magnets chosen from the two magnets (3007, 3009) for e.g. (3009), is replaced by yoke (3014) having same dimensions as that of the replaced magnet. The said yoke (3014) is fitted to the other yoke (3008), in the same manner in which the replaced magnet was initially fitted on the yoke (3008). The yoke (3014) is made up of laminated magnetic substance. In this case less torque will be produced as compared to FIG. 31D.

In case of DC motors, the direction of motion of the system comprising of magnets (3007, 3009) and yoke (3008) can be reversed by reversing the direction of currents sent through the conductors (3001) on the armature cores (3006, 3012) simultaneously. Alternatively, it can be achieved by reversing the direction of currents through field coils in case of electromagnetic field. The speed of DC motor can be controlled by controlling the movement of the system of magnets and yoke by varying the magnitude of DC voltage applied to armature winding or by varying resistance connected in series with armature winding or by varying current in field winding in case of the electromagnetic field system.

FIG. 31F shows another example of the above embodiment. In this example magnetic system having magnets (3007, 3009) with yoke (3008) is fixedly attached with motor body (3011). The armature cores (3006, 3012), having conductors (3001) on them, are fixedly attached with yoke (3005). The remaining construction is same as that described in FIG. 31A through FIG. 31D. The armature system having said armature cores (3006, 3012) along with the said yoke (3005) are free to move above magnets (3007, 3009) and the yoke (3008) by means (not shown) in horizontal direction, along the width of magnets keeping constant length of air gap between magnets and armature cores. This time the forces produced by the magnets (3007, 3009) causes the motion of system comprises of said armature cores having current carrying conductors (3001) and the yoke (3005) in the direction away from the observer as depicted in FIG. 31F given by Fleming's left hand rule.

### DC Brushless Linear Machine

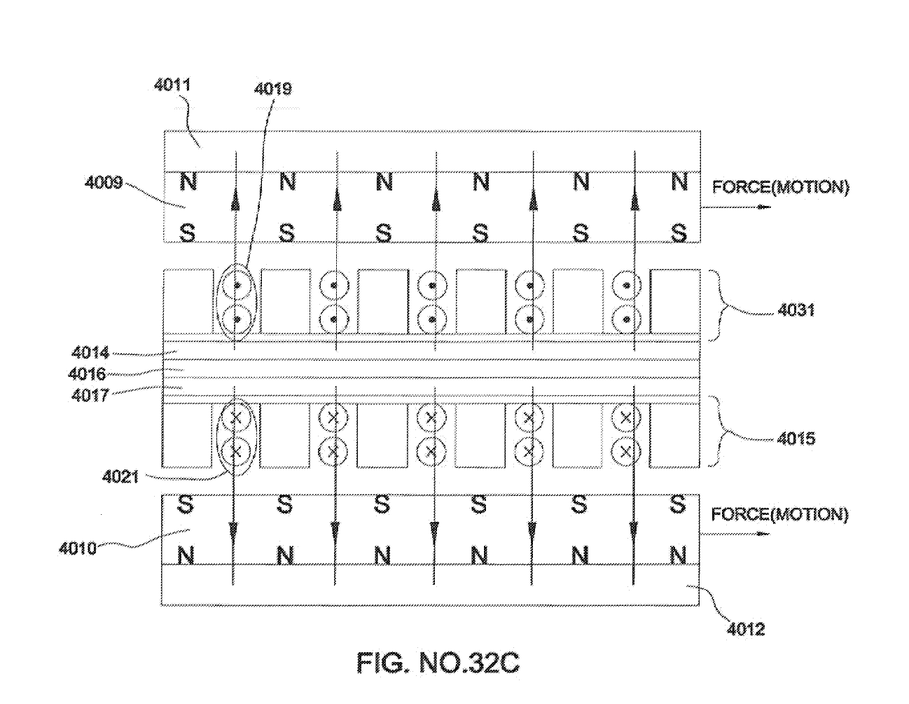

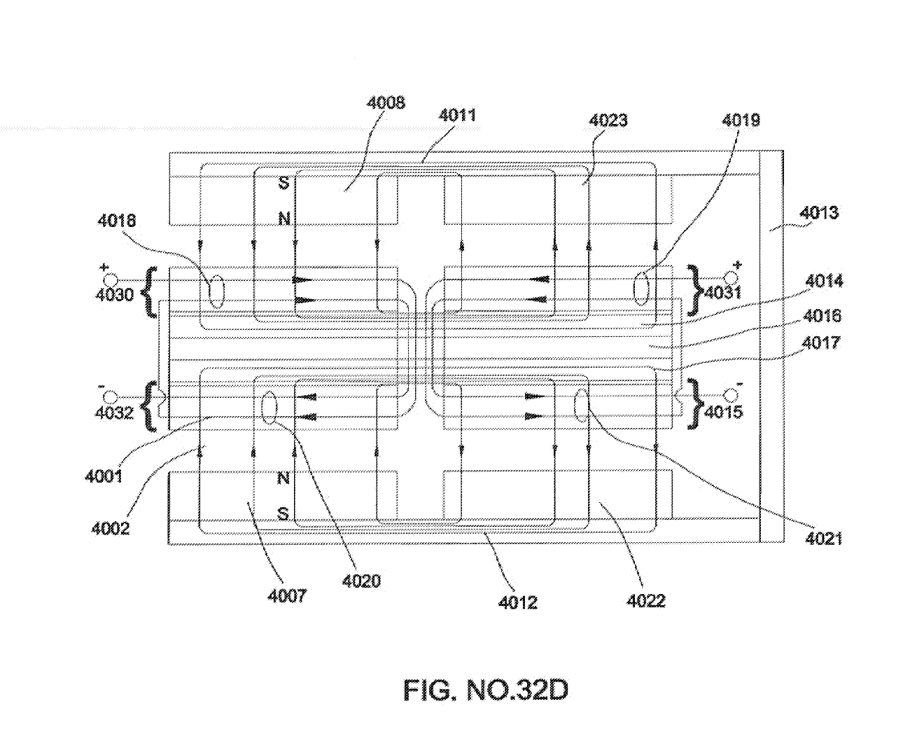

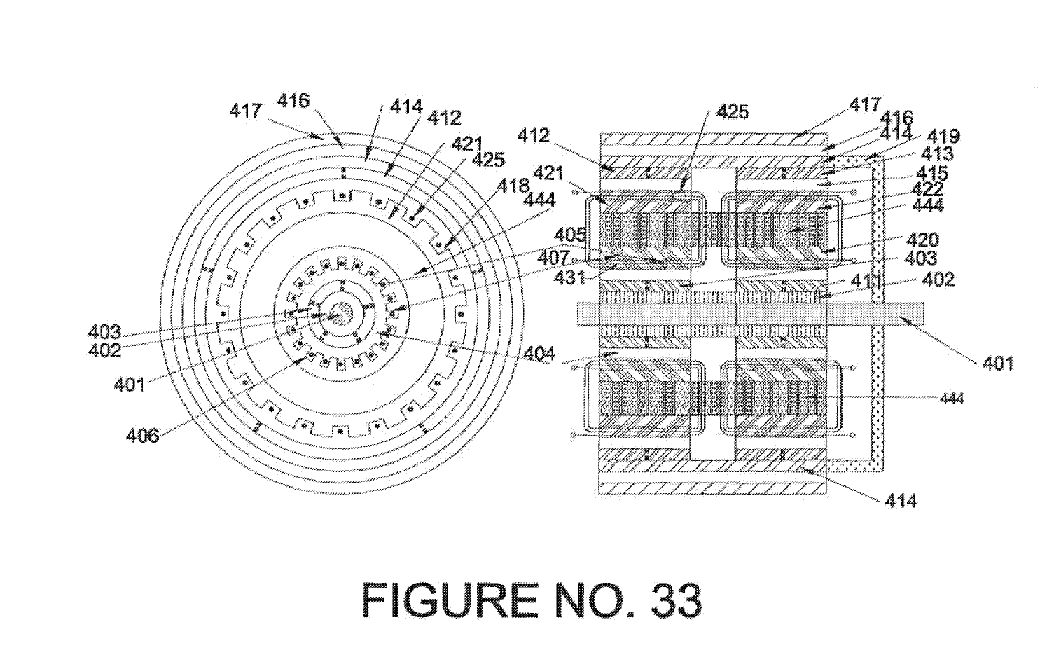

FIGS. 32A to 32D depicts another embodiment namely the DC brushless linear machine in which there are two magnetic field systems each with two magnets and armature having coils in place of conductor bars. Assembly of the DC linear brushless machine is explained with help of FIG. 32A while working of the said linear DC machine as linear motor and linear generator is explained with the help of FIGS. 32B and 32C.

This embodiment comprises of 4 yokes (4011, 4012, 4014, 4017) made of laminated magnetic substance and non-magnetic substance plate (4016). The armature system comprising of armature cores (4030, 4032, 4031, 4015) bearing coils within, member which is combination of the said yokes (4014, 4017) and non-magnetic flat plate (4016)) is fixedly attached with body (not shown) of motor. FIG. 32A shows two armature cores (4030) and (4031) fixedly mounted to a flat surface of yoke (4014) (act as surface 1 of said member) with a gap between the two armature cores. The said armature cores (4030) and (4031) are flat and rectangular in shape. There are slots on armature cores for housing insulated armature conductors (4001). The said armature core (4030) carries a coil side (4018) of a coil in a slot, while another armature core (4031) carries a coil side (4019) of another coil in a slot. The armature cores (4030, 4031) and yoke (4014) are made up of laminated magnetic substance. There is flat rectangular plate of nonmagnetic substance (4016) which is fixedly mounted to another surface of yoke (4014) having same length and width of yoke (4014).

The yoke (4017) is fixedly mounted to another surface of non-magnetic substance plate (4016). The said yoke is identical in length, width as well as in construction to the yoke (4014). The armature cores (4032) and (4015) are mounted on the surface of the yoke (4017) which is away from nonmagnetic core 4016 (surface 2 of member) in same fashion as armature cores (4030, 4031) on the yoke (4014). The said armature cores (4032, 4015) are made of laminated magnetic substance and have flat rectangular shape. Slots are made on the armature cores (4032, 4015) for housing conductors. The length and width of armature core (4030, 4031) align with the length and width of the armature core (4032, 4015) respectively.

Armature winding comprises of at least 1 winding (1, 2 . . . n), each said winding have multiple groups of coils which are connected serially or parallel, however in the preferred embodiment only two winding 1 and 2 has been described.

The said armature cores (4032, 4015) respectively carry coil sides (4020, 4021) in their slots. Each coil side has multiple conductors in it. There are coil sides (4018, 4020) in each slot on the respective armature core (4030, 4032). Similarly there are coil sides (4019, 4021) in each slot on armature cores (4031, 4015) respectively. Said coil sides (4018, 4020) from vertically aligned slots on armature cores (4030, 4032) respectively form one armature coil. Similarly coil sides (4019, 4021) from vertically aligned slots on armature cores (4031, 4015) respectively form an armature coil. The armature coil is series connection of conductors alternately from two coil sides. There are multiple armature coils formed from each said coil side (4018) and (4020). Similarly the multiple armature coils are formed from each coil side (4019) and (4021). Such coils are shown with terminals + and −.

North poles facing coil sides on each coil in the said group of multiple coils bears terminals (+(plus), −(minus)/+′(plus″), −′(minus′)/+″(plus″), −″(minus)″) such that terminals (+(plus), +′(plus′), +″(plus″) . . . n) terminals of each coil are on the coil sides (4018) present on the slots of the armature core (4030) while the corresponding terminals (−(minus), −′(minus′), −″(minus″) are on the adjacent coil sides (4020) on the slots of the corresponding armature core (4032), such terminals being so connected that terminal (−(minus)) is connected to (+′(plus′)), (−′(minus′)) is connected (+″(plus″)) and so on till all the coils are connected to form serially connected group of multiple coils. Each said serially connected coils having two end terminals START and FINISH.

South poles facing coil sides on each coil in the said group of multiple coil bears terminals (+(plus), −(minus)/+′(plus′), −′(minus′)/+″(plus″), −″(minus)″) such that terminals (+(plus), +′(plus′), +″(plus″) . . . n) terminals of each coils are on the coil sides (4019) present on the slots of the armature core (4031) while the corresponding terminals (−(minus), −′(minus′), −″(minus″) are on the adjacent coil sides (4021) on the slots of the corresponding armature core (4015), such terminals being so connected that terminal (−(minus)) is connected to (+′(plus′)), (−′(minus′)) is connected (+″(plus″)) and so on till all the coils are connected to form serially connected group of multiple coils. Each said serially connected coils groups having two terminal START and FINISH.

One set of winding of multiple groups of said coils having coil sides (4018,4020) i.e. winding 1, comprises of serially connected multiple said groups in a manner that the terminal FINISH of first group is joined to the terminal START of second group, terminal FINISH of second group is joined to the terminal START of third group, so on till all the groups having said coils each with coil sides (4018, 4020) are connected, with terminal START of first group marked as terminal START of winding 1 and terminal FINISH of last group marked as terminal FINISH of winding 1.

Alternatively, winding 1 is formed by parallel connection of said multiple groups of serially connected said coils with terminal START of all multiple groups connected together and marked as terminal START of winding 1 and terminal FINISH of all multiple groups connected together and marked as terminal FINISH of winding 1, wherein each group includes equal number of coils in series, each coil having equal number of conductors in it.

Winding 2 is identical to winding 1 but having said groups, each said group having coils with coil sides (4019, 4021).

Armature winding comprises of said winding 1 and said winding 2 connected serially in manner that terminal FINISH of winding 1 connected to terminal START of winding 2 with terminal START of winding 1 marked as terminal A1 and terminal FINISH of winding 2 marked as terminal A2 of armature winding.

Alternatively armature winding comprises of said winding 1 and said winding 2 connected in parallel in a manner that terminal START of both windings connected together and marked as terminal A1 of armature winding and terminal FINISH of both windings connected together and marked as terminal A2 of armature winding.

Aforementioned construction of winding of DC generator and DC motor is same as described above.

DC voltage is applied across armature winding terminals A1 & A2 in case of DC machine works as motor while induced DC voltage available across A1 & A2 terminals in case of DC machine working as generator.

For linear brushless motor action, the direction in which current is sent through armature conductor (4001) is shown by arrow on said conductor. For all the conductors in one coil side, the direction of currents is identical. Multiple armature coils are connected in series in such way as to maintain direction of current sent in conductor/coil side as shown by arrows on conductors in FIG. 32A.

In FIGS. 32B and 32C the current direction for the current going away from observer in said conductors (4001) is shown by cross (X) on conductor while the current direction for the current coming towards observer is shown by a dot (.) on the conductor. The DC voltage is applied across armature winding for sending currents through armature conductors.

In FIG. 32A, for the purpose of creating first magnetic field system there is yoke (4011) which is made up of laminated magnetic substance and has rectangular flat plate shape. Magnets (4008 and 4009) are fixedly mounted on one of the flat surface of yoke (4011) with a gap between said magnets. The said magnets (4008, 4009) are rectangular in shape. The length of the magnets (4008, 4009) align with the length of the armature core (4030, 4031) respectively. There is an air gap between armature cores (4030, 4031) and magnets (4008, 4009). The north (N) pole of magnet (4008) is facing towards armature core (4030) while south (S) pole of magnet (4009) is facing towards armature core (4031).

Another yoke (4012) is made up of laminated magnetic substance and has rectangular plate shape. The magnets (4007) and (4010) are fixedly mounted with a gap between them to the flat surface of said yoke (4012) to create second magnetic field system. The magnet (4007) has its north (N) pole facing towards armature core (4032) while magnet (4010) has its south (S) pole facing towards armature core (4015) The said magnets (4007, 4010) is aligned lengthwise with respective armature cores (4032, 4015). There is an air gap (4002) between armature cores (4032, 4015) and respective magnets (4007, 4010). Yoke (4011) and yoke (4012) are fixedly fixed with each other by means (4013) which is generally nonmagnetic substance. The width of magnets (4008, 4009, 4007, 4010) and yokes (4011, 4012) is generally equal or larger or smaller than the width of armature cores (4030, 4031, 4032, 4015), yokes (4014, 4017) and non-magnetic plate (4016), so that substantial portion of magnets will always be there above armature cores when magnets are moving. For simplicity same width is shown for magnets and armature cores in figures. The systems comprising of magnets (4008, 4009), yoke (4011), magnets (4007, 4010), yoke (4012) and non-magnetic means (4013) is free to move in direction at right angles w.r.t. FIG. 32A, (Going away from observer or coming towards observer), keeping constant air gap length between magnets and armature cores facing them by use of bearings or other suitable means (not shown).

FIG. 32B is left hand side view of embodiment in FIG. 32A in which armature cores (4030, 4032) respectively are under influence of magnets (4008, 4007) are shown. A coil having coil sides (4018 and 4020) are positioned respectively under north (N) pole of magnet (4008) and north (N) pole of magnet (4007). The current directions in conductors are shown by cross (X) and a dot (.) on said conductors. The vertical lines with arrows on them are flux lines. The interaction between magnetic flux produced by current flowing through conductors in coil sides (4018) and magnetic flux produced by the two magnets (4008 and 4009) together results into production of force on magnet (4008) and yoke (4011). Similarly the interaction between magnetic flux produced by current flowing through the conductors in the coil sides (4020) and magnetic flux produced by magnet (4007 and 4010 together) results into production of force on magnet (4007) and yoke (4012). Both forces are in same direction w.r.t. stationary armature cores. Thus these forces are additive which leads to the motion of said magnet (4008, 4007) and said yoke (4011, 4012) in the direction shown in FIG. 32B.

FIG. 32C exhibits left hand side view of embodiment in FIG. 32A from vertical plane drawn at the center (not shown) between magnets (4008) and (4009). It shows armature cores (4031) and (4015) under influence of respective magnets (4009) and (4010). It can be seen that the interaction between magnetic flux produced by current flowing through conductors in coil sides (4019) and magnetic flux produced by magnets (4009 and 4008 together) results into production of force on magnet (4009) and yoke (4011). Similarly the interaction between magnetic flux produced by current flowing through conductors in coil sides (4021) and magnetic flux produced by magnet (4010 and 4007 together) results into production of force on magnet (4010) and yoke (4012). Both forces are in same direction w.r.t. stationary armature cores. and thus these forces are additive and lead to the motion of said magnets (4009, 4010) and said yokes (4011, 4012) in the direction as shown in FIG. 32C.

With reference to FIGS. 32B and 32C it is found that direction of forces on magnets (4008, 4009), yoke (4011) and on magnets (4007, 4010), yoke (4012) is same and hence forces on all four magnets are additive. It results into motion of all four magnets (4008, 4009, 4007 and 4010) with yokes (4011, 4012) and means of non-magnetic substance (4013) into motion of motor, in direction on right hand side as shown in FIGS. 32(b) and 32(c) and towards observer w.r.t. FIG. 32A. Further yokes (4011) and (4012) are fixedly mounted with each other by non-magnetic substance means (4013).

FIG. 32(D) shows one more example of embodiment in FIG. 32A. One magnet from each magnetic field system is replaced by a yoke. One of the magnets chosen from two magnets (4009, 4008 and 4010, 4007) (For e.g. (4009 and 4010)) which are fixed to each of the yokes (4011, 4012) respectively are replaced by yokes. In illustrative embodiment magnets (4009, 4010) is replaced by yokes (4023, 4022) respectively. The yokes (4023, 4022) have same size and shape as that of replaced magnets (4009, 4010). The said yokes (4023, 4022) are fixedly attached to yoke (4011, 4012) respectively. Remaining assembly is same as that shown in FIG. 32A. In this example less force will be produced on magnets by armature.

### Example

In one more example of embodiment in FIG. 32A, system consisting

magnets (4008), (4009), (4007), (4010) and yokes (4011, 4012) and means 4013 is fixedly fixed with body (not shown) of motor. A system consisting of armature cores (4030, 4032, 4031) and (4015) with coils on them and yokes (4014, 4017), non-magnetic plate (4016) is free to move horizontally w.r.t. stationary magnetic field systems, keeping constant air gap length between magnets and armature cores with help of means (not shown). The force is created on armature system by systems of magnets, and armature cores (4030, 4032, 4031, 4015) with their yokes (4014, 4017) and non-magnetic plate (4016) move in direction at right angle (going away from observer) in FIG. 32A.

For a motor in embodiment 2, direction of motion can be reversed by ways mentioned in embodiment) and speed of movement can be changed by ways mentioned in embodiment 1.

### Linear Brushless DC Generator:

The linear brushless DC machine can work as linear brushless DC generator if instead of sending DC current through conductors in coil sides as shown in FIG. 32A, the mechanical power is supplied to the system of magnets (4008, 4009, 4007, 4010), and member which is combination of yokes (4011, 4012) and nonmagnetic means (4013). The said mechanical power is applied in such manner that the said system moves in linear direction which is either opposite or same to the direction of motion of magnetic system shown in FIGS. 32B and 32C, keeping constant air gap between magnets and stationary armature cores. In this illustrative embodiment for the purpose of not adding figures for linear generator for simplicity, the said mechanical power is applied in such manner that the above said system moves in linear direction which is opposite to the direction of motion of magnetic system shown in FIGS. 32B and 32C.

Because of the cutting of the magnetic flux by said conductors, the DC emf will be induced in the conductors. The direction of the DC induced emf in conductors and direction of current that would flow through the conductors is shown by arrows on conductors in FIG. 32A. The polarity (+/−) of DC emf induced in coils and available at coil terminals will be opposite to that shown on coil terminals in FIG. 32A direction of motion of said magnets and associated yokes is reversed after reaching the end of the width of the armature cores. The magnets and associated yokes are then moved in the direction shown in FIGS. 32B and 32C. The DC emf having direction opposite to that shown by arrows on conductors in FIG. 32A, is induced in the said conductors. The polarity (+/−) of DC emf induced in coils and available at coil terminals will be same as shown on coil terminals in FIG. 32A.

When the said magnets and the associated yokes move to the other end of the width of the armature cores, again direction of motion of said magnets and associated yokes is reversed. In this way said magnets and associated yokes are moved continuously with respect to said armature cores. Double pole double throw (DPDT) switch/relay/contactor is connected between terminals of armature winding (mentioned in embodiment 2) and output voltage terminals of this generator. The double pole double throw (DPDT) switch/relay/contactor is actuated when the above said magnets reach at each end of the armature cores so as to maintain same polarity of DC voltage output at output voltage terminals of this generator. A capacitor is connected across output voltage terminals of this generator to supply current to load at the time of switching of the double pole double throw (DPDT) switch/relay/contactor. Alternatively, a full wave rectifier is connected to armature winding terminals to convert bidirectional voltage into DC voltage.

Alternatively there can be arrangement for linear machine in which armature system is moved with respect to stationary system of magnets and associated yokes.

Linear DC Machine with Single Yoke in Armature System:

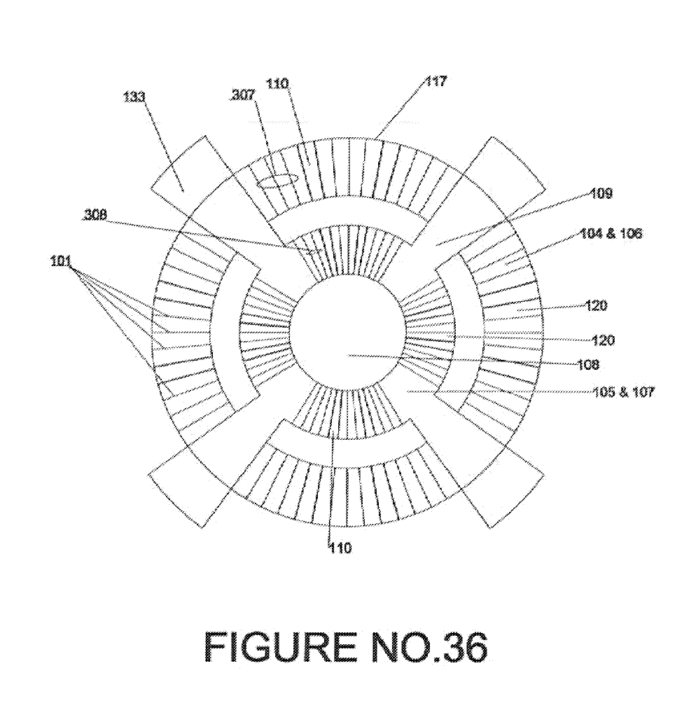

FIG. 35 sets forth another way of constructing armature system, in armature system instead of pairs of yoke (4014. 4017) the member has only single yoke (4049).

The flat rectangular plate (4016) made of non-magnetic substance and mentioned above, under embodiments of linear brushless DC motor and DC generator, is not essential. Instead of the non-magnetic flat rectangular plate (4016), the yokes (4014 and 4017) are combined into a single rectangular plate shaped yoke (4049) made of laminated magnetic substance as shown in FIG. 35. The said armature cores (4030, 4031) are mounted on one flat surface of yoke (4049) facing magnets (4008, 4009) while said armature cores (4032, 4015) are mounted on another flat surface of yoke (4049) facing magnets (4007, 4010). The armature system consisting of armature cores (4030, 4032, 4031, 4015) (with said coils there within), yoke (4049) is fixedly attached with body (not shown) of motor for stationary armature type linear brushless DC motor and generator. The remaining construction of the armature system and magnetic field system is same as described under embodiment 2 for the linear brushless DC motor and generator.

### B. Axial Flux DC Machine:

In the axial flux DC machine the magnetic flux travels in the axial direction. They can have multiple disk and pancake shape rotors and stators. The novelty and inventive step in the axial flux type machine of the present invention as well as its working principle are described in seven embodiments.

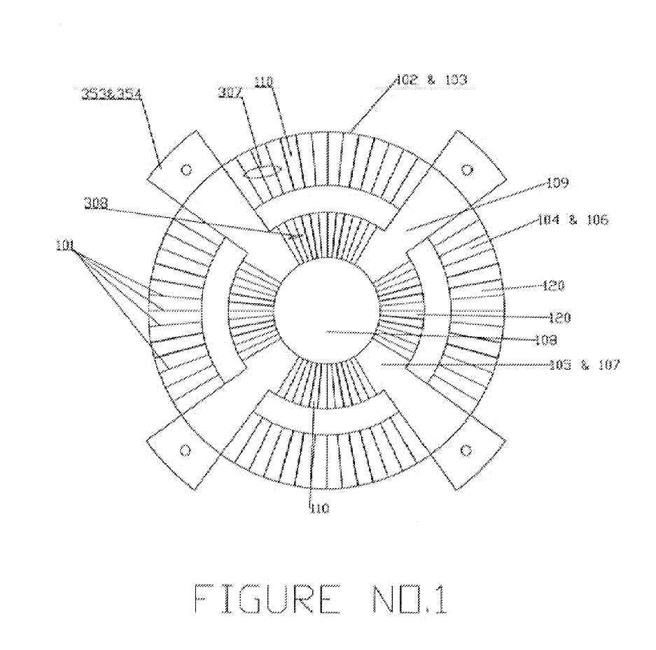

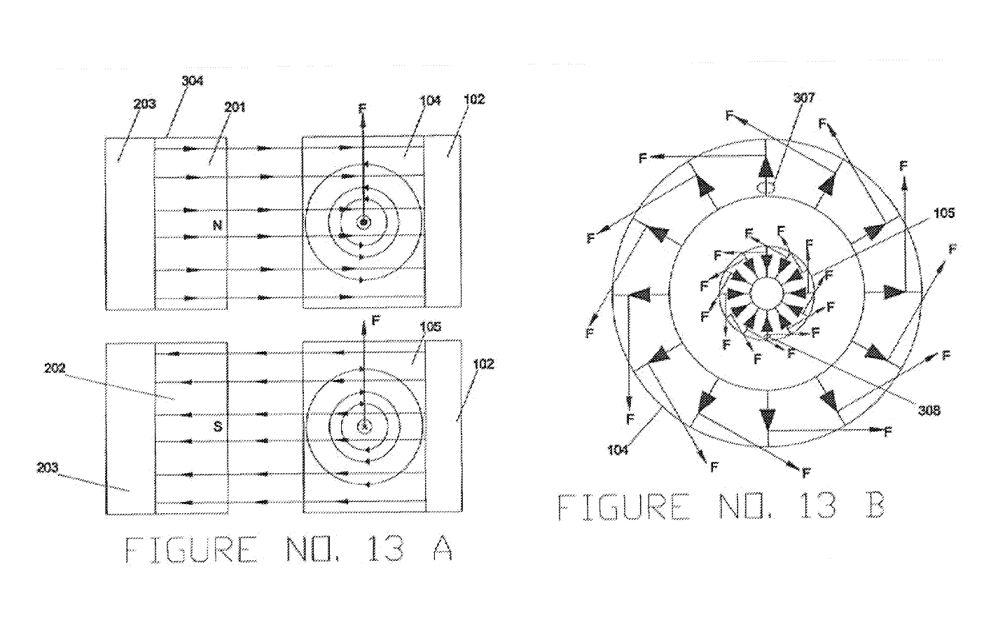

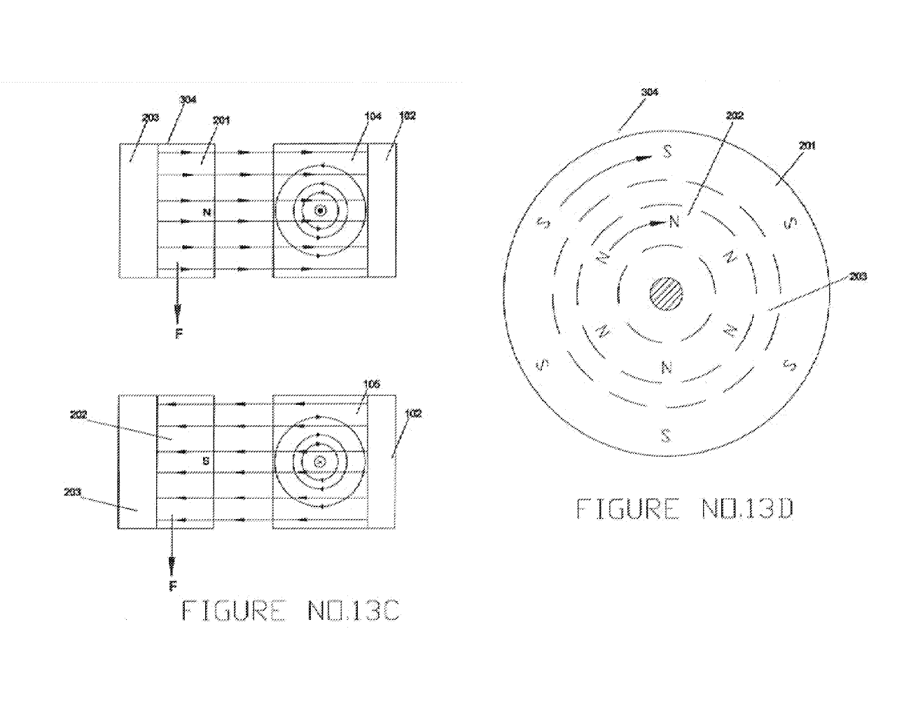

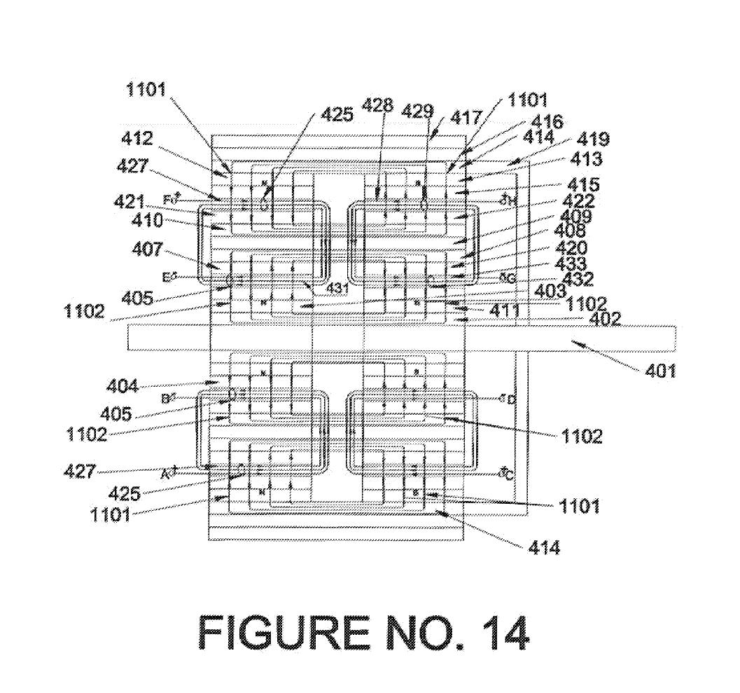

Assembly of the axial flux type DC machine is explained here with the help of FIGS. 1, 2, 3, and FIG. 20 while the axial flux type machine operating as DC motor is explained in FIGS. 18, 13A, 13B, 13C, 13D, 17A, 17B, 17C and 17D.

The present invention when directed to the axial flux type DC machine comprises of rotary shaft (302) which is rotatably supported on bearings in bearing house which is fixed in end caps (350) and (352). The said end caps are fixed to the DC machine body. Machine frame (361) is generally cylindrical to enclose the substantial portions of motor, and fixed on the base thereof, not shown.

There are 4 yokes (203, 205, 102, and 103) and one non-magnetic core (301). The yokes (203, 205) are part of magnetic flux producing system while combination of pair of yokes (102, 103) and non-magnetic core which is member is a part of armature system. The said yokes are made of laminated layer of magnetic substance. The shaft (302) carries two yokes (203, 205) which are fitted in longitudinal direction of said shaft. The armature system is between two yokes (203 and 205) which comprises of member (two yokes (102, 103) and one non-magnetic core (301)) and armature winding (explained elsewhere).

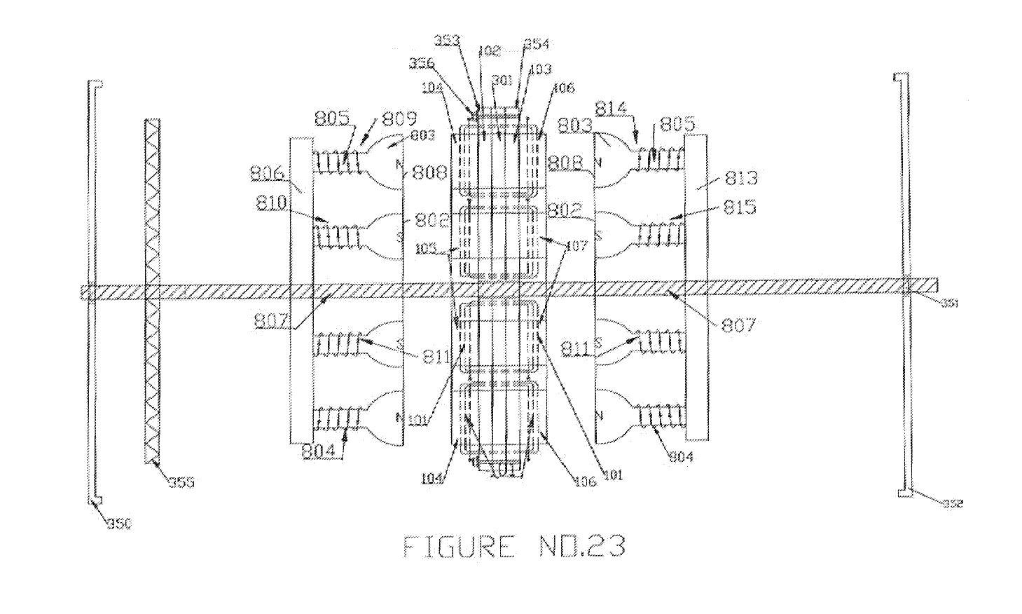

Like radial flux machine there is magnetic flux producing system comprising of two separate magnetic field systems (304 and 305), as shown in FIG. 20.

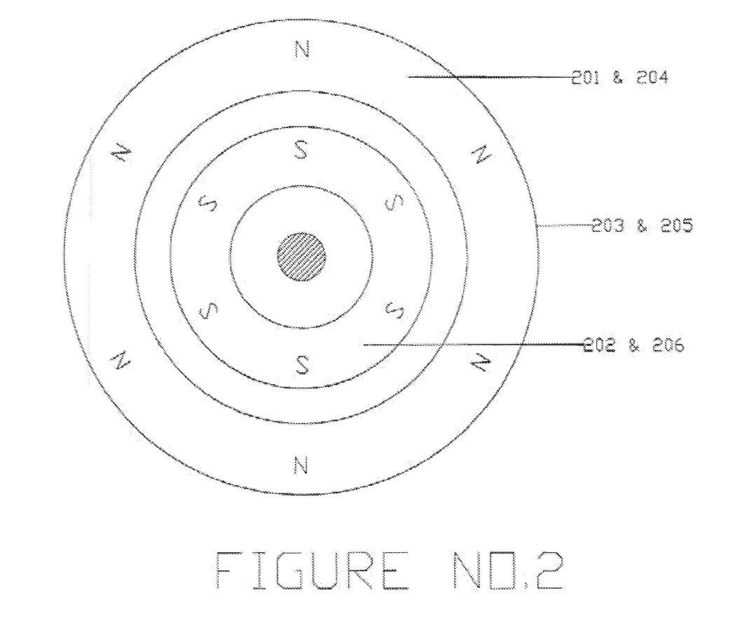

The rotary shaft (302) fixedly carries yoke (205), which is generally having shape of flat circular disc. The permanent magnet (204) which is usually a flat ring shaped placed on the outer peripheral portion of flat circular surface of the yoke (205) away from end cap (352). The permanent magnet (204) is polarized in predetermined orientation in which the magnet (204) has its outer flat ring shaped end magnetized in one magnetic polarity, while its inner ring shaped end has the opposite polarity. In the illustrative embodiment, outer ring shaped flat end has north (N) magnetic pole and inner ring shaped end has south (S) magnetic pole, as shown in FIGS. 2, 3 and 20. There is another permanent magnet (206)) which is generally flat ring shaped magnet placed on flat circular surface of yoke (205) at some radial distance from inner cylindrical surface of the permanent magnet (204). The permanent magnet (206) is polarized in predetermined orientation like permanent magnet (204) but in opposite direction.

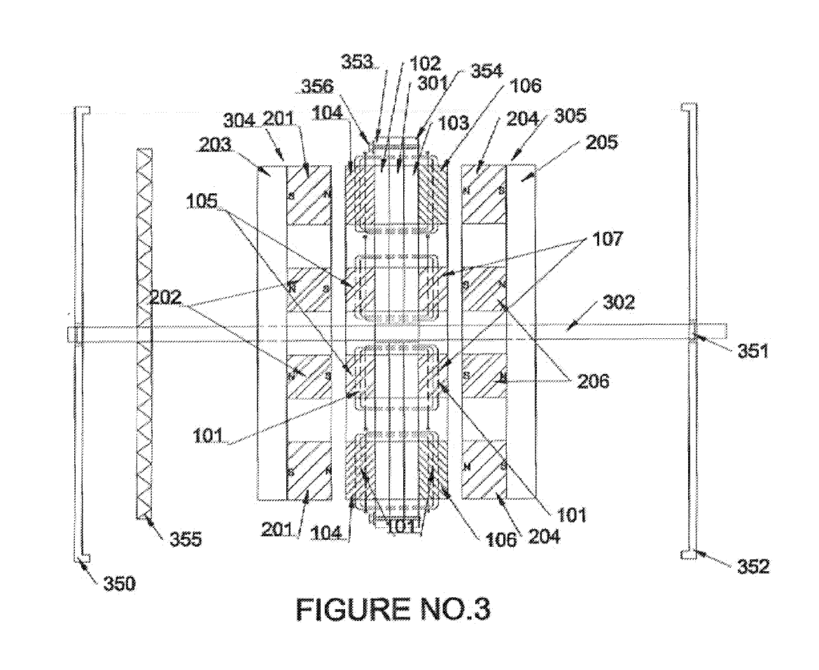

In the illustrative embodiment, outer ring shaped flat end has south (S) magnetic pole and inner ring shaped flat end has north (N) magnetic pole as shown in FIGS. 2, 3 and 20. So rotary shaft (302), yoke (205), magnet (204) and magnet (206) form one of the magnetic field systems (305) in the FIGS. 3 and 20

Within machine body (361) the rotary shaft fixedly carries another flat disc shaped yoke (203), which is spaced in longitudinal direction of shaft (302) from the yoke (205). The said rotary shaft (302) passes through the hole (108) which is at the center of armature system as shown in FIG. 1.

The said yoke (203) fixedly carries a pair of permanent magnets (201, 202) which are generally flat ring shaped. The said magnets are placed on outer peripheral and inner portion of flat circular surface of yoke (203) which is facing towards the magnetic field system (305). The magnets (201, 202) face their respectively north (N) and south (S) pole towards magnetic field system (305). The yoke (203), magnets (201, 202) form magnetic field system, (304). The magnetic system (304) in terms of deployment of magnets (201, 202) and predetermined orientation of said magnets is the mirror image of magnetic system (305) as seen in FIGS. 2, 3 and 20.

With reference to FIGS. 1, 3 and 20, another yoke (102) having flat disc shape is fixedly fitted to body (361) of the motor by its extended portion (353). The said yoke (102) is made of two co-axial flat rings which are separated by flat ring shaped air gap between the two. Arms (109) which are made of layers of magnetic substance connect outer flat ring and inner flat ring. There is circular hole (108) at the center of yoke (102). The said rotary shaft (302) passes through the hole (108).

There is an armature core (104) which is a projected portion as depicted in the FIGS. 3 and 20 generally have flat ring shape fixedly fitted to the outer flat ring of the yoke (102) which is also surface 1 of member. The said armature core (104) is made of laminated layers of magnetic substance.

As shown in FIG. 1 the slots (120) are made on said armature (104) in radial direction from its inner periphery to outer periphery which house coil side (307). The portion between two slots is called as tooth (110). Coil side (307) is a group of insulated conductors (101). There are multiple slots on armature (104) with each slot housing multiple coil sides (307). The radial height of outer ring on yoke (102) generally matches with the radial height of armature core (104). The said armature core (104) faces north (N) pole of magnet (201) of field system (304) and aligns with it. There is adequate air gap between the armature core (104) and permanent magnet (201).

Another armature core (105) is projected portion and generally having flat ring shape fixedly fitted to the inner flat ring of yoke (102) (which is surface 1 of member). The said armature core (105) is made of laminated layers of magnetic substance. The said armature core (105) also bears slots (120) which house coils side (308) in a identical manner as the armature core (107). The radial height of inner ring on yoke (102) generally matches with radial height of armature (105). The armature core (105) faces south (S) pole and is aligned with south (S) pole of flat cylindrical permanent magnet (202) of field system (304). There is adequate air gap between the armature core (105) and permanent magnet (202).

Further, the flat disc (301) is fixedly fitted to yoke (102) in its extended portion above periphery of its outer ring. The said flat disc (301) is fitted to that flat side of yoke (102) to which the armatures (104) and (105) are not fitted. The said flat disc (301) which comprises of two co-axial rings is made of non-magnetic substance. There is ring shaped windows between outer rings of yoke (102), yoke (103) and disc (301) and their respective inner flat rings. These three windows align with each other. The outer diameter and the inner diameter of outer ring on the disc (301) generally are equal to outer and inner diameter respectively, of outer rings on the yokes (102 and 103) and aligned with it. Similarly the outer diameter and the inner diameter of inner ring on the disc (301) are usually equal to the outer and inner diameter respectively of inner rings on yokes (102 and 103) and aligned with it. The outer and inner rings of disc (301) are fixedly attached by arms (109) which are made of non-magnetic substance. The circular hole at the centre of the disc (301) is aligned with the circular hole (108) of the yoke (102) and yoke (103). The nonmagnetic disc (301) provides isolation between magnetic field systems (304) and (305). On upper portion and lower portion of the arms (109), armature core is absent on the discs (102) and (103). Another yoke (103) is fixedly fitted to the disc (301) and the yoke (102) in the extended portions (353) and (354) by means (356). Further yokes (102), disc (301) and yoke (103) together are fixedly fitted to motor body (361) in the portions (353) and (354). The said yoke (103) is fitted on the flat side of disc (301) to which yoke (102) is not fitted. The said yoke (103) is having flat disc shape. It is made of laminated layers of magnetic substance. The yoke (103) is made of two co-planer flat rings which are separated by flat ring shaped air gap (window). The arms made of magnetic substance (109) connect the outer and inner flat rings. There is a circular hole (108) at the centre of yoke (103) which aligns with that on yoke (102) and disc (301). The said rotary shaft (302) passes through the hole (108).

The armature core (106) is projected portion generally having flat ring shape is fixedly fitted to the outer flat ring of the said yoke (103) (which is surface 2 of member). The said armature core (106) is made of laminated layers of magnetic substance. Slots (120) are made on armature (106) in radial direction from its inner periphery to outer periphery which house coil side (309). The portion between two slots is called as tooth (110). There are multiple slots on armature (106) which houses multiple coil sides (309). A coil side is a group of insulated conductors. The radial height of the outer ring on yoke (103) generally matches with the radial height of the armature (106). The said armature (106) faces north (N) pole and is aligned with north (N) pole of flat cylindrical permanent magnet (204) of the field system (305). There is an adequate air gap between armature (106) and permanent magnet (204). The armature core (107) is projected portion is generally having flat ring shape fixedly fitted to inner flat ring of yoke (103) (which is surface 2 of member). The armature core (107) is made of laminated layers of magnetic substance. There are slots (120) which are made on the armature core (107) in radial direction from its inner periphery to outer periphery and these slots house coil side (310). The said coil side (310) is a group of insulated conductors. A coil is formed by series connections of conductors alternating from coil sides (307 and 309).

In one of ways of forming coil, the coil conductor passes through a slot on the armature core (104) then over outer peripheral portions of outer ring on yoke (102), outer ring on a flat disc (301) and outer ring on yoke (103) then through a slot on armature (106) then over inner peripheral portions of outer ring on yoke (103), outer ring of the flat disc (301) and outer ring of yoke (102). This sequence is repeated till all the conductors in the coil sides (307) and (309) are connected in series. Multiple such coils are wound having coil sides (307) and (309) from multiple slots on the armatures cores (104) and (106). Similarly another coil is formed by series connections of alternate conductors from the coil side (308) and (310). In one of the ways of forming coil, the coil conductor passes through a slot on armature (105) then over outer peripheral portions of inner ring on yoke (102), inner ring of flat disc (301) and inner ring on yoke (103) then through a slot on armature (107) then over inner peripheral portions of inner ring on yoke (103), inner ring of the flat disc (301) and inner ring on the yoke (102), and repeating this sequence till all the conductors in the coil sides (308) and (310) are connected in series.

The radial height of the inner ring on the yoke (103) generally matches with the radial height of the armature (107). The said armature (107) faces south (S) pole and is aligned with south (S) pole of flat cylindrical permanent magnet (206) of field system (305). There is adequate air gap between armature (107) and permanent magnet (206). There are multiple such coils are wound having coil sides (308 and 310) from multiple slots on armatures (105) and (107).

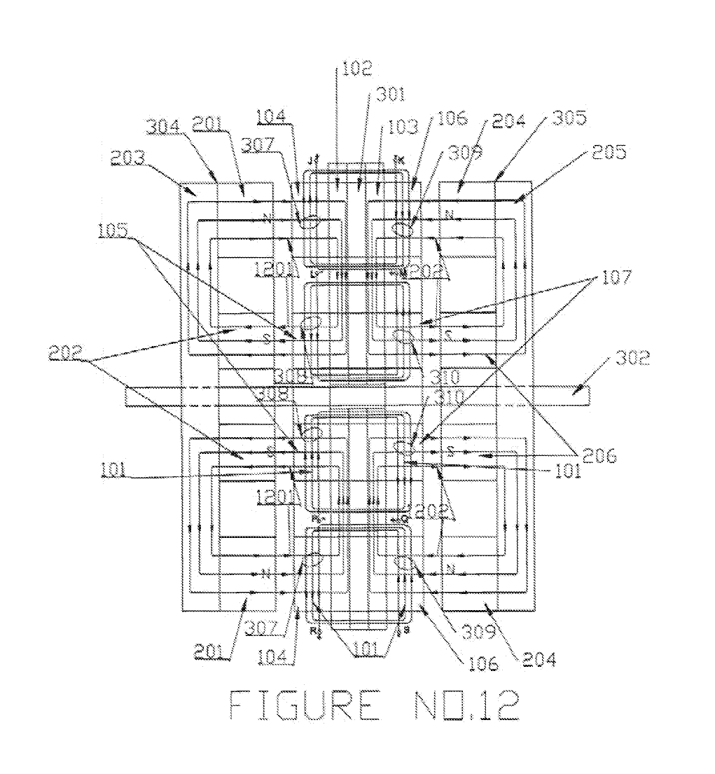

Axial flux type DC machine working as DC generator FIG. 12 shows the direction and path of magnetic fluxes (1201, 1202) produced by magnetic field systems (304, 305). It also shows the direction of induced emfs in conductors when magnetic field systems (304) and (305) are rotated in anticlockwise direction seen from end cap (350) as shown in FIG. 20 with respect to stationary armature system. This embodiment is directed towards axial DC machine while operating as axial flux DC generator. The working of the DC generator is based on Fleming's right hand rule.

A coil will have conductors connected in series alternatively from a slot on armature (104) then a slot on armature C (106) then said slot on armature (104) then said slot on armature (106) and so on. Similarly another coil will have conductors connected in series alternatively from a slot on armature (105) then a slot on armature (107) then said slot on armature (105) then said slot on armature (107) and so on. The group of conductors in slot in an armature (core) is called as coil side. There is one coil side in each slot on armature.

One such coil side (307) is in a slot in armature core (104) and is under north pole of magnetic field system (304). Another coil side (309) is in a slot in armature core (106) and is under the north pole of magnetic field system (305). A coil is series connection of conductors alternately from its two coil sides. One coil is formed by said coil sides (307) and (309) and is marked with terminals J and K. Similarly there is another coil having terminal L and M formed by coil sides (308) and (310). The said coil sides (308 and 310) are placed in slots of armature core (105) and armature core (107) respectively. The said coil sides (308) and (310) are under south poles of magnetic systems (304) and (305) respectively.

One more coil with terminals R and S is formed by coil sides (307, 309) which are under north poles of field systems (304) and (305) respectively. The coil with terminals P and Q is formed by coil sides (308 and 310) which are under south poles of the field systems (304) and (305) respectively.

Armature winding comprises of at least 1 winding (1, 2 . . . n), each said winding have multiple groups of coils which are connected serially or parallel, however in the preferred embodiment only two winding 1 and 2 has been described.

North-pole facing coil sides on each coil in the said group of multiple coils bears terminals (K, J/S, R/K′, J′/S′R′, . . . n) such that terminals J, R, J′, R′ are on the coil sides (307) present on the slots of the armature core facing magnetic field system (304) while the corresponding terminals K, S K′, S′ are on the adjacent coil sides (309) on the slots of the corresponding armature core facing magnetic field system (305). These terminals are so connected that terminal J is connected to S, R is connected to K′, J′ connected to S′ and so on till all the coils are connected to form serially connected group of multiple coils.

South-poles facing coil sides on each coil in the said group of multiple coils bears terminals (L,M/P,Q/L′,M′/P′,Q′ . . . n) such that that terminals L, P, L′, P′ are on the coil sides (308) present on the slots of the armature core facing magnetic field system (304) while the corresponding terminals M, Q M′, Q′ are on the adjacent coil sides (310) on the slots of the corresponding armature core facing magnetic field system (305), such terminals being so connected that terminal M is connected to P, Q is connected to L′, M′ connected to P′, and so on till all the coils are connected to form serially connected group of multiple coils.

Each serially connected group of multiple coils having two end terminals, START terminal and FINISH terminal.

One set of winding of multiple groups of said coils having coil sides (309,307) i.e. winding 1, comprises of serially connected multiple said groups in a manner that the terminal FINISH of first group is joined to the terminal START of second group, terminal FINISH of second group is joined to the terminal START of third group, so on till all the groups having said coils each with coil sides (309, 307) are connected, with terminal START of first group marked as terminal START of winding 1 and terminal FINISH of last group marked as terminal FINISH of winding 1.

Alternatively, winding 1 is formed by parallel connection of said multiple groups of serially connected said coils with terminal start of all multiple groups connected together and marked as terminal start of winding 1 and terminal FINISH of all multiple groups connected together and marked as terminal FINISH of winding 1, wherein each group includes equal number of coils in series, each coil having equal number of conductors in it.

Winding 2 is identical to winding 1 but having said groups, each said group having coils with coil sides (308, 310).

Armature winding comprises of said winding 1 and said winding 2 connected serially in manner that terminal FINISH of winding 1 connected to terminal START of winding 2 with terminal START of winding 1 marked as terminal A1 and terminal FINISH of winding 2 marked as terminal A2 of armature winding.

Alternatively armature winding comprises of said winding 1 and said winding 1 connected in parallel in a manner that terminal START of both windings connected together and marked as terminal A1 of armature winding and terminal FINISH of both windings connected together and marked as terminal A2 of armature winding.

Construction of armature winding described above is same for DC generator and DC motor.

Induced DC voltage is available across armature winding terminals if DC machine is working as DC generator and DC voltage is applied across armature winding terminals if DC machine is working as DC motor.

There are two isolated magnetic field systems (304, 305) which are rotated in the same direction. The magnetic flux lines (1201) are produced by the magnetic field system (304) while the magnetic flux lines (1202) are produced by the magnetic field system (305). The said magnetic flux lines (1201) emerge out from the north pole of the magnet (201), passes through the closed flux transport mean which is a magnetic path that traverses through air gap, then through conductors (101) from coil side (307) mounted in armature (104), then armature core (104) and disc shaped yoke (102), then moves through arm (109) joining to armature (105), armature 105, through conductors from coil side (308) placed in slot in armature (105), air gap, then south pole of magnet (202), north pole of magnet (202), yoke (203) and south pole of magnet (201) and finally the north pole of magnet (201).

Similarly the magnetic flux lines (1202) produced by the magnetic field system (305). These flux lines emerge out from north pole of magnet (204), passes through closed flux transport loop mean which is a magnetic path that traverses through air gap, through conductors from coil side (309) mounted in slots of armature core (106), then pass through the armature core (106) and disc shaped yoke (103), then through arm (109) on the yoke (103), through armature (107) then move through conductors from coil side (310), air gap, south pole of magnet (206), north pole of magnet (206), yoke (205) and south pole of magnet (204) and finally the north pole of magnet (204).

With the above mentioned anticlockwise direction of rotation of the magnetic field systems (304, 305) (refer FIG. 20), the relative direction of rotation of all armatures having coil sides and conductors is clockwise when seen from side of end cap (350). Now by applying Fleming's right hand rule, the direction of induced emfs in all the conductors in the coil sides (307, 308) are shown by arrow on the said conductors in FIG. 12. The direction of the induced emfs in all the conductors in the coil side (308) under armature cores (105) is opposite to the induced emf in the conductors in coil side (307) because the direction of magnetic flux lines (1201) is set up in opposite direction when passing through the respective conductors.

Similarly Fleming right hand rule applies to the conductors in the coils sides (309, 310) placed in the slots on the armature cores (106, 107) respectively shown in FIG. 12. With anticlockwise direction of rotation of the magnetic field systems (304, 305), the relative direction of rotation of all armatures, coil sides and conductors in them is clockwise when seen from the side of end cap (350) as shown in FIG. 20 and FIG. 3. Now by applying Fleming's right hand rule, the directions of the induced emfs in all conductors in the coil sides (309 and 310) are shown by arrows on conductors in them. The direction of emfs in all the conductors in the coil side (310) in armature core (107) is opposite to that in conductors in the coil side (309) in the armature core (106) because the direction of the magnetic flux lines are set up in the opposite direction when passing through the respective conductors.

The direction of emfs in all the conductors in a coil side is identical. Further each coil side cuts the magnetic flux of the same pole throughout the rotation. Since the direction of emfs in all conductors in a coil side is the same throughout the duration of rotation, it means that the emf induced in all conductors in a coil side is DC emf. Further in one complete rotation the direction of the magnetic flux lines is at right angles with regard to relative direction of motion of conductor so that the induced emf has constant value throughout time just like pure DC voltage from battery. This constant value of pure DC emf in conductor will change proportionally with the speed of rotation of field systems (304 and 305).

The directions of emfs in the conductors in coil sides (307 and 309) are such that the value of the emf induced in the coil formed from the coil sides (307) and (309) is the sum of emfs induced in all conductors in the said coil sides. In one coil the induced emf is such that terminals J and K are of positive and negative polarities respectively as shown in FIG. 12. Similarly in another coil the induced emf is such that its terminal R is positive with respect to terminal S. There are multiple such coils, each having one coil side in a slot on the armature core (104) and another coil side in a slot on the armature core (106).

The above arrangement is applicable and replicated to conductors in coil sides (308) and (310) which are under south poles of magnetic field systems (304) and (305). One coil which is formed from the coil sides (308, 310) has induced emf such that terminals M and L are of positive and negative polarities respectively. Similarly one more coil has induced emf polarity such that its terminal Q is positive and terminal P is negative. There are multiple such coils having one coil side in armature (105) and another coil side in armature (107).

The output DC voltage and DC power is available across terminals A1 and A2.

### Axial Flux Type DC Machine Working as DC Motor

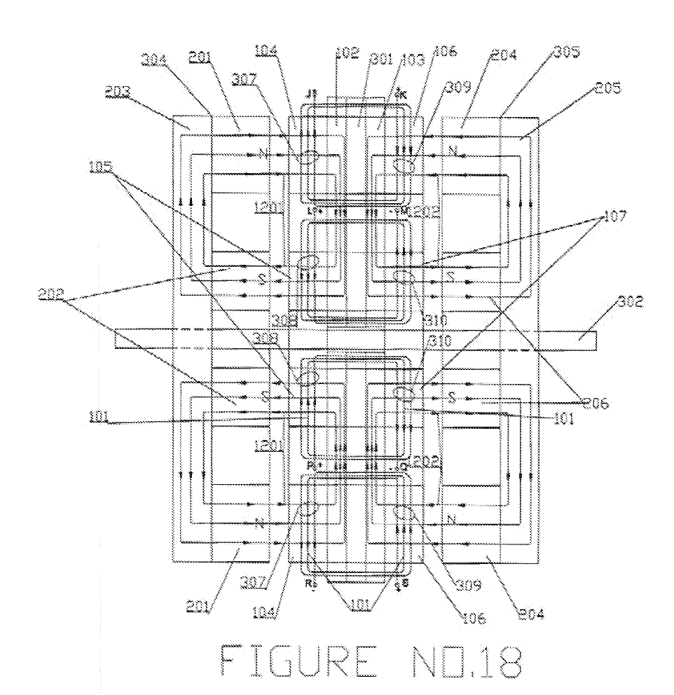

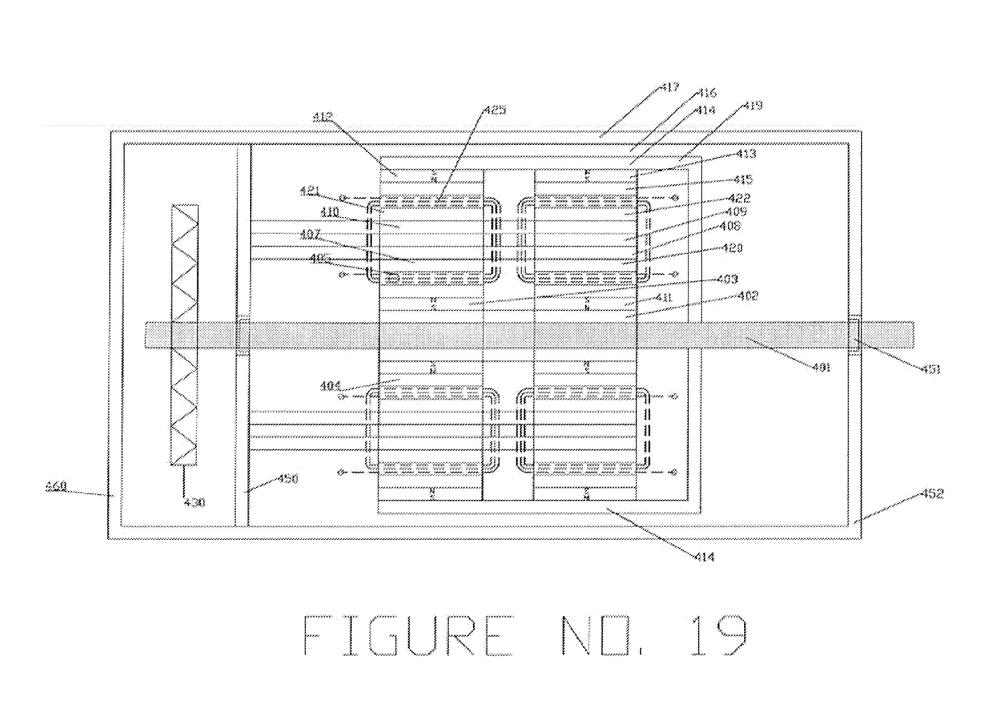

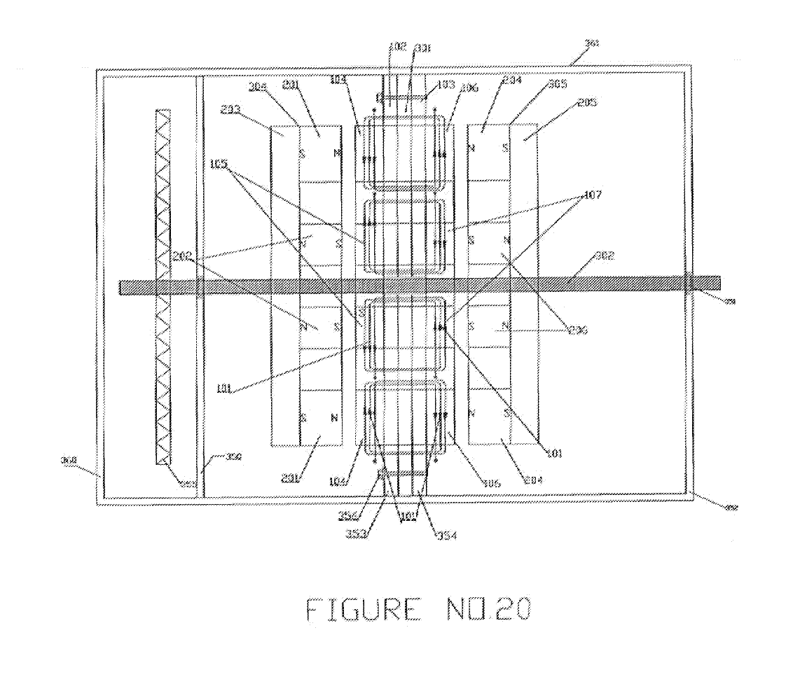

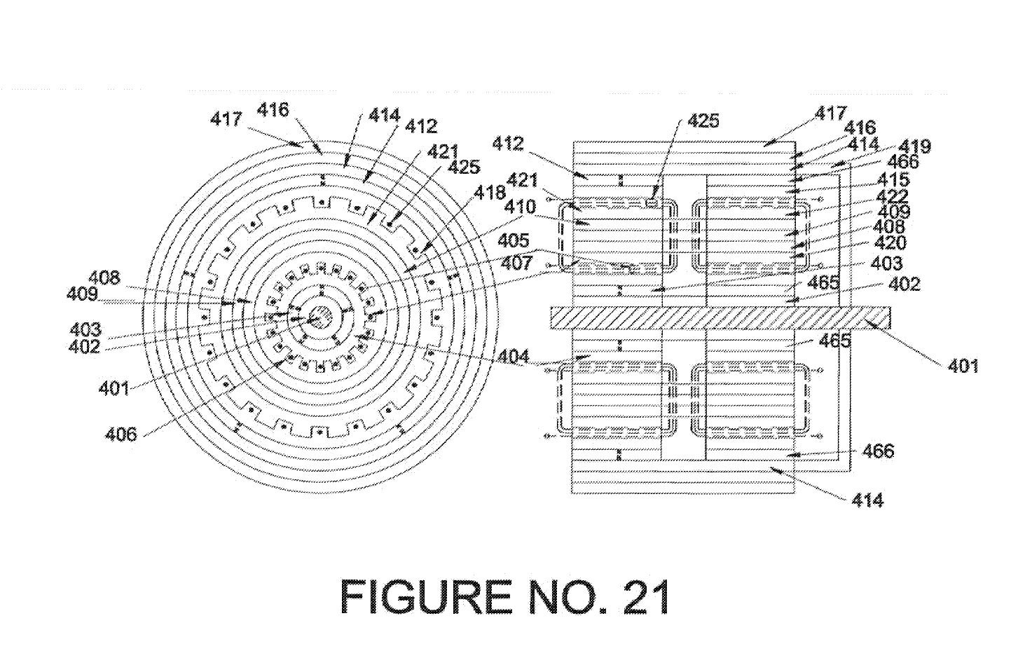

FIGS. 18, 13A, 13B, 13C, 13D, 17A, 17B, 17C, and 17D are used to explain this embodiment. FIG. 18 shows the direction of fluxes produced by field systems and it also shows the direction of currents sent through the armature conductors. FIGS. 13A, 13B, 17A and 17B show direction of forces produced on conductors on armature and hence direction of motion of armature system, under magnetic field system (304 and 305) for rotating armature type axial flux DC motor. FIGS. 13C, 13D, 17C and 17D show the direction of forces produced on magnets on the magnetic field system and hence the direction of motion of the magnetic field system (304) and (305), with respect to stationary armature system, for rotating field system type axial flux DC motor.

The coils of the armature windings are energized by applying DC voltage across the armature terminals A1 and A2. An appropriate value of the DC voltage is also applied across the field winding terminals of the magnetic field systems (304) and (305) in case of electromagnetic field system with polarity of voltage such that direction of flux lines and path of flux is as shown in FIG. 18. One of the directions (polarity) of DC voltage applied across armature terminals A1 and A2 is such that polarities of potential differences created across four coils shown in FIG. 18 are as follows: terminal K is positive w.r.t. terminal J, terminal S is positive w.r.t. terminal R, terminal L is positive w.r.t. terminal M and terminal P is positive w.r.t. terminal Q. This results into the direction of currents flowing through conductors in coil sides (307), (308), (309) and (310) as indicated by arrows on conductors.

FIG. 13B depicts direction of currents in conductors and direction of forces on conductors in the coil sides (307, 308) on the armature cores (104, 105) placed under the magnetic field system (304) as seen from end cap (350) for rotating armature type axial flux DC motor. Single conductor is shown in each coil side for simplicity. The current direction in conductor is shown by arrow on it.

FIG. 13A depicts 2 conductors of which one of the conductor from the coil side (307) (only one conductor is shown for simplicity) while another conductor from the coil side (308) are shown. The coil side (307) and conductors in it are facing north pole of the magnetic field system (304) continuously while coil side (308) and conductors in it are facing south pole of the magnetic field system (304) continuously. Current in conductor in coil side (307) placed in armature core (104) is coming up to the observer as shown by dot marked on conductor in FIG. 13A seen from peripheral top view of armatures (104). So the conductor (307) while carrying current creates a circular self-magnetic flux which is in anticlockwise direction. So self-flux created by current in the said conductor which is in the form of circular lines in the anticlockwise direction around the said conductor. Similarly current in conductor in the coil side (308) is going away from the observer as shown by cross marked on conductor in the coil side (308) in FIG. 13A seen from top peripheral view of armature core (105). So the said conductor while carrying current creates circular self-flux which is in clockwise direction. The direction of flux from north pole and south pole of the magnetic field system (304) is shown by arrows on flux lines.

Due to interaction of magnetic flux from the field system (304) and self-flux of conductor (307), the total flux on right hand side of the conductor in coil side (307) increases while on left hand side it decreases as seen from end cap (350). This imbalance of flux or differential flux on the said conductor (307) leads to the development of force, which causes the conductor (307)) to move to its left (seen from end cap 350) thereby resulting in the rotation of armature fitted on the shaft in anticlockwise direction as seen from end cap (350) as shown in FIG. 13B. This aforementioned situation will occur only if the magnetic field system is stationary while the conductors and the armature are fitted on the rotatable shaft.

The direction of force on conductor placed in magnetic field is given by Fleming's left hand rule. Since armature system and conductors are stationary and said magnetic field system is free to rotate, the said force acts in right hand direction on magnet (201) and hence on magnetic field system (304) shown in upper part of FIG. 13C, which is opposite to the direction of rotation of armature shown in FIG. 13B, thereby causing the rotation of the magnetic field system (304) as seen from end cap (350), in clockwise direction with respect to stationary conductor in coil side (307) of stationary armature (104) as shown in FIG. 13D

Similarly flux from the magnetic field system (304) has direction such that total flux on right hand side of conductor in coil side (308) increases while on left hand side the total flux decreases, as seen from end cap (350). This imbalance of flux or differential flux on two sides of said conductor leads to the development of force on conductor which causes the conductor in coil side (308) to move to left hand side direction (seen from end cap 350) in FIG. 13A, thereby resulting in the rotation of armature (105) in anticlockwise direction as seen from end cap (350) and shown in FIG. 13B on conductors. The direction of currents in conductors in coil sides is shown by arrows on coil sides while the direction of forces on conductors in coil sides (307) and (308) which are also shown in FIG. 13B as seen from end cap 352 (FIG. 20). This aforementioned situation will occur only if the magnetic field system is stationary while the conductors and the armature are fitted on the rotatable shaft. The direction of force on conductor placed in magnetic field is given by Fleming's left hand rule. Since the armature (105) and the conductors in coil side (308) are stationary while the magnetic field system (304) is free to rotate, the said force acts on magnet (202) hence on magnetic field system (304). The said force acts in opposite direction i.e. in right hand direction as shown in lower part of FIG. 13C (seen from end cap 350), thereby causing the rotation of the magnetic field system (304) in clockwise direction with respect to the conductors in coil sides (308) of stationary armature (105) as shown in FIG. 13D as seen from end cap (350). The outer ring magnet (201) and inner ring magnets (202) are fitted on same magnetic yoke (203). So forces produced on both outer and inner ring magnets are additive and act in clockwise direction resulting into clockwise direction of rotation of magnetic field system (304).

In FIG. 17A, one of the conductors (for simplicity) from coil side (309) and one of the conductors from coil side (310) are shown. The coil side (309) and conductors in it are facing north pole of magnet (204) of the magnetic field system (305) continuously while the coil side (310) and conductors in it are facing south pole of magnet (206) of the magnetic field system (305) continuously.

The current in the conductor in the coil side (309) placed in the armature core (106) is going away from the observer as shown by cross marked on conductor in FIG. 17A, seen from peripheral top view of armature (106). The said conductor while carrying current creates circular self-flux lines which are in clockwise direction. Similarly current in conductor in the coil side (310) placed in the armature core (107) is coming towards observer as shown by dot marked on said conductor in the coil side (310) in FIG. 17A. The self-flux produced by current in the said conductor in the coil side (310) is in the form of circular lines which is in anti-clockwise direction around the conductor. The direction of the flux from north pole and south pole of the magnetic field system (305) is shown by arrows on flux lines. The total flux on the right hand side of conductor in the coil side (309) increases while on left hand side the total flux decreases as seen from end cap (350). This imbalance of flux or differential flux on two sides of the conductors in the coil side (309) leads to the development of force on conductor which causes the said conductor to move to its left as shown in FIG. 17A, thereby resulting in the rotation of the armature core (106) in anti-clock wise direction as seen from the end cap (350) (and in clockwise direction as seen from side of end cap (352) and shown in FIG. 17B). This aforementioned situation will occur only if the magnetic field system is stationary while the conductors and the armature are fitted on the rotatable shaft. The direction of force on conductor placed in magnetic field is given by Fleming's left hand rule.

Since the armature core (106) and the conductors in coil sides (309) are stationary while the magnetic field system (305) is free to rotate the said force acts on magnet (204) and on the magnetic field system (305). The said force acts in opposite direction i.e. in right hand side direction shown in upper part of FIG. 17C thereby causing rotation of magnetic field system (305) in clock wise direction as seen from end cap (350), as shown in FIG. 17D.

Similarly flux from south pole of the magnetic field system (305) has direction such that total flux on right hand side of conductor in the coil side (310) increases while on left hand side said the total flux decreases. This imbalance of flux or differential flux on two sides of the conductor leads into development of force on conductor in coil side (310) which causes the said conductor to move to its left hand side direction (seen from end cap (350) in FIG. 17A, resulting in the rotation of armature in anticlockwise direction (as seen from end cap (350)). Seen from the end cap (352), the direction of force (F) on the conductors in the coil side (310) is on the right hand side, causing rotation of the said conductors and armature (107) in clock wise direction as shown in FIG. 17B.)

The direction of currents in conductors in the coil sides is shown by arrows on coil side and direction of forces on conductors in the coil sides (309, 310) are also shown in FIG. 17B as seen from the end cap (352) (shown in FIG. 20). The direction of force on conductor placed in the magnetic field is given by Fleming's left hand rule. Since the armature system and hence armature (107) and conductors in coil side (310) are stationary while magnetic system (305) is free to rotate. The said force acts in opposite direction means in right hand side direction (as seen from end cap (350) shown in lower part of FIG. 17C and thereby causing rotation of the magnetic field system (305) in clockwise direction with respect to conductor in said coil sides of stationary armature core (107) as shown in FIG. 17D. The outer ring magnet (204) and inner ring magnets (206) are fitted on same magnetic yoke (205) and forces produced on both outer and inner ring magnets are additive and in clockwise direction resulting into clockwise direction of rotation of the magnetic field system (305).

The magnetic field systems (304), 305) rotate in clock wise direction with respect to stationary armature system as seen from end cap (350) (shown in FIG. 20).

Embodiment for Axial Flux Machine in which Each Magnetic Field System Single Flat Ring Magnet is Made of Multiple Pieces of Small Permanent Magnets:

With reference to FIG. 30 in the magnetic field system (304) one set of multiple pieces of small permanent magnets forms outer flat ring shaped magnet (201). Each piece of magnet has two arc shaped surfaces i.e. outer arc and inner arc shaped surface. The radius of the outer arc and inner arc surface is respectively equal to the outer and inner radius of magnet (201) which is shown in FIG. 2. The two opposite flat surfaces of each said piece of magnet which are parallel to each other, are magnetically polarized, in a manner that one surface becomes north pole while another surface becomes south pole. These multiple pieces of magnets are fixed on the flat surface of the yoke (203) in such way that a flat ring shaped magnet (201) is formed. The flat surfaces of these magnets bearing south pole touch the yoke (203). The other said flat surfaces of these multiple magnets which bear north pole are facing armature core (104) and align with it. There is air gap between magnet and armature.

Similarly another set of multiple pieces of small permanent magnets form inner flat ring shaped magnet (202) as shown in FIG. 30. The flat surfaces of these multiple piece magnets bearing north pole touch the said yoke (203). The other flat surfaces of these multiple magnet which bear south poles are facing the armature core (105) and align with it.

The construction of the magnetic field system (305) is identical to the aforementioned field system (304). In the magnetic field system (305) outer flat ring shaped permanent magnet (204) and inner flat ring shaped magnet (206) are formed from small pieces of magnet in similar fashion as magnets (201) and (202) are formed in the field system (304).

Embodiment for Axial Flux Type DC Machine in which Magnetic Field System is Electromagnetic Field System:

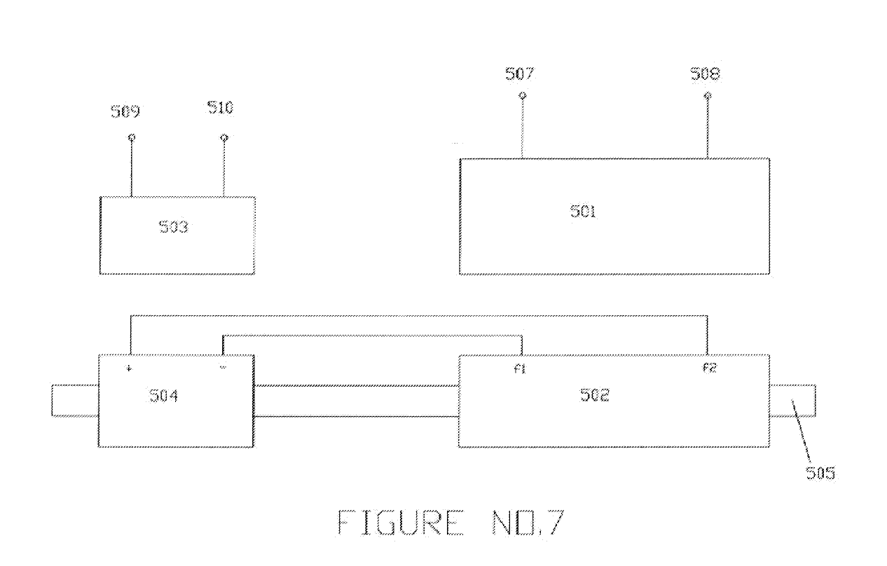

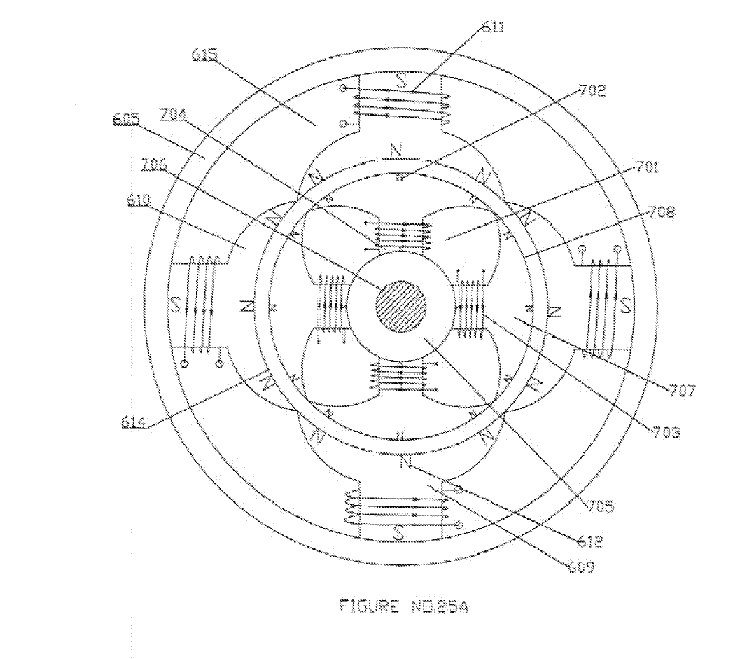

FIGS. 8A(1), 8A(2), 8(B) show the detailed construction while FIG. 23 shows the assembly of electromagnetic field systems with armature system.

Electromagnetic field axial flux type DC machine comprises of two electromagnetic field systems (812, 816). On the one side of shaft (807) there is yoke (806) which carries four outer field magnets (809) and four inner field magnets (810) forming electromagnetic field system (812). On the other side of shaft there is another yoke (813) which also carries four outer field magnets (814) and four inner field magnets (815) forming another electromagnetic field system (816). The armature system construction is similar to the axial flux DC machine explained in earlier embodiments.

The rotary shaft (807) is rotatably fixed with end caps (350, 352) by means (351) which are attached to the machine body (361) (not shown). The rotary shaft (807) fixedly carries the yoke (806), which is shaped as a thick flat circular disc and made of laminated layers of magnetic substance. The multiple field magnets (809) are fixedly supported to the yoke (806) on flat circular surface of yoke near outer peripheral portion as shown in FIG. 8A(1). FIG. 8A(2) is a view of electromagnetic field systems (812) and (816) taken from the armature system between two field systems which shows cores of four field magnet as shown by dotted circles. The cross sectional area of pole face (808) of each field magnet (809) are arranged to touch each other in a manner that the total surface area and shape of the said pole face is of flat ring.

Field coils or pole coils (804) comprise of insulated conducting wire or strip. The turns are of a certain dimension and are formed by wounding it on a former. Once the coils are formed then the former is removed and wound coil is put into place over pole core. The field magnet comprises of pole core (805) and pole shoe (803). The pole shoe (803) being larger than the pole core (805) serve two purposes, it spreads out magnetic flux in air gap, reduces reluctance of magnetic path. It also supports field coil (804). The said pole core and the pole shoe are made of multiple thin laminations of magnetic substance. There are multiple laminations which are stacked together or bolted together (not shown) to get required thickness of pole core and pole shoe. The DC current is passed through the field coils (804) in such a direction that all outer field magnets (809) produce magnetic flux having same direction. In illustrative embodiment all pole faces (808) of the pole shoes (803), form ring shaped magnetic pole which emanates flux in axial direction with its north pole (N) facing the armature core (104) and align with it on the armature system. There is an air gap between pole face (808) and armature core (104).

Multiple inner field magnets (810) with pole faces (802) are positioned in identical manner as the outer field magnet (809) on inner side of same surface of yoke (806) to form inner single flat ring shaped pole (FIG. 8A(1)). In illustrated embodiment there are four inner field magnets as shown in FIG. 8A(2). The field coil (811) has same construction as that of field coil (804) and is placed on the pole core of the field magnet (810). The DC current is passed through the field coils (811) in such a direction that all inner field magnets (810) produce magnetic flux having same direction. In illustrative embodiment all pole shoes of (810), forms ring shaped magnetic pole which produces flux in axial direction with its south (S) pole facing towards the armature core (105) and align with it on the armature system. There is air gap between pole face (802) and armature core (105).

The position of pole cores (805) of inner field magnets (810) is fixedly mounted on the yoke (806). The said position of the ring shaped south pole is such that it aligns with the ring shaped face of armature core (105).

FIG. 8B shows that the electromagnetic field system (816) which has identical construction to that of (812) and both are fixedly fitted on the shaft (807) in such a way that flat ring shaped north (N) and south (S) pole of field system (816) respectively facing towards armatures cores (106) and (107). FIG. 23 shows electromagnetic field system (816) is the mirror image of magnetic field system (812) about vertical central plane drawn in non-magnetic flat disc (301) except the direction of currents in the field coils (804, 811). The directions of currents in the field coils (804, 811) of electromagnets (814, 815) are suitable to produce aforementioned polarity in electromagnets (814, 815).

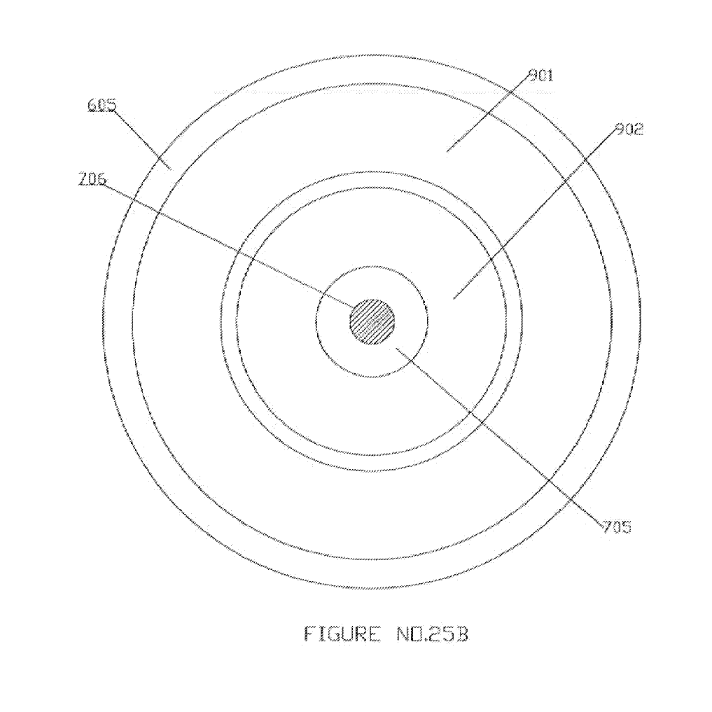

The field coils on all field magnets on the magnetic field systems (812 and 816) are either connected in series or parallel with each other such that current directions shown on field coils are maintained (shown in FIG. 23), forming field winding 1 and winding 2 respectively. Field winding 1 and field winding 2 may be connected in series or parallel forming total field winding (not shown). The total field winding (not shown) is connected to DC supply through slip rings and brushes. The slip ring and brush arrangement may be similar to that of the rotating armature type axial flux machine (FIG. 24).

Embodiment for Axial Flux DC Machine Having Electromagnetic Field System Each Field System with Single Magnet:

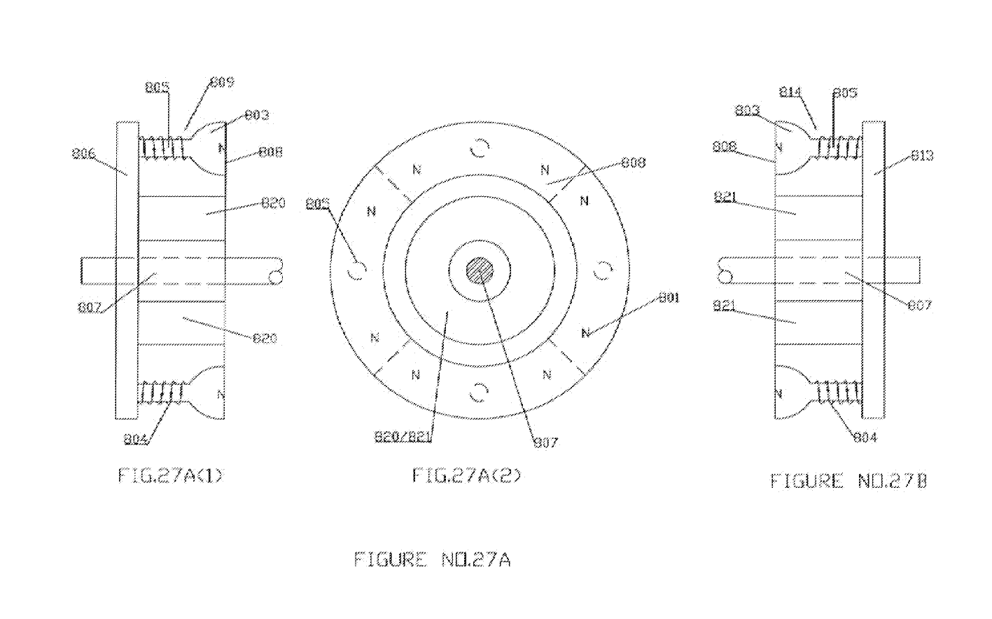

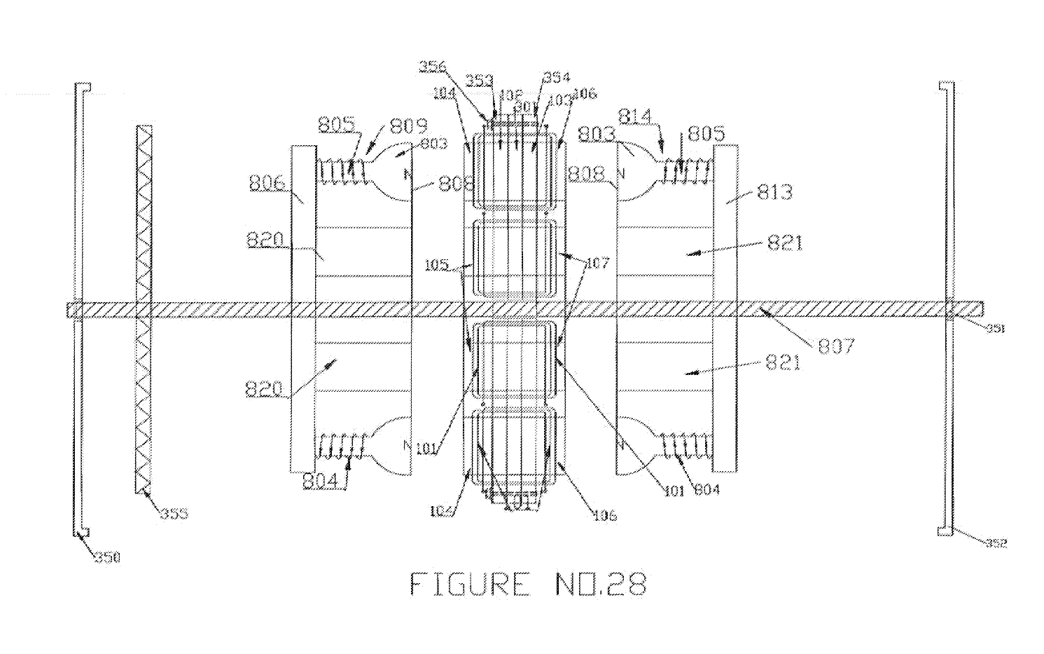

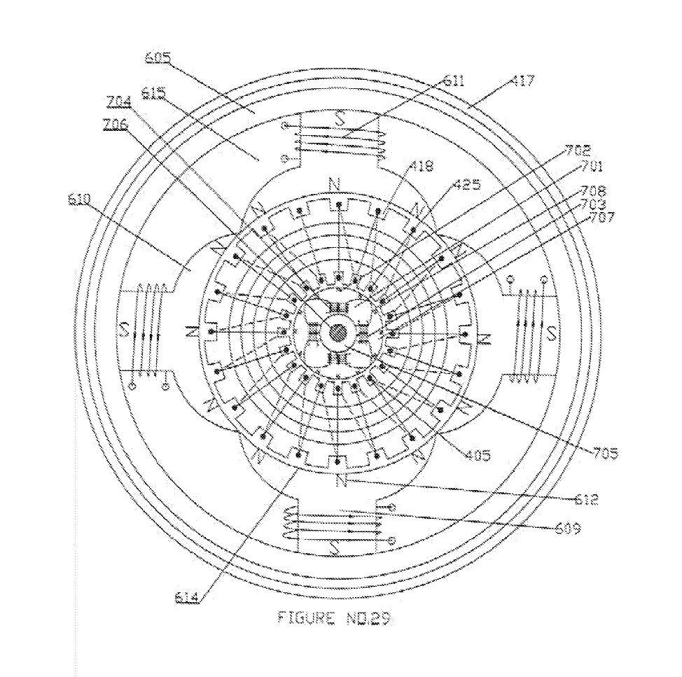

FIGS. 27A(1), 27A(2) and 27B depicts yet another embodiment of the present invention where the axial flux DC machine has electromagnetic field system having single set of electromagnets instead two sets of electromagnets. The second set of electromagnets is replaced by a yoke. FIG. 28 shows assembly of above mentioned electromagnetic field system with the armature system.

FIG. 27A(1) shows the electromagnetic field system (812) in which the set of inner electromagnets (810) is replaced by the flat ring-shaped yoke (820), which is made of layers of magnetic substance. It is fixed on the yoke (806) in a manner that one of the flat ring shaped surface is in touch with the yoke (806). The outer diameter and inner diameter of yoke (820) is equal to the outer diameter and inner diameter of flat ring shaped pole face (802) formed by pole faces of electromagnets (810) as shown in FIG. 8A(2). Another flat ring shaped surface of the yoke (820) faces the flat ring shaped surface of armature (105) and aligns with it. FIG. 27A (2) is a view of the field system (812) taken from side of the armature system.

Similarly FIG. 27B shows the electromagnetic field system (816) mentioned in above embodiment with set of inner electromagnets (815) replaced by yoke (821). The view of field system (816)) as seen from the armature system is identical to FIG. 27A (2) if yoke (820) is replaced by yoke (821).

### Embodiment for Two Shafts Axial Flux DC Machine Working as DC Motor:

FIG. 5 shows the construction of two shafts axial flux DC machine, which is also known as two speed axial flux DC machine. While operating as DC motor its working principle is identical to single shaft axial flux DC motor, but differs in construction and operation.

The said axial flux DC machine with two shafts comprises of two mechanically isolated shafts i.e. (306) and (302). The shafts (306, 302) are rotatably fixed on supports (388 and 389). The said supports (388, 389) are fixedly fitted with body of machine (361) (not shown). The magnetic field systems (304, 305)) are fitted on the shaft (306, 302), respectively. Both shafts rotate in same direction. In order to make two separate mechanical powers available at the shafts, the values of magnetic flux and flux densities produced by magnetic field systems (304, 305) are kept at different values.

The speed N1 with which magnetic field system (304) will rotate and speed at shaft (306) at which mechanical output power is available is given by

N1=k[V1−(Ia×Ra1)]/Φ1=k Eb1/Φ1

Similarly the speed N2 with which magnetic field system (305) will rotate and speed at shaft (302) at which another mechanical output power is available is given by

N2=k[V2−(Ia×Ra2)]/Φ2=k Eb2/Φ2

wherein
Φ1 is flux produced by magnetic field system (304),
Φ2 is flux produced by magnetic field system (305),
Eb1 is sum of back emfs induced in conductors in coil sides on armatures under magnetic field system (304),
Eb2 is sum of back emfs induced in conductors in coil sides on armatures under magnetic field system (305),
V1 is sum of voltage drops across conductors in coil sides on armatures under magnetic field system (304),
V2 is sum of voltage drops across conductors in coil sides on armatures under magnetic field system (305) where supply voltage to armature winding V=V1+V2,
Ra1 is sum of resistances of conductors in coil sides on armatures under magnetic field system (304),
Ra2 is sum of resistances of conductors in coil sides on armatures under magnetic field system 305 and Ia is armature current.

The speeds N1 and N2 at the two shafts can be controlled by controlling magnetic flux values Φ1 and Φ2 respectively. In this way DC motor of the present invention can work as two speed DC motor and can drive two different mechanical loads at two shafts. Armature current Ia and power input to armature system is proportional to sum of mechanical power outputs at the two shafts. The armature current Ia is given by expression:

Ia=[V−(Eb1+Eb2)]/(Ra1+Ra2)

### Embodiment for Two Shafts Axial Flux DC Machine Working as DC Generator:

With reference to FIG. 5 the present embodiment is about two shaft axial flux machine operating as DC generator. Its working principle is same to that of single shaft axial flux DC generator described above, and shown in FIG. 12 but differ in construction and operation. One more way to have two shaft constructions is “shaft in shaft construction”. In case of two shaft axial flux type DC generator the rotary mechanical energy input from one prime mover is supplied to shaft (306) and thereby to magnetic field system (304) for rotation while rotary mechanical energy input from another prime mover is supplied to the shaft (302) and thereby to the magnetic field system (305) for rotation, but the direction of rotation of both the shafts must be same. The resulted DC power output of the DC generator is proportional to the sum of input mechanical powers from the two prime movers. The DC output voltage is kept constant by adjusting speeds of the two prime movers and magnetic flux produced by the magnetic field systems (304) and (305).

Embodiment Showing Axial Flux DC Machine with Single Ring Shaped Magnet for Each Field System:

FIG. 22 exhibits axial flux DC machine with single flat ring shaped magnet on each field systems. Its construction is similar to the axial flux machine explained in embodiment 1 which is shown in FIGS. 1, 2 and 3. The difference here lies in the replacement of one permanent magnet with yoke. So instead of two magnets, only one magnet is used.

In the magnetic field system (304), the magnet (202) in FIGS. 2 and 3 is replaced by yoke (265). The yoke (265) is having flat ring shape and dimensions equal to that of magnet (202) and is fixedly fitted on yoke (203). The position of yoke (265) on yoke (203) is same as that of initially fitted magnet (202). The said yoke (265) is also made of layers of laminated magnetic substance. The yoke (265) aligns with flat cylindrical ring shaped face of armature (105). There is an adequate air gap between face of yoke (265) and face of armature (105).

Another magnetic field system (305) has identical construction as that of field system (304). The yoke (266) is fixedly fitted and positioned on yoke (205) where magnet (206) is mounted initially, shown in FIGS. 2 and 3. The outer flat ring shaped face of the yoke (266) is facing the armature core (107) and is aligned with it.

Embodiment Pertaining to Axial Flux DC Machine with Rotating Armature Systems:

FIG. 24 depicts axial flux DC machine with rotating armature system and stationary magnetic field system.

The rotary shaft (302) is rotatably supported by supporting means (351) on end caps (350 and 352). The end caps are fixed to the machine body (361). The machine body is generally cylindrical to enclose substantial portions of the machine which is fixed to the base (not shown). The armature system has construction identical to that described under embodiment 1, with some exception. The armature system comprises of a member which is combination of a pair of yokes (102, 103), non-magnetic core (301) or yoke 117 which is rotatable armatures cores (104, 105, 106, 107), armature winding and flat disc (301). The said armature system is not fixed with the machine body but is fixedly fitted on shaft (302) and is free to rotate with rotary shaft (302).

The magnetic field system (304) has identical construction as mentioned under embodiment 1, except that its yoke (203) has a hole (370) at the center for passing of shaft (302) through it. The yoke's peripheral cylindrical surface is fixedly fitted with the body (361) of DC machine. In the longitudinal direction of the shaft (302) on other side of the armature system, the shaft (302) passes through a hole (371) in yoke (205) of the magnetic field system (305). The magnetic field system (305) has identical construction to the field system (304) mentioned above. The slip rings (390, 391) are fixedly fitted on the shaft (302) and are free to rotate with the said shaft. There is electrical insulation between the slip ring and the shaft. The connections of armature winding (described elsewhere) terminals A1 and A2 on rotating armature system are taken out through the slip rings (390, 391) and brushes (393, 394), which is an arrangement for supplying DC power in case of DC motor, or getting DC voltage output in case of DC generator.

Embodiment Showing Armature System with Single Yoke for Axial Flux DC Machine:

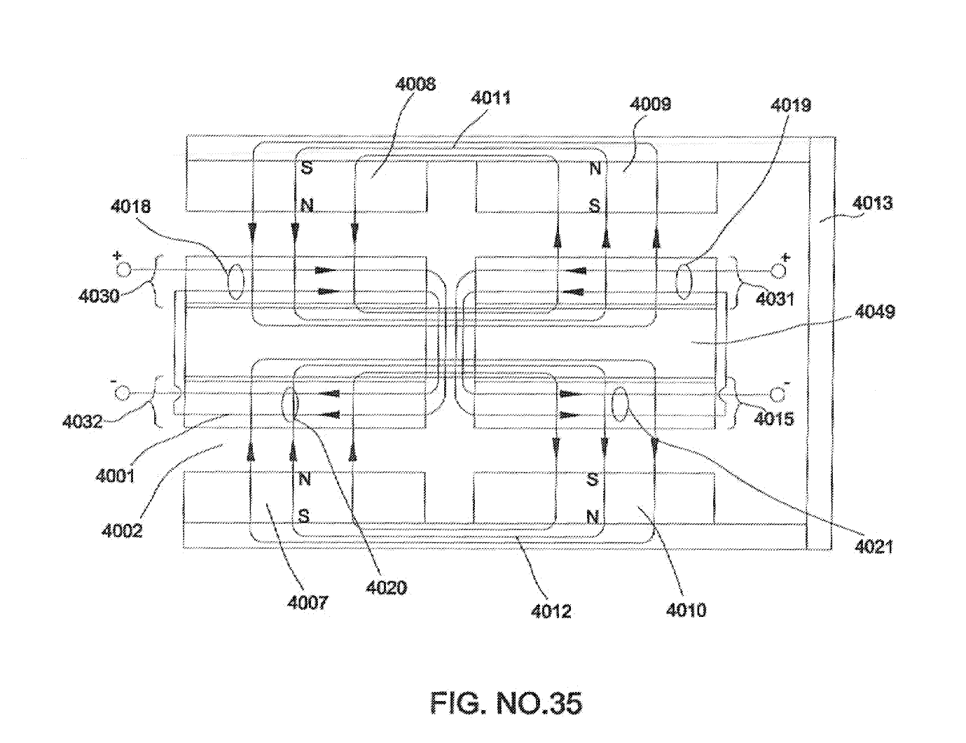

The armature system with single yoke is depicted in FIG. 36 and FIG. 34. Here instead of member having pairs of yoke (102, 103) and non-magnetic core (301), the said member has only single yoke (117). FIG. 36 shows yoke (117) which is fixed with motor body (not shown) through extended portion (133) for the rotating field type axial flux DC machine. For the rotating armature type axial flux DC machine armature system is not fixed with the body but the said yoke (117) is fitted on shaft (302) in place of core (301) and yokes (102,103) as shown in FIG. 24. FIG. 34 shows assembly of armature system with magnetic field systems.

The flat disc (301) is made of non-magnetic substance mentioned above, under embodiments of the axial flux DC motor and DC generator (except two shaft operation of axial flux DC machine) is not essential. Then on magnetic core (301) may be absent and in that case said yokes (102, 103) are combined into single yoke (117) as shown in FIG. 34 and FIG. 36. The yoke (117) has construction similar to the yoke (102) or yoke (103). The said armature core (104) is fixed on the flat ring shaped surface of the outer ring of the yoke (117) facing north pole of the said magnet (201) while said armature core (105) is fixed on flat ring shaped surface of inner ring of the yoke (117) facing south pole of said magnet (202). Said armature cores (106, 107) are fixed on the other flat side of yoke (117) such that the armature core (106) is fixed on the flat ring shaped surface of the outer ring of the yoke (117) facing north pole of said magnet (204) while the armature core (106) is fixed on flat ring shaped surface of inner ring of yoke (117) facing south pole of said magnet (206). Remaining construction of armature system is similar to that described in earlier embodiments for axial flux DC machine.

I claim:

1. Commutatorless, brushless DC machine with stationary armature, said DC machine being deployed in DC machine body, said DC machine comprising of magnetic flux producing system and armature system with an air gap between them, in an arrangement that is radial, axial or linear arrangement
each said arrangement having at least one closed loop flux transport means,
said magnetic flux producing system having at least one magnetic field system preferably a pair of movable or rotatable magnetic field systems, magnetic field system 1 and magnetic field system 2, each said magnetic field system having at least one magnet,
said armature system comprising of
at least 1 stationary member for transporting magnetic flux and having at least 2 surfaces, each said surface having at least one armature core having multiple slots, each said slot housing a group of insulated conductor,
armature winding comprising of at least one winding (1, 2 . . . n), each said winding comprises of multiple groups of coil, each said group of coils comprises of multiple coils, each said coil being formed by serially connecting said insulated conductors alternating between said conductors on each of the armature cores being fixed on opposite surfaces i.e. surface 1 and surface 2, each said coil so formed having at least 2 coil side, each coil side corresponding to each said armature core,
wherein, the armature system is so deployed with in the magnetic flux producing system which is movable or rotatable that the said surface 1 of the stationary member faces magnetic field system 1 while the said surface 2 of the stationary member faces magnetic field system 2, in a manner that the coil side on armature core of said surface 1 faces pole of magnet under magnetic field system 1 while the corresponding coil side on armature core of said surface 2 faces pole of magnet under magnetic field system 2, such that the poles of the magnets facing the coil sides are of same polarity.

2. Commutatorless, brushless DC machine with stationary armature as claimed in claim 1, wherein said radial arrangement comprising of
said magnetic flux producing system which is permanent or electromagnetic field system comprising of
at least one rotatable shaft (400),
at least two magnetic field system, inner and outer magnetic field system, wherein the inner magnetic field system is enclosed by the outer magnetic field system,
said inner magnetic field system comprises of cylindrical pipe shaped yoke (402) coaxially fitted on said rotatable shaft, outer periphery of the said cylindrical pipe shaped yoke (402) having at least one cylindrical pipe magnet (403, 411), said cylindrical pipe shape magnet (403, 411) being magnetized in radial direction,
said outer magnetic field system comprises of cylindrical pipe shape yoke (414) encompassing the cylindrical yoke of the inner magnetic field system (402) and is disposed toward machine body, inner periphery of said cylindrical yoke (414) having at least one cylindrical pipe shaped magnet (412, 413), said cylindrical pipe shape magnet (412, 413) being magnetized in radial direction, said cylindrical yoke (414) being anchored to said shaft by anchoring means (419),
said armature system comprising of
at least one cylindrical shaped stationary member (408, 409, 410/444) for transporting magnetic flux, having at least two surfaces i.e. inner and outer periphery, each of which has at least one armature core (407, 420 and 421, 422), each said armature core being made of laminated magnetic substance, having multiple slots running in axial direction, each said slot housing a group of insulated conductor,
armature winding which comprises of at least 1 winding (1, 2 . . . n), each said winding comprises of multiple groups of coils, each said multiple group comprises of multiple coils, each said coil is formed by serially connecting said insulated conductors alternating between said conductor on each armature core being fixed on inner and outer periphery of stationary cylindrical member,
wherein, said armature system is so deployed within said rotatable magnetic flux producing system that the said inner periphery of the said stationary member (408, 409, 410/444) faces the inner magnetic field system while the said outer periphery of said stationary member faces the outer magnetic field system, in a manner that the said coil side on armature core of said inner periphery faces a pole of magnet under inner magnetic field system while the corresponding coil side on armature core of said outer periphery faces pole of magnet under outer magnetic field system, such that the said poles of the magnets facing the said coil sides are of same polarity,
said magnetic flux generated from each said magnetic field system being transported in a closed loop flux transport means through a magnetic path present in each magnetic field system, said magnetic path comprising magnet (403/412), air gap (404/415), armature core (407/421) and conductors therein, the stationary member (408/410 or 444/444), armature core (420/422) and conductors therein, air gap (404/415), magnet (411/113), cylindrical yoke (402/414), magnet (403/412) in that order.

3. Commutatorless and brushless DC machine with stationary armature as claimed in claim 2, wherein said cylindrical pipe shape magnets (403, 411) forming said inner magnetic field system, are placed side by side on outer periphery of said inner cylinder with an air gap between them facing armature cores (407, 420), while said cylindrical pipe shaped magnets (412, 413) forming outer magnetic fields system are placed side by side on the inner periphery of said outer cylinder with an air gap between them facing armature cores (421, 422) respectively, said pairs of being magnetized in a manner that magnets in each pair bear opposite polarity.

4. Commutatorless and brushless DC machine with stationary armature as claimed in claim 3, wherein said cylindrical pipe shaped magnet (412) of the outer magnetic field system having its inner pole as north pole is placed on same side of the shaft length on which the said cylindrical pipe shape magnet (403) of inner magnetic field having its outer pole as north pole is fitted, while the said cylindrical pipe shape magnet (413) of outer magnetic field having its inner pole as south pole and said cylindrical pipe shaped magnet (411) of the said inner magnetic field with its south pole as outer pole both are placed on the other side of shaft length.

5. Commutatorless and brushless DC machine with stationary armature as claimed in claim 4, wherein inner magnetic field system comprises single cylindrical pipe shaped magnet (403) and one cylindrical yoke (465) while outer magnetic field system comprises of single cylindrical pipe shape magnet (412) and one cylindrical yoke (466), the said cylindrical yokes (465, 466) in inner and outer magnetic field facilitates the formation of closed flux transport means made of magnetic substance so placed as to facilitates the formation of closed loop flux transport means, said cylindrical pipe shaped yokes (465, 466) in the inner and outer magnetic flux system is positioned on the yokes (402, 414) respectively in the manner that like poles of said magnets (403, 412) facing armature core are placed on same side of shaft length while said positioned yokes (465, 466) are placed on the other side of shaft length.

6. Commutatorless and brushless DC machine with stationary armature as claimed in claim 2, wherein said armature cores (421, 422) are aligned with magnets (412, 413) while said armature cores (407, 420) are aligned with magnets (403, 411).

7. Commutatorless and brushless DC machine with stationary armature as claimed in claim 2, wherein cylindrical shaped stationary member is selected from stationary member (408, 409, 410) made of magnetic substance having nonmagnetic core or stationary member made of only magnetic substance (444).

8. Commutatorless and brushless DC machine with stationary armature as claimed in claim 7, wherein stationary member which is made of magnetic substance having non-magnetic core, comprises a pair of cylindrical magnetic yoke (408, 410) with nonmagnetic core (409) between them, such that one surface of each magnetic yoke touches the nonmagnetic core (409), while the opposite surfaces of said yokes (408, 410) have at least one armature core (407, 420) and (421, 422) respectively.

9. Commutatorless and brushless DC machine with stationary armature as claimed in claim 7, wherein stationary member made of magnetic substance comprises of at least one cylindrical yoke (444) with two opposite surfaces inner and outer periphery having at least one armature core (407, 420) and (421, 422) respectively.

10. Commutatorless and brushless DC machine with stationary armature as claimed in claim 2, wherein magnetic flux producing arrangement comprises of the inner and outer magnetic field system each fitted on corresponding shafts (400, 426) and armature system comprising of pair of yokes (408, 410) with nonmagnetic cores (409).

11. Commutatorless and brushless DC machine with stationary armature as claimed in claim 2, wherein magnetic flux producing system is electromagnetic system, each said magnetic field system, inner and outer magnetic field system comprises of at least one set of electromagnet, each said set of electromagnet comprises of multiple field magnets, each said field magnet comprises of pole core, pole shoe with field coils made of insulated conducting wire of suitable material wound on said pole core, and said field coil being connected to DC supply arrangement and said pole shoe being made of laminated layers of magnetic substance, which are stacked together, such that said field magnets of said inner magnetic field system are fixed to the outer periphery of inner cylindrical yoke of inner magnetic field system through said pole core and said field magnets of said outer magnetic field system being fixed to the inner periphery of outer cylindrical yoke of said outer magnetic field system through their said pole cores, the cross sectional area of said pole faces of each field magnet are arranged to touch each other in a manner that total combined shape and surface area of pole face being cylindrical shaped electromagnet one each for inner and outer magnetic field system, each said set of electromagnet is magnetized by sending DC current in its said field coils in a manner that all said field magnets produces magnetic flux in same direction

12. Commutatorless, brushless DC machine as claimed in claim 11 wherein DC supply arrangement is selected from brushless arrangement or slip rings and brushes arrangement, and said radial flux DC electromagnetic field machine comprising of stationary armature system (501), electromagnetic field system (502), said electromagnetic field system being fitted on the rotatable shaft (505) having terminals (f1, f2).

13. Commutatorless, brushless DC machine as claimed in claim 12 wherein brushless arrangement comprises of exciter, which is smaller than the said radial flux DC machine, said exciter is selected from exciter having radial/axial flux DC machine with rotating armature or exciter having three phase alternator or exciter having conventional DC machine.

14. Commutatorless, brushless DC machine with stationary armature as claimed in claim 13, wherein the exciter having radial/axial flux DC machine with rotating armature type, said exciter comprises of rotating armature system (504) having two terminals positive (+) and negative (−) and stationary field system (503), said stationary field system (503) comprises of electromagnet or permanent magnet and said rotating armature system is fitted on the rotatable shaft (505) such that said terminal positive (+) and negative (−) are connected to the f1 and f2 terminals of electromagnetic field system (502)

15. Commutatorless, brushless DC machine with stationary armature as claimed in claim 13, wherein said exciter having three phase alternator comprises of rotor (504), having two terminals positive (+) and negative (−), said stationary field system (503) having two terminals such that
said rotor having three phase winding fitted on rotatable shaft (505) and said positive (+) and negative (−) terminals are connected to the f1 and f2 terminals of the electromagnetic field system (502), while the
said terminals of stationary field system are connected to DC supply when said DC machine (501 & 502) works as DC motor, or connected to armature system (501) of the DC machine (501, 502) when said DC machine works as DC generator.

16. Commutatorless, brushless DC machine with stationary armature as claimed in claim 13, wherein said exciter having conventional DC machine comprises of armature system (504) having positive (+) and negative (−) terminals, and stationary field system (503) having two terminals, such that
said armature system (504) is fitted on rotatable shaft (505), and said positive (+) and negative (−) terminals are connected to the f1 and f2 terminals of the electromagnetic field system (502), while
said terminals of stationary field systems are connected to DC supply when said DC machine works as DC motor, or connected to stationary armature (501) of the DC machine (501 502) when said DC machine works as DC generator.

17. Commutatorless, brushless DC machine with stationary armature as claimed in claim 12, wherein slip ring and brushes arrangement,
said slip rings fitted on rotatable shaft are connected to the terminals of said electromagnetic field system of the DC machine while
said brushes which are stationary and are in contact with slip rings are connected to DC supply when said DC machine works as DC motor or connected to armature winding of the stationary armature of the DC machine when said DC machine works as DC generator.

18. Commutatorless and brushless DC machine with stationary armature as claimed in claim 2, wherein magnetic flux producing system is permanent magnetic field system, each said cylindrical pipe shaped magnet (403, 411, 412, 413) is single permanent magnet or a group of small permanent magnets separated by air gaps (488) acting as a single magnet such that in said group of small magnets, each said small magnet has two arcs, inner arc and outer arc being magnetized in a manner that all said small magnets have same magnetic polarity.

19. Commutatorless and brushless DC machine with stationary armature as claimed in claim 2 wherein all coils in the said groups of multiple coils are connected in series in a manner that
north poles facing coil sides on each coil in the said group of multiple coils bears terminals (E,F/A,B/E′,F′/A′,B′ . . . n) such that terminals E, B, E′, B′ are on coil sides present on the slots of the inner armature core while the corresponding terminals F, A, F′, A′ are on the adjacent coil sides present on the slots of the outer armature core, such terminals being so connected that terminal E is connected A, B is connected to F′, E′ connected to A′ and so on till all the coils are connected to form serially connected group of multiple coils and
south poles facing coil sides on each coil in the said group of multiple coils bears terminals (G, H/D,C/G′,H′/D′,C′ . . . n) such that the terminals (G, D, G′, D′) are on coil sides present on the slots of the inner armature core while the corresponding terminals (H, C, H′, C′) are on the adjacent coil sides present on the slots of the outer armature core, such terminals being so connected that terminal G is connected to C, D is connected to H′, G′ connected to C′ and so on till all the coils are connected to form serially connected group of multiple coils,
each said serially connected group of multiple coils having two end terminals, inner end terminal and outer end terminal.

20. Commutatorless and brushless DC machine with stationary armature as claimed in claim 19, wherein
said serially connected group of multiple coils facing the north poles of inner and outer magnetic field system are connected together either in series or in parallel to form winding 1 and
said serially connected group of multiple coils facing south poles of inner and outer magnetic field systems are connected together either in series or in parallel to form winding 2.

21. Commutatorless and brushless DC machine with stationary armature as claimed in claim 20, wherein said winding 1 and winding 2 are formed by connecting said inner end terminal of first group of multiple coils on the inner armature core is connected to the outer end terminals of second group of multiple coils, which is on the outer armature core, said inner end terminal of second group of multiple coils is connected to said outer terminal of third group of multiple coils and so on till all the groups are connected to form winding (1, 2).

22. Commutatorless and brushless DC machine with stationary armature as claimed in claim 2, wherein each said group of multiple coils has two terminals inner and outer end terminals in corresponding inner and outer armature core which are connected in parallel to form windings (1, 2) in a manner that inner end terminals of all groups of multiple coils in inner armature core are connected together while all outer terminal of multiple groups having terminal in the outer armature core are connected together to form said winding (1, 2) and each said group having equal number of coils in series.

23. Commutatorless and brushless DC machine with stationary armature as claimed in claim 20, wherein said winding 1 is connected to winding 2,
in series to form armature winding with terminal A1 and A2 in a manner that one terminal of winding 1 in the inner armature core is connected to the terminal of winding (2) which is in the outer armature core while other terminals of winding (1 and 2) terminal (A1 and A2) of armature winding, or
in parallel to form armature winding with A1 and A2 such that one pair of terminals of winding 1 and winding 2 which are in the inner armature cores are connected together to terminal A and other pair of terminal in other coil sides which are in outer armature cores are connected together to terminal A2.

24. A method for using commutatorless and brushless DC machine with stationary armature as claimed in claim 2 for use as DC motor, said method comprising the steps of:
generation of magnetic field system 1 and magnetic field system 2 by using said magnetic flux producing system,
energization of coils of armature winding of said armature system through current generated by applying DC voltage across armature terminals A1 and A2 of armature winding, thereby inducing self-flux around the conductor and coil sides (405, 425, 432, 429) facing inner magnetic field system and outer magnetic field system of each coil,
interaction of said self-flux around the conductors and coil sides with the magnetic flux generated from inner and outer magnetic field systems thereby generating differential flux around each of the conductors,
generation of force around insulated conductors of armature coils of armature system, as per the Fleming Left hand rule, said armature system being stationary triggering the transmission of force thereby creating a torque on the rotatable inner and outer magnetic field causing the rotation of the said rotatable inner and outer magnetic field in the intended clockwise or anticlockwise direction w.r.t stationary armature system,
monitoring and controlling the speed of DC motor,
by varying the magnitude of DC voltage applied to said armature winding, and/or by varying resistance connected in series with armature winding when magnetic flux producing system is permanent magnetic system or
when magnetic flux producing system is electromagnetic system by varying current in field winding of electromagnets and/or by varying the magnitude of DC voltage applied to said armature winding and/or by varying the resistance connected in series with armature winding.

25. A method for, using commutatorless and brushless DC machine with stationary armature as claimed in claim 2 for use as DC generator, said method comprising steps of:
generation of inner and outer magnetic field system by using magnetic flux producing system,
rotation of inner and outer magnetic field system in same direction using at least 1 rotatable shaft, thereby inducing emf in additive direction in insulated conductors of each coil of armature system, which are alternately under like magnetic poles i.e north or south pole of inner and outer magnetic field system, resulting in production of total additive emf in each said coil, which is sum of emfs of said individual conductors of each said coil, the said induced emf is DC emf since said induced emfs on individual conductors are in same direction throughout the period of rotation.

26. Commutatorless, brushless DC machines with stationary armature as claimed in claim 1, wherein said axial arrangement comprises an arrangement
said rotatable magnetic flux producing system which is permanent magnetic field system or electromagnetic field system comprising
at least 1 rotatable shaft (301),
at least 2 magnetic field system (304, 305),
said magnetic field system (304) comprising of cylindrical flat disc yoke (203), coaxially fitted on said rotatable shaft (302), one flat surface of said magnetic yoke (203) having at least one flat ring magnet (201, 202), said flat ring being magnetized in axial direction,
said magnetic field system (305) comprising of cylindrical flat disc yoke (205) which is fitted on shaft (302) in longitudinal direction of said rotatable shaft, said magnetic field system (305), said yoke (205) having at least one ring magnet (204, 206) on its surface which is toward said flat surface of said yoke (203) having flat ring magnet (201, 202), said flat ring magnet being magnetized in axial direction,
said armature system comprising of
at least one flat disc shaped stationary member (102, 301, 103/117) for transporting magnetic flux, made of two co-planer rings with air gap between them, connected by arms (109) which are made of laminated layers of magnetic substance, said stationary member having hole (108) at the centre and having two opposite surfaces surface 1 and surface 2, each surface having at least 1 armature core (104, 105 and 106, 107) which is ring shaped, each armature core comprises of slots running in radial direction which houses insulated conductors,
armature winding which comprising of at least 1 winding (1, 2 . . . n), each said winding comprises of multiple groups of coils, each said coil being formed by serially connecting said insulated conductors alternating between said conductors on each of the armature core being fixed on the opposite surface of a ring of the said stationary member (102, 301,103/117), each coil is so formed having at least 2 coil side, each coil side corresponding to each armature core,
wherein the armature system is deployed within the magnetic flux producing system with said shaft passing through hole (108) of said yoke in said armature system such that the said surface 1 of the said stationary member (102,301,103/117) faces magnetic field system (304) while the said surface 2 faces magnetic field system (305) a manner that the said coil side on armature core of said surface 1 faces a pole of magnet under magnetic field system (304) while the corresponding coil side on armature core of said surface 2 faces pole of magnet under magnetic field system (305), such that the pole of the magnets facing the said coil sides are of same polarity,
said closed flux transport means for closed flux loop from said ring magnets of said magnetic flux generated from each magnetic field system is transported in a magnetic path that include ring shaped magnet (201/204), air gap, armature core (104/106) and conductors therein, through outer ring made of magnetic substance of stationary member (102, 301, 103/117), arms (109), inner ring made of magnetic substance of stationary member (102, 301, 103/117), armature core (105/107) and conductors therein, air gap, ring magnet (202/206), cylindrical flat disc yoke (203/205) finally ring shaped magnet (201/204).

27. Commutatorless and brushless DC machine with stationary armature as claimed in claim 26, wherein outer surface of each said ring magnet faces armature systems and has one polarity which while inner surface of said ring, which is away from armature system has opposite polarity.

28. Commutatorless and brushless DC machine with stationary armature as claimed in claim 26, wherein the said magnets (201 and 202) and (204 and 206) in each magnetic field system (304 and 305) respectively are of opposite polarity.

29. Commutatorless and brushless DC machine with stationary armature as claimed in claim 28, wherein said magnets (201 and 204) and (202 and 206) are of like polarity and face armature cores (104, 106) and (105, 107) respectively.

30. Commutatorless and brushless DC machine with stationary armature as claimed in claim 29, wherein each of said magnetic system (304/305) comprises one ring magnet and one cylindrical flat ring shaped yoke (265/266) respectively that facilitates formation of closed flux transport means, said magnetic field systems (304/305) being separated by an armature system, said cylindrical flat ring shaped yokes (265/266) and ring magnets in each said magnetic fields (304/305) being so positioned that like poles faces each other.

31. Commutatorless and brushless DC machine as claimed in claim 26, wherein said armature system comprises of flat disc shape stationary member (102, 301, 103/117) is selected from the stationary member made of magnetic substance having nonmagnetic core or stationary member made of only magnetic substance.

32. Commutatorless and brushless DC machine as claimed in claim 26, wherein said stationary member made of magnetic substance having nonmagnetic core is a pair of flat disc yoke (102, 103) made of magnetic substance and nonmagnetic core disc (301) having hole at the center for passing the rotatable shaft, said flat disc yokes and non-magnetic core comprises of at least two coplanar rings with air gap between them, said coplanar ring being connected by arm (109) in said pair of cylindrical disc yoke, said arms of coplanar rings are made of laminated layers of magnetic substance, said non-magnetic core being placed between the pair of cylindrical disc yokes, such that one surface of said cylindrical disc touches the non-magnetic core (301), while the opposite surfaces of said said yokes (102, 103) having at least one ring armature cores (104, 105) and (106, 107) and each said armature core ring covers only coplanar rings leaving the air gap exposed.

33. Commutatorless and brushless DC machine with stationary armature as claimed in claim 26, wherein said stationary member having magnetic material comprising of at least one flat disc shaped magnetic yoke made of two co-planner rings with air gap between them, said coplanar rings being connected by arms (109), which are made of laminated layers of magnetic substance, said magnetic having 2 opposite surfaces, having hole (108) at the centre for passing rotatable shaft, each surface having at least 1 armature core (104, 105 & 106, 107) on said coplanar ring, and each armature core cover only coplanar ring leaving the air gap exposed.

34. Commutatorless and brushless DC machine with stationary armature as claimed in claim 26, wherein magnetic flux producing arrangement comprises of magnetic field systems (304, 305) each fitted on corresponding shafts (306, 302) and armature system comprising of a pair of yokes (102, 103) with nonmagnetic core (301).

35. Commutatorless and brushless DC machine with stationary armature as claimed in claim 26, wherein two magnetic field system (304, 305) are electromagnetic fields systems (812, 816) respectively, each electromagnetic field system comprises of at least one yoke having at least one set of electromagnets, each said set of electromagnets comprises of multiple field magnets, each field magnet comprises of pole core and pole shoe, said pole shoe being larger in dimension as compare to pole core, the pole core and the said pole shoe are made of multiple thin layer of stacked magnetic lamination, the pole core also support field coil which is connected to DC supply arrangement, in each set of electromagnets, the pole faces of said pole shoes of said field magnets being positioned to form a ring shaped magnetic pole, facing respective armature cores, each said set of electromagnet is magnetized by sending DC current in its said field coils in a manner that all said field magnet produces magnetic flux in same direction.

36. Commutatorless, brushless DC machine as claimed in claim 35, wherein DC supply arrangement is selected from brushless arrangement or slip rings and brushes arrangement, and said axial flux DC electromagnetic field machine comprising of stationary armature system (501), said electromagnetic field system (502), said electromagnetic field system being fitted on the rotatable shaft (505) having terminals (f1, f2).

37. Commutatorless, brushless DC machine as claimed in claim 36, wherein brushless arrangement comprises of exciter which is smaller than the said axial flux DC machine, said exciter is selected from exciter having axial/radial flux DC machine with rotating armature or exciter having three phase alternator or exciter having conventional DC machine.

38. Commutatorless, brushless DC machine with stationary armature as claimed in claim 37, wherein the exciter having axial/radial flux DC machine with rotating armature type, said exciter comprises of rotating armature system (504) having two terminals positive (+) and negative (−) and stationary field system (503), said stationary field system (503) comprises of electromagnet or permanent magnet and said rotating armature system is fitted on the rotatable shaft (505) such that said terminal positive (+) and negative (−) are connected to the f1 and f2 terminals of electromagnetic field system (502).

39. Commutatorless, brushless DC machine with stationary armature as claimed in claim 37, wherein said exciter having three phase alternator comprises of rotor (504), having two terminals positive (+) and negative (−) said stationary field system (503) having two terminals such that
said rotor having three phase winding fitted on rotatable shaft (505) and said positive (+) and negative (−) terminals are connected to the f1 and f2 terminals respectively of the electromagnetic field system (502), while the
said terminals of stationary field system are connected to DC supply when said DC machine (501 and 502) works as DC motor, or connected to armature system (501) of the DC machine (501, 502) when said DC machine works as DC generator,

40. Commutatorless, brushless DC machine with stationary armature as claimed in claim 37, wherein said exciter having conventional DC machine comprises of armature system (504) having positive (+) and negative (−) terminals, and stationary field system (503) having two terminals such that
said armature system (504) is fitted on rotatable shaft (505), and said positive (+) and negative (−) terminals are connected to the f1 and f2 terminals of the electromagnetic field system (502), while
said terminals of stationary field systems are connected to DC supply when said DC machine works as DC motor, or connected to stationary armature (501) of the DC machine (501 502) when said DC machine works as DC generator,

41. Commutatorless, brushless DC machine with stationary armature as claimed in claim 36, wherein slip ring and brushes arrangement,
said slip rings fitted on rotatable shaft are connected to the terminals of said electromagnetic field system of the DC machine while
said brushes which are stationary and are in contact with slip rings are connected to DC supply when said DC machine works as DC motor or connected to armature winding of the stationary armature of the DC machine when said DC machine works as DC generator.

42. Commutatorless and brushless DC machine with stationary armature as claimed in claim 26, wherein said ring shape magnets of each magnetic field systems are in alignment with their respective ring shaped armatures of the said armature system.

43. Commutatorless and brushless DC machine with stationary armature as claimed in claim 26 wherein magnetic flux producing system is permanent magnetic field system, each said ring shaped magnet is single permanent magnet or a group of small permanent magnets acting as a single magnet such that in said group of small magnets, each said piece of small magnet has two arcs, inner ring arc and outer ring arc aligned with inner and outer radius of armature core and being magnetized in a manner that all said small magnets have same magnetic polarity.

44. Commutatorless and brushless DC machine with stationary armature as claimed in claim 43 wherein all coils in the said groups of multiple coils are connected in series in a manner that
north-poles facing coil sides on each coil in the said group of multiple coils bears terminals (K, J/S, R/K′, J′/S′R′, . . . n) such that terminals J, R, J′, R′ are on the coil sides present on the slots of the armature core facing magnetic field system (304) while the corresponding terminals K, S, K′, S′ are on the adjacent coil sides on the slots of the corresponding armature core facing magnetic field system (305), such terminals being so connected that terminal J is connected to S, R is connected to K′, J′ connected to S′ and so on till all the coils are connected to form serially connected group of multiple coils,
south-poles facing coil sides on each coil in the said group of multiple coils bears terminals (L,M/P,Q/L′,M′/P′,Q′ . . . n) such that that terminals L, P, L′, P′ are on the coil sides present on the slots of the armature core facing magnetic field system (304) while the corresponding terminals M, Q, M′, Q′ are on the adjacent coil sides on the slots of the corresponding armature core facing magnetic field system (305), such terminals being so connected that terminal M is connected to P, Q is connected to L′, M′ connected to P′, and so on till all the coils are connected to form serially connected group of multiple coils.
each said serially connected group of multiple coils having two end terminals, START terminal and FINISH terminal.

45. Commutatorless brushless DC machine with stationary armature as claimed in claim 44, wherein
said serially connected group of multiple coils facing the north poles of magnetic field system (304) and magnetic field system (305) are connected together either in series or in parallel to form winding 1 and
said serially connected group of multiple coils facing south poles of magnetic field system (304) and magnetic field system (305) are connected together either in series or in parallel to form winding 2.

46. Commutatorless and brushless DC machine as claimed in claim 45, wherein said winding 1 and winding 2 are formed by connecting the START and FINISH terminals of each said group of multiple coils in series in a manner that said FINISH terminal of first group of multiple coils in coil sides (307/310), is connected to the START terminal of second group of multiple coils in coil sides (309/308), the FINISH terminal of second group of multiple coils is connected to START terminal of the third group of multiple coils and so on till all the groups are connected to form winding (1, 2).

47. Commutatorless and brushless DC machine as claimed in claim 45, wherein said winding 1 and said winding 2 are formed by connecting the START and FINISH terminals of each said groups of multiple coils in parallel in a manner that the said START terminal of all groups in coil side (309/308) are connected together while all groups having FINISH terminal in coil side (307/310) are connected together to form said winding (1) and winding (2) and each said group having equal number of coils in series.

48. Commutatorless and brushless DC machine with stationary armature as claimed in claim 46, wherein
said winding 1 and winding 2 are connected serially in a manner to form armature winding with terminal A1 and A2 so that one terminal of winding 1 in the coil side (307) is connected to terminal of winding (2) which is in the coil side (308), while other terminals of winding 1 and winding 2 are connected to terminals (A1 and A2) of armature winding or
said winding 1 and winding 2 are connected in parallel manner to form armature winding with A1 and A2 such that one pair of terminals of winding 1 and winding 2 which are in coil sides (309) and (308) are connected together to terminal A and other pair of terminal in coil sides (307) and (310) are connected together to terminal A2.

49. A method for using commutatorless and brushless DC machine with stationary armature as claimed in claim 26 for use as DC motor, said method comprising the steps of:
generation of magnetic field system 1 and magnetic field system 2 by using magnetic flux producing system,
energization of coils of armature winding of armature system through current generated by applying DC voltage across terminal A1 and A2 of armature winding, thereby producing self-flux around the conductors in coil sides (307, 308, 309, 310) facing magnetic field system (304) and magnetic field system (305) of each coil,
interaction of said self-flux around conductors of the coil sides with the magnetic flux generated from inner and outer magnetic field systems thereby generating differential flux around each of the conductors leading to the production of force around insulated conductors of armature coils of armature system, direction of said force on the insulated conductors of armature coil of armature system facing magnetic field system (304) and (305) is in same direction as given by Fleming left hand rule, said armature system being stationary, thereby triggering the transmission of force which is creating a torque on the rotatable magnetic field systems (304, 305), causing the rotation of both said rotatable magnetic field systems (304, 305) in the same intended clockwise or anticlockwise direction w.r.t stationary armature system,
monitoring and controlling the speed of DC motor
by varying magnitude of DC voltage applied to armature winding which comprises of armature conductors on armature cores, and/or by varying resistance connected in series with armature winding when magnetic flux producing system is permanent magnetic field system or
when magnetic flux producing system is electromagnetic system, by varying current in field winding and/or by varying magnitude of DC voltage applied to said DC armature winding and/or by varying resistance connected in series with armature winding.

50. A method for using commutatorless and brushless DC machine with stationary armature as claimed in claim 26 for the use as DC generator, the said method comprising steps of:
generation of magnetic field systems (304, 305) by using magnetic flux producing system,
rotation of magnetic field systems (304, 305) in same direction using at least 1 rotatable shaft, thereby inducing emf in additive direction in insulated conductors of each coil of armature system, which are alternately under same magnetic poles of north or south pole of the magnetic field systems (304, 305), resulting in production of total additive emf on each said coil, which is sum of emfs of said individual conductors of each said coil, the said induced emf is DC emf, since the said induced emfs in individual conductors are in same direction throughout period of rotation.

51. Commutatorless, brushless DC machine with stationary armature as claimed in claim 1 said linear arrangement comprising of arrangement of magnetic flux producing system and armature system,
said magnetic flux producing system which is permanent or electromagnetic system comprising of at least two magnetic field systems, magnetic field system 1 and magnetic field system 2,
said magnetic field system 1 comprising of at least 1 rectangular yoke (4011) made of magnetic substance which is movable in linear direction, said rectangular yoke having at least one rectangular shaped magnet (4008, 4009) deployed on its surface,
said magnetic field system 2 comprising of at least 1 rectangular yoke (4012) made of magnetic substance which is movable in linear direction and said rectangular yoke having at least one rectangular shaped magnet (4007, 4010) facing magnetic yoke (4011),
said rectangular yokes (4011, 4012) having a non-magnetic rectangular plate (4013) fixed to said yokes,
said armature system comprises of
stationary member (4014, 4016, 4017/4049) to transport magnetic flux having rectangular flat shape, having two opposite surfaces, surface 1 and surface 2, said surface 1 and 2 having at least one armature core (4030, 4031) and one armature core (4032, 4015) respectively, each said armature core having slots housing groups of conductor,
armature winding comprises multiple winding (1, 2 . . . n), each said winding comprises of multiple groups of coils, each said multiple coils being formed by serially connecting said insulated conductors alternating between said insulated conductors on each of the armature cores being fixed on the opposite surface of the said stationary member and said armature cores aligned with each other, each coil so formed having at least 2 coil side, each coil side corresponding to each said armature core,
wherein, the armature system is deployed within the magnetic flux producing system movable in linear direction such that the said surface 1 of the said stationary member (4014, 4016, 4017/4049) faces magnetic field system 1 while the said surface 2 of the stationary member faces magnetic field system 2, in a manner that the said coil side on armature core of said surface 1 faces a pole of magnet under magnetic field system 1 while the corresponding coil side on armature core of said surface 2 faces pole of magnet under magnetic field system 2, such that the pole of the magnets facing the said coil sides are of same polarity,
said magnetic flux generated from each magnetic field system is transported in a closed loop flux transport means through a magnetic path that include rectangular magnet (4008/4007), air gap, armature core (4030/4032) and conductors therein, stationary member (4014/4017 or 4049), armature core (4031/4015) and conductors therein, air gap, magnet (4009/4010), yoke (4011/4012), finally magnet (4008/4007).

52. Commutatorless, brushless DC machine with stationary armature as claimed in claim 51, wherein said rectangular shaped magnets (4008, 4009) in magnetic field system 1 are of opposite polarity while said rectangular shaped magnets (4007, 4010) in magnetic field system 2 respectively are of opposite polarity.

53. Commutatorless brushless DC machine with stationary armature as claimed in claim 52, wherein both magnetic field systems magnetic field system 1 and magnetic field system 2, like poles of rectangular magnet (4008, 4007) faces towards rectangular armature cores (4030, 4032) respectively while like poles of rectangular magnets (4009, 4010) faces toward armature cores (4031,4015) respectively.

54. Commutatorless, brushless DC machine as claimed in claim 53, wherein each said magnetic field system has one rectangular shaped magnet and one rectangular yoke made of magnetic substance so placed as to facilitates the formation of closed loop flux transport means, said rectangular yokes (4022, 4023) are positioned on the yokes (4012, 4011) respectively in a manner that like pole of said magnets of two magnetic field system faces each other while positioned yokes are faces towards each other.

55. Commutatorless brushless DC machine as claimed in claim 54, wherein both magnetic field system having one or more rectangular magnets are placed side by side on the yoke with an air gap between them facing their respective armature cores in a manner that length of the said magnet is in alignment and equal to the said armature cores.

56. Commutatorless and brushless DC machine with stationary armature as claimed in claim 51, wherein said stationary member in the armature system is selected from stationary member made of magnetic substance having nonmagnetic core or stationary member made of only magnetic substance.

57. Commutatorless and brushless DC machine with stationary armature as claimed in claim 56, wherein said stationary member made of magnetic substance having nonmagnetic core is a pair of rectangular yokes (4014 and 4017) with rectangular non-magnetic core (4016) such that one surface of the each said yoke (4014 and 4017) is in touch with the non-magnetic core (4016) while the surface of the yokes away from the non-magnetic core have at least one armature core.

58. Commutatorless and brushless DC machine with stationary armature as claimed in claim 56, wherein stationary member made of magnetic material comprising of single yoke (4049) said single yoke having two opposite surface with each said surface comprising of at least one armature core.

59. Commutatorless and brushless DC machine with stationary armature as claimed in claim 51, wherein each said rectangular magnet is a single piece or made of multiple magnets acting as a single magnet with same polarity placed side by side on said yoke above said armature cores.

60. Commutatorless and brushless DC machine with stationary armature as claimed in claim 51, wherein all coils in the said group of multiple coils are connected in series in a manner that
north poles facing coil sides on each coil in the said group of multiple coils bears terminals (+(plus), −(minus)/+′(plus′), −′(minus′)/+″(plus″), −″(minus)″) such that terminals (+(plus), +′(plus′), +″(plus″) . . . n) terminals of each coils are on the coil sides present on the slots of the armature core (4030) while the corresponding terminals (−(minus), −′(minus′), −″(minus″) are on the adjacent coil sides on the slots of the corresponding armature core (4032), such terminals being so connected that terminal (−(minus)) is connected to (+′(plus′)), (−(minus′)) is connected (+″(plus″)) and so on till all the coils are connected to form serially connected group of multiple coils. Each said group of serially connected coils having two end terminals START and FINISH.
south poles facing coil sides on each coil in the said group of multiple coil bears terminals (+(plus), −(minus)/+′(plus′), −′(minus′)/+″(plus″), −″(minus)″) such that terminals (+(plus), +′(plus′), +″(plus″) . . . n) terminals of each coils are on the coil sides present on the slots of the armature core (4031) while the corresponding terminals (−(minus), −′(minus′), −″(minus″)) are on the adjacent coil sides on the slots of the corresponding armature core (4015), such terminals being so connected that terminal (−(minus)) is connected to +′(plus′), −′(minus′)) is connected +″(plus″) and so on till all the coils are connected to form serially connected group of multiple coils. Each said serially connected coils groups having two terminal START and FINISH.

61. Commutatorless and brushless DC machine with stationary armature as claimed in claim 60 wherein
said serially connected group of multiple coils facing the north poles of magnets (4008, 4007) of magnetic field system are connected together either in series or in parallel to form winding 1 and
said serially connected group of multiple coils facing south poles of magnets (4009, 4010) are connected together either in series or in parallel to form winding (2).

62. Commutatorless and brushless DC machine as claimed in claim 61, wherein said winding 1 and winding 2 are formed by connecting said START terminal and FINISH terminal in series in a manner that said FINISH terminal of first group of multiple coils on the armature core facing magnetic field system (4007, 4010) is connected to the START terminal of second group of multiple coils facing magnetic field system (4008, 4009), the terminal FINISH terminal of second group of multiple coils is connected to terminal START of the third group of multiple coils and so on till all the groups are connected to form winding (1, 2).

63. Commutatorless and brushless DC machine as claimed in claim 61, wherein said winding 1 and said winding 2 are formed by connecting said groups in parallel in a manner that the said START terminal of all groups of multiple coils on the armature core facing magnetic field system (4008, 4009) are connected together while all groups having FINISH terminal on armature cores facing magnetic field system (4007, 4010) are connected together to form said winding (1) and winding (2) and each said group having equal number of coils in series.

64. Commutatorless and brushless DC machine with stationary armature as claimed in claim 61, wherein
said winding 1 and winding 2 are connected in serial serially in a manner to form armature winding with terminal A1 and A2 so that one terminal of winding 1 in under the magnetic field system (4008, 4009) is connected to terminal of winding (2) which is in the armature core which faces magnetic field system (4007, 4010), while other terminals of winding 1 and winding 2 are connected to terminals (A1 and A2) of armature winding or
said winding 1 and winding 2 are connected in parallel manner to form armature winding with A1 and A2 such that one pair of terminals of winding 1 and winding 2 which are in the armature core facing magnetic field system (4008, 4009) are connected together to terminal A1 and other pair of terminal in the armature core facing magnetic field system (4007 and 4010) are connected together to terminal A2

65. A method for commutatorless, brushless DC machine with stationary armature as claimed in claim 51 for using as DC motor, said method comprising steps of
generation of magnetic field system 1 and magnet field system 2 by using magnetic flux producing system,
energization of coils of armature winding of armature system through current generated by applying DC voltage across terminal A1 and A2 through thereby inducing self-flux around the coil sides facing magnetic field system 1 and magnetic field system 3 of each coil,
interaction of said self-flux with magnetic flux of both magnetic field 1, magnetic field 2, thereby generating differential flux around each of the conductor leading to production of force around insulated conductors of armature coils of armature system, direction of said force on the insulated conductors of armature coil of armature system facing magnetic field system 1 and magnetic field system 2 is in same direction as given by Fleming Left hand rule, said armature system being stationary, thereby triggering the transmission of force resulting into linear motion of magnetic field system in intended linear direction w.r.t stationary armature system,
controlling and monitoring the speed of DC motor
by varying magnitude of DC voltage applied to armature winding and/or by varying resistance connected in series with armature winding when magnetic field system is permanent magnetic field system, or
when magnetic field system is electromagnetic field system by varying current in field winding in case of electromagnetic field system and/or by varying resistance connected in series with armature winding, and/or varying magnitude of DC voltage applied to armature winding.

66. A method for using commutatorless, brushless DC machine with stationary armature as claimed in claim 51 as DC generator comprising steps, said method comprising steps of
generating magnetic field system 1 and magnetic field system 2 by using magnetic flux producing system,
supplying mechanical power to move the yokes (4011,4012) having magnet (4008, 4009 and 4007,4010), along with non-magnetic substance (4013) resulting into movement of magnetic field system 1 and magnetic field system 2 in same linear direction,
which in turn leads to induction of emfs in same direction in insulated conductors of armature system, which are alternately facing like magnetic poles i.e north or south pole of magnetic field system (1 and 2), thereby producing total additive emf in each said coil, which is sum of emfs of said individual conductors of each said coil, as said induced emfs in individual conductor are in same direction, so induced emf is DC emf,
reversing the direction of motion of the said magnet and yoke once said magnet and yokes reach end of the width of armature core, thereby inducing DC emf in conductors of stationary armatures in opposite direction,
repeating above step, each time said movable magnet and yoke reaches end of the width of armature core, maintaining same polarity of DC voltage output by Double pole double throw (DPDT) switch/relay/contactor connected between said armature winding or using rectifier connected between said armature winding and generator output terminals.

67. Commutatorless, brushless DC machine with stationary armature, said DC machine deployed in DC machine body, comprising of magnetic flux producing system and armature system in linear arrangement with an air gap between them, said arrangement comprising of at least one closed loop flux transport means,
said magnetic flux producing system comprising of magnetic field system having at least one rectangular magnetic yoke (3008) movable in linear direction, having at least one rectangular magnet (3007, 3009) deployed on said rectangular magnetic yoke (3008)
said armature system comprising of
at least one flat rectangular yoke (3005) made of magnetic substance having at least one armature core (3006, 3012) placed on one side, having slots, and said slots are in axial alignment with each other, each said slot has armature conductors which is insulated bar made of suitable conducting material housed in each said slot, said armature conductors are connected in parallel by wires to form group of conductors, each said groups of conductors is connected in series,
wherein, said armature system is deployed in manner with in magnetic flux producing system such that said yoke surface having armature core is faces toward corresponding magnet in magnetic field,
said closed flux transport means for closed flux loop from said rectangular magnet of said magnetic flux generated from magnetic field system is transported in a magnetic path that include magnet (3007), air gap (3010), armature core (3006) and conductors therein, through flat magnetic yoke (3005), armature core (3012) and conductors therein, air gap, magnet (3009), flat magnetic yoke (3008) finally magnet (3007).

68. A method for using commutatorless, brushless DC machine with stationary armature as claimed in claim 67 as DC motor, said method comprising steps of:
generation of magnetic field system by magnetic flux producing system which is of said yoke (3008), and said magnets (3007) and (3009)
energization of conductors generally in the form of bars of armature winding of armature system through current generated by applying DC voltage supply across terminals marked as + and − (A1 and A2), thereby producing self-flux around the said conductors facing said magnetic flux producing system,
interaction between flux produced by current in conductors on armature core (3006 and 3012) and flux produced by magnets (3007 and 3009) respectively, leading to production of additive force on the magnets (3007 3009) and yoke (3008), resulting into linear motion of said magnetic producing system in intended direction,
controlling and monitoring the speed of DC motor
by varying the magnitude of DC voltage applied to armature winding and/or by varying resistance connected in series with armature winding when magnetic field system is permanent magnetic field system, or
when magnetic field system is electromagnetic system by varying current in field winding and/or by varying magnitude of the DC voltage applied to armature winding, and/or by varying resistance connected in series with armature winding.

69. Commutatorless, DC machine with movable or rotatable armature system, said DC machine deployed in DC machine body comprising of magnetic flux producing system and armature system with an air gap between them in an arrangement that is radial, axial or linear arrangement
each said arrangement having at least one closed loop flux transport means,
said magnetic flux producing system comprising of at least one magnetic field system preferably a pair of stationary magnetic systems, magnetic field system 1 and magnetic field system 2, each said stationary magnetic field system having at least one magnet said magnetic flux producing system fitted to motor body directly or through means.
said armature system comprising
movable or rotatable member having at least 2 surfaces, each surface having at least one armature core having multiple slots, each slot housing a group of insulated conductors,
armature winding which comprises of at least 1 winding (1, 2 . . . n), each winding comprises of group of multiple coils, each said coil being formed by serially connecting said insulated conductors alternating between said conductor, each of the armature cores being fixed on opposite surfaces of the said member, each said coil so formed having at least 2 coil side, each coil side corresponding to each said armature core,
slip ring and brush arrangement, to supply/to get out DC power to/from armature winding in case of DC motor/generator,
wherein the movable or rotatable armature system is deployed within the stationary magnetic flux producing system such that the said surface 1 of the said yoke faces magnetic field system 1 while the said surface 2 faces magnetic field system 2 in a manner that the said coil side on armature core of the said yoke faces magnetic field system, in a manner that the coil side on armature core of said surface 1 faces pole of magnet under magnetic field system 1 while the corresponding coil side on armature core of said surface 2 faces pole of magnet under magnetic field system 2, such that the poles of the magnets facing the coil sides are of same polarity.

70. Commutatorless, DC machine with movable or rotatable armature system as claimed in claim 69, wherein in the said radial arrangement of stationary magnetic flux producing system and rotatable armature system, deployed in the DC machine body,
said stationary magnetic flux producing system comprising of
at least two magnetic field system inner and outer magnetic field system, wherein the inner magnetic field system is enclosed by the outer magnetic field system,
said inner magnetic field system comprising of cylindrical pipe shaped yoke (402) fixed with DC machine body, outer periphery of the said cylindrical pipe shaped yoke (402) having at least one cylindrical pipe magnet (403, 411), said cylindrical pipe shape magnet being magnetized in radial direction,
said outer magnetic field system comprising of cylindrical pipe shape yoke (414) encompassing the cylindrical yoke of the inner magnetic field system (402) and is fixed with DC machine body, inner periphery of said cylindrical yoke (414) having at least one cylindrical pipe shaped magnet (412, 413), said cylindrical pipe shape magnet magnetized in radial direction
said armature system comprising of
at least one rotatable shaft,
at least 1 rotatable member for transporting magnetic flux and is anchored to the said rotatable shaft, said member has inner periphery and outer periphery each of which has at least one armature core (407, 420 and 421, 422), each said armature core being made of laminated magnetic substance, having slots running in axial direction, each said slot housing a group of insulated conductor,
an armature winding which comprises of multiple windings (1, 2 . . . n), each said winding comprises of multiple groups of coils, each said coil is formed by serially connecting said insulated conductors alternating between said conductors on each armature core being fixed on inner periphery and outer periphery of the member, each coil is so formed having at least 2 coil side, each coil side corresponding to each said armature core, said armature winding
slip ring and brush arrangement having slip rings fixed with said rotatable shaft, said armature winding having two terminals connected to two slip rings which are electrically insulated from each other
wherein the movable or rotatable armature system is deployed within the magnetic flux producing system such that the said inner periphery of the cylindrical said member faces inner magnetic field system while the said outer periphery of cylindrical member faces outer magnetic field system in a manner that the said coil side on armature core of said inner periphery faces a pole of magnet under inner magnetic field system while the corresponding coil side on armature core of said outer periphery faces pole of magnet under outer magnetic field system, such that the pole of the magnets facing the said coil sides are of same polarity,
said magnetic flux generated from each said magnetic field system is transported in a closed loop flux transport means through a magnetic path that includes magnet (403/412), air gap (404/415), armature core (407/421) and conductors therein, member (408,410/444), armature core (420/422) and conductors therein, air gap (404/415) magnet (411/413), cylindrical yoke (402/414) finally magnet (403/412).

71. Commutatorless, DC machines movable or rotatable armature system as claimed in claim 69, wherein said axial arrangement of magnetic flux producing system and armature system in DC machine body
said magnetic flux producing system comprises of
at least 2 magnetic field system (304, 305),
said magnetic field system (304) comprises of cylindrical flat disc yoke (203), having hole (370) at the center of said disc (203) fitted with DC machine body, at least one flat ring magnet (201, 202) mounted on one surface of said magnetic yoke (203), said flat ring being magnetized in axial direction,
said magnetic field system (305) comprises of cylindrical flat disc yoke (205) having hole (371), at the center of said yoke (205) fitted with DC machine body having at least one ring magnet (204, 206) on its surface which is facing toward said yoke (203), said flat ring being magnetized in axial direction,
said armature system comprises of
at least one rotatable shaft,
at least one flat disc shaped member (102, 301, 103/117) anchored to said rotatable shaft, for transporting magnetic flux, made of two co-planer rings with air gap between them, connected by arms (109) which are made of laminated layers of magnetic substance, having two opposite surfaces surface 1 and surface 2, each surface having at least 1 armature core (104, 105 and 106, 107) on each said coplanar ring, each armature core comprises of slots running in radial direction which houses insulated conductors,
armature winding comprising of at least 1 winding (1, 2 . . . n) having group of multiple coils, each said coil in each group being formed by serially connecting said insulated conductors alternating between said conductors on each of the armature cores being fixed on the opposite surface of the said member (103, 301, 104/117), each coil is so formed having at least 2 coil side, each coil side corresponding to each armature core,
slip rings (390, 391) and brushes (393, 394) arrangement, said slip rings are electrically insulated from each other fixedly fitted on said rotatable shaft (302),
wherein the armature system is deployed within the magnetic flux producing system with said shaft (302) passing through the said holes (370) and (371) in said magnetic field systems (304) and (305) respectively, such that the said surface 1 of the said member (102,301,103/117) faces magnetic field system (304) while the said surface 2 faces magnetic field system (305), in a manner that the said coil side on armature core of said surface 1 faces a pole of magnet under magnetic field system (304) while the corresponding coil side on armature core of said surface 2 faces pole of magnet under magnetic field system (305), such that the pole of the magnets facing the said coil sides are of same polarity,
said closed flux transport means for closed flux loop from said ring magnets of said magnetic flux generated from each magnetic field system is transported in a magnetic path that include ring shaped magnet (201/204), air gap, armature core (104/106) and conductors therein, through outer ring made of magnetic substance of member (102, 301, 103/117), arms (109), inner ring made of magnetic substance of member (102, 301, 103/117), armature core (105/107) and conductors therein, air gap, ring magnet (202/206), cylindrical flat disc yoke (203/205) finally ring shaped magnet (201/204).

72. Commutatorless, brushless DC machine with movable or rotatable armature as claimed in claim 69, wherein said linear arrangement comprising of magnetic flux producing system and armature system
said magnetic flux producing system including
at least two magnetic field systems, magnetic field system 1 and magnetic field system 2
said magnetic field system 1 comprises of at least 1 rectangular yoke made of magnetic substance (4011) fixed with DC machine body, which is having at least one rectangular magnet (4008, 4009) deployed on its surface,
said magnetic field system 2 comprises of at least 1 rectangular yoke made of magnetic substance (4012) which is fixed with DC machine body and having at least one rectangular magnet (4007, 4010) deployed on that surface facing toward said magnetic yoke (4011),
said armature system comprises of
at least one flat rectangular shape member ((4014, 4016, 4017)/(4049)) which is movable in linear direction, having two opposite surfaces, surface 1 and surface 2, said surface 1 having at least one armature core (4030, 4031) while said surface 2 having at least one armature core (4032, 4015), each armature core having slots housing groups of conductor,
armature winding comprises of multiple winding (1, 2 . . . n), each said winding comprises of multiple groups of coils, each said multiple coils being formed by serially connecting said insulated conductors alternating between said insulated conductors on each of the armature cores being fixed on the opposite surface of the said stationary member and said armature cores aligned with each other, each coil so formed having at least 2 coil side, each coil side corresponding to each said armature core,
wherein the armature system is deployed within the magnetic flux producing system such that the said surface 1 of the said member faces magnetic field system 1 while the said surface 2 of said member faces magnetic field system 2, in a manner that the said coil side on armature core of said surface 1 faces a pole of magnet under magnetic field system 1 while the corresponding coil side on armature core of said surface 2 faces pole of magnet under magnetic field system 2, such that the pole of the magnets facing the said coil sides are of same polarity.

73. Commutatorless DC machine with movable or rotating armature as claimed in claim 69, wherein armature winding terminals are connected through said slip rings and brush arrangement to supply DC power when DC machine is working as DC motor or to get DC voltage when DC machine operating as DC.
